(19) United States
(12) Patent Application Publication
(10) Pub. No.: US 2011/0055585 A1
(43) Pub. Date: Mar. 3, 2011

(54) Methods and Systems to Create Big Memorizable Secrets and Their Applications in Information Engineering

(76) Inventor: Kok-Wah Lee, Melaka (MY)

(21) Appl. No.: 12/921,155

(22) PCT Filed: Dec. 18, 2008
(86) PCT No.: PCT/IB2008/055432

§ 371 Date: Nov. 8, 2010

(30) Foreign Application Priority Data
Jul. 25, 2008 (MY) PI 20082771

(51) Int. Cl. G06F 21/00

(52) U.S. Cl. 713/183

(57) ABSTRACT

Main invention is methods and systems to create big and yet memorizable secret, which are later applied into many novel and innovated applications in information engineering. Among the big secret creation methods are (i) self-created signature-like Chinese character, (ii) two-dimensional key (2D key), (iii) multilingual key, (iv) multi-tier geo-image key, (v) multi-factor key using software token, and their hybrid combinations. Multihash key using hash iteration and hash truncation is further used to increase number of created secret for multiple offline and online accounts. Besides, multihash signature using multiple hash values of a message from different hash iteration provides object-designated signature function. The object may be recipient, action, feature, function, meaning, etc., as representation. Also, random space steganography using stego-data with random noise insertion is proposed. The main application of big memorizable secret is MePKC (Memorizable Public-Key Cryptography) using fully memorizable private key. Here, 160- to 512-bit MePKC can be realized.

### CROSS-REFERENCE TO RELATED APPLICATIONS

The present application claim priority to and benefits of Malaysian patent application number “PI 20082771” entitled “Methods and Systems to Create Big Memorizable Secrets and Their Applications in Information Engineering” filed on 25 Jul. 2008 at MyIPO (Intellectual Property Corporation of Malaysia) in Malaysia, via extended patent filing period in foreign geo-political regions and countries enabled by an international patent filing number “PCT/IB2008/055432” having the same title and filed on 18 Dec. 2008 at the International Bureau (IB), under the PCT (Patent Cooperation Treaty) of WIPO (World Intellectual Property Organization), where the entire contents are hereby incorporated by reference.

### STATEMENT REGARDING FEDERALLY SPONSORED RESEARCH OR DEVELOPMENT

For this intellectual property (IP), it is fully financed by the inventor cum author, who is Kok-Wah Lee @ Xpree Li. Nevertheless, the inventor has to admit that throughout the past decade since 1998 via the Internet, he has been an unofficial and unregistered learner cum reviewer over the networked web pages from the United States of America (USA). Majority of the learned knowledge from the USA by Kok-Wah Lee are free of charge. Hence, I, named as Lee Kok Wah (aka Kok-Wah Lee), can feel the indebtedness of gratitude to the American people, especially their country and their elected government.

Consequently, subject to successful patent searches and examinations, I, Kok-Wah Lee, hereby license royalty-free the potential patent rights of the invention disclosed in this article to the American government for all types of its official duties. Also, for copyright of this patent specification article, I, Kok-Wah Lee, hereby grant the American government a conditional open-source copyright license, which is revocable, perpetual, worldwide, non-exclusive, non-transferable, royalty-free, needs attribution to the originality of resources, charges free and keeps open to noncommercial uses, as well as shall have no commercial derivatives without author's permission.

### BACKGROUND OF THE INVENTION

### Field of Invention

The present invention generally relates to computer communications security. More particularly, the present invention relates to key management of cryptography and information security. Most particularly, the present invention relates to methods and systems to create big and yet memorizable secrets that are large enough for the higher levels of security strength of security systems like AES-256, 256-bit ECC, 256-bit PRNG, and so on, (where AES stands for Advanced Encryption Standard; ECC stands for Elliptic Curve Cryptography; and PRNG stands for Pseudo-Random Number Generator), together with their derived applications as invention improvements thereof in the general field of information engineering and specific field of information security like memorizable public-key cryptography (MePKC).

### —Key/Password the Secret for Symmetric Key Cryptosystem—

In civilian information security, according to Kerckhoff's Law, a security system shall depend fully on the secrecy of a key, and not the algorithmic software nor its hardware. The main reason for this law is that public confidence has to be earned to show that there is no backdoor in the security system relying solely on secrecy of key, and disclosing its algorithm and hardware to the public, especially academic and corporate researchers, for comments.

For authentication to access a security system, it basically consists of four methods: Secret for what you know, token for what you have, biometrics for what you own, and person for whom you know. Due to the factors of cost, hardware and software compatibilities, password or key the secret is the most popular method. Short key is called password and long key is called passphrase. The selection of a key is always the balance of the factors of memorizability and security. Long and random key is securer but harder to remember. The current prior art of single-line key/password input field limits the practical memorizable key size to a maximum of 128 bits for majority normal users.

To create longer password called passphrase, there are now four existing methods: Sentence-type passphrase, acronym-type passphrase, diceware, and coinware. Sentence-type passphrase is memorizable and has long key size, but vulnerable to dictionary attack; whereas acronym-type passphrase taking the first, last, other locations, or hybrid location is memorizable and resists to dictionary attack, but has a small key size. Diceware and coinware use several dices and coins, respectively, to randomly select a word from monolingual, bilingual, or multilingual wordlists, where they can resist dictionary attack, but memorizablity reduces as the key size becomes longer. Hence, these passphrase generation methods are still insufficient to create random, memorizable, and yet big secret, that can resist guessing attack and dictionary attack, to fulfill the need for secret bigger than 128 bits.

In an article “MySpace Password aren't so Dumb” by Bruce Schneier dated 14 Dec. 2006, <URL: http://www.wired.com/politics/security/commentary/securitymatters/2006/12/72300>, for a survey of 34,000 MySpace users' passwords, about 99% of the passwords have 12 ASCII characters or less. An ASCII character carries about 6.57 bits, which means 99% of the 34,000 MySpace passwords have 78.84 bits or less. This reflects the facts that almost all the symmetric keys of the current symmetric key cryptosystems in practice reach at a key size less than 128 bits. In other words, memorizable key the secret is only practically applicable to the current popular symmetric key cryptosystems like 112-bit 3TDES (3-Key Triple Data Encryption Standard) and 128-bit AES (Advanced Encryption Standard). Table 1 shows the numbers of ASCII and Unicode (version 5.0) characters for various key sizes. In Unicode 5.0, there are 98884 graphic symbols or 16.59 bits per graphic symbol. The repertoire of Unicode graphic symbols can be upgraded from time to time in future versions to enlarge the number of graphic symbols. Memorizable keys for 192-bit and 256-bit AES are out of the reach of the current key management method and system. Hence, there exists a need to have better key management method and system to create larger key/password the secret larger than 128 bits.

### —Key/Password the Secret for Asymmetric Key Cryptosystem—

Besides the symmetric key cryptography, asymmetric key cryptography or public-key cryptography (PKC) is one of the two main components in the field of cryptography. PKC emerges in the 1970s. Symmetric key cryptosystem has a shared secret key between a pair of users, but each PKC user has an asymmetric key pair consisting of a private key known only to the user and a public key shared with the other users Amazingly, PKC can solve the key sharing and distribution problems of symmetric key cryptosystem. Moreover, PKC can resist the guessing attack, dictionary attack, and pre-computation attack that symmetric key cryptosystem is susceptible to. Nevertheless, PKC processing speed is about 1000 times slower than the symmetric key cryptography. Consequently, PKC and symmetric key cryptosystem have to be used in hybrid mode for maximum performance of effectiveness.

Now, there are three main conventional asymmetric cryptosystems: IFC (Integer Factorization Cryptography), FFC (Finite Field Cryptography), and ECC (Elliptic Curve Cryptography). IFC is based on the mathematical hard problem of integer factorization. FFC is based on discrete logarithm problem. And ECC is based on elliptic curve discrete logarithm problem.

RSA (Rivest-Shamir-Adleman) cryptosystem is a type of IFC being the very first practical realization of PKC since 1977. FFC like EIGamal encryption and DSA (Digital Signature Algorithm), as well as ECC are firstly introduced in the 1980s. Then, there are other PKC based on different mathematical hard problems but not yet well-standardized. Nevertheless, so far all the key sizes of asymmetric private key for IFC, FFC and ECC are too big to be human-memorizable. The large key sizes of RSA cryptosystem for its both private and public keys, as well as FFC cryptosystem for its public key, have even caused the USA government to shift to ECC having significant smaller public and private key sizes. For more details on their practically secure key sizes, please refer to “Recommendation for key management—Part 1: General (revised)” (NIST Special Publication 800-57) by E. Barker, W. Barker, W. Burr, W. Polk, and M. Smid dated March 2007.

Due to the reason that private key is not fully human-memorizable using the current prior art, a private key is either fully or partially in the form of a token. In the mean time among the prior art, there are three basic methods for private key storage: (i) Encrypted private key stored in the local computing system or device; (ii) split private key firstly proposed by Ravi Ganesan on 18 Jul. 1994 in the U.S. Pat. No. 5,557,678 “System and Method for Centralized Session Key Distribution, Privacy Enhanced Messaging and Information Distribution Using a Split Private Key Public Cryptosystem”; and (iii) roaming private key firstly proposed by Cliff A. Baltzley on 25 Nov. 1998 in the U.S. Pat. No. 6,154,543 “Public Key Cryptosystem with Roaming User Capability”. All the three methods are bi-factor or multi-factor authentication, where at least one factor is a secret, and another factor is a software token or hardware token.

The first method of private key storage encrypts the private key using a symmetric key and stores the ciphertext of private key in the local computing system like computer hard disk drive or a device like smartcard, floppy disk, and USB flash drive. Encrypted private key method suffers from the problems of loss, damage, side-channel attacks, mobility, hardware and software compatibility, and password domino cracking effect of its digital certificate carrying only one asymmetric public key.

The second method splits a private key into two or more portions, where the first portion is a memorizable password or derivable from the memorizable password kept by the owner of that private key. The second and possible other portions of the private key are kept by one or more servers in the encrypted form like the first method. The first, second and possible other split portions of the private key may also be derived from various authentication factors like token and biometrics. Split private key method suffers from the problems of malicious central authority attack on the user's short password, dictionary attack on the stolen encrypted partial private key, and password domino cracking effect of its digital certificate carrying only one asymmetric public key.

For the third method, roaming private key also has encrypted private key but its ciphertext is stored in a network system like server, and owner of the private key can download it from anywhere and anytime as long as the user has network access. The roaming private key method suffers from the problems of side-channel attacks, hardware and software compatibility, malicious central authority, dictionary attack on the stolen encrypted private key, and password domino cracking effect of its digital certificate carrying only one asymmetric public key.

In U.S. Pat. No. 7,113,594, D. Boneh and M. Franklin described a new type of PKC called identity-based cryptography. In this method, a user's unique public identity like email or phone number is the public key and hence memorizable. However, its private key is not memorizable and has to be generated by a trusted third party (TTP).

Notwithstanding, as compared with symmetric key cryptosystem using password or key the secret, the popularity of token-based PKC using fully or partially encrypted private key, is low due to the problems of mobility convenience, implementation costs, hardware and software compatibilities, and management difficulty of certificate revocation list. Hence, there exists a need to get rid of fully or partially encrypted private key, and to invent key input method to let the private key fully human-memorizable as like the symmetric key.

### —Potential Methods to Create Big and Yet Memorizable Secret—

One of the many invented methods here to create big and yet memorizable secret is to innovate the graphical password or picture password. From psychological studies, it claims that human graphical memory is stronger than human textual memory. The graphical password is categorized into recognition-based and recall-based methods by Xiaoyuan Suo, Ying Zhu, and G. Scott Owen, in their article “Graphical Passwords: A Survey” at the 21st Annual Computer Security Applications Conference (ACSAC 21), Dec. 5-9, 2005, Tucson, Ariz., USA. For recognition-based method, it can be the types of cognometrics and locimetrics. Meanwhile for recalled-based method, it can be the type of drawmetrics.

Passfaces invented by J. H. E. Davies, as in U.S. Pat. No. 5,608,387 “Personal Identification Devices and Access Control Systems”, is a type of cognometircs, where a user is requested to recognize some pre-selected image sequence of human faces as password. Davies's method has the weakness of low entropy per image. For G. Blonder's method, as in U.S. Pat. No. 5,559,961 “Graphical Password”, it is a type of locimetrics, where a user has to select a few areas of an image in sequence as password. Blonder's method is vulnerable to hot-spot attack and shoulder-surfing attack. For Draw-a-Secret scheme by I. Jermyn, A. Mayer, F. Monrose, M. Reiter, and A. Rubin, in article “The Design and Analysis of Graphical Passwords”, it is a type of drawmetrics, where a user draw lines and points on a grid in the form as like a hidden hand signature. For this Draw-a-Secret scheme, its weakness is its authentication process for either acceptance or rejection is not exact as in the previous two graphical password methods, but estimation having FAR (False Acceptance Rate) and FRR (False Rejection Rate).

Besides these three main groups of graphical password, there are icon-like graphical password scheme by P. V. Haperen, as in UK Patent Application: GB2313460 “Graphical Password Entry”, and event-based graphical password scheme by J. Schneider, as in US Patent Application: US2004/0250138 “Graphical Event-Based Password System”. The both of these latter methods are cognometric. Their common weakness is that the key space or password space is limited by the fine differentiation capability of human visual memory over images that may have only minor differences. This causes the entropy per image selection to be still unsatisfactory not big enough for the demands of information engineering for the stronger security levels to carry more bits of strength. Hence, there exists a need to boost the key space of graphical password for higher entropy per image selection and yet still human-memorizable and visually differentiable.

Another potential method to have big memorizable secret is to create Chinese language password (CLPW) through Chinese character encodings and their Romanization. T. D. Huang, as in U.S. Pat. No. 4,500,872 “Method for Encoding Chinese Characters”, proposed on 19 Feb. 1985 to use phonetic encoding and symbolic encoding to represent a Chinese character. The character space of Chinese language is huge by more than 16 bits per character and yet human-memorizable and differentiable. This CLPW method can also be extended to other CJKV languages due to the common sharing for the usages of Han characters ( [symbol] or [symbol] ) like Chinese Hanzi, Japanese Kanji, Korean Hanja, and Vietnamese Hán T [symbol] . However, the current CLPW has a weakness that it is subject to dictionary attack. Hence, there exists a need to create CLPW resisting the dictionary attack.

There are some inventions to create password that can resist the dictionary attacks. Among them are (i) “System and Method for Generating Unique Passwords” by Martin Abadi, Krishna Bharat, and Johannes Marais in U.S. Pat. No. 6,141,760; (ii) “Password Generation Method and System” by M. R. McCulligh in U.S. Pat. No. 6,643,784; (iii) “Method and System for Automated Password Generation” by P. M. Goal and S. J. Kriese in US Patent Application: US2004/0168068; (iv) “Method and Apparatus for Password Generation” by M. R. Dharmarajan in US Patent Application: US2005/0132203; and (v) “Method and System for Generating Passwords” by B. E. Moseley in US Patent Application: US2006/0026439. Nevertheless, even though these five methods can resist dictionary attacks, they have lower memorizability. Hence, there exists a need not only to have a password generation method that can resist dictionary attack, but can have high memorizability as well even for a big secret at least and beyond 128 bits.

Yet another method to create a memorizable secret bigger than the current prior art was proposed by Whitfield Diffie and William A. Woods in their patent application filed on 22 Jun. 2006 entitled “Method for Generating Mnemonic Random Passcodes”, US Patent Application: US2007/0300076. However, the password created by this method is not yet big enough for many applications in the information engineering.

### —Potential Applications of Conditionally Available Big and Yet Memorizable Secret—

With the realization of big memorizable secret, not only the big secret keys of symmetric key cryptosystems of higher security strength like AES-192 and AES-256 can be realized firstly, but memorizable public-key cryptosystem (MePKC) secondly, and other cryptographic, information-hiding, and non-cryptographic applications thirdly in the field of information engineering that need big and yet memorizable secret.

These cryptographic applications include cryptographic schemes like encryption, signature, key exchange, authentication, blind signature, multisignature, group-oriented signature, undeniable signature, threshold signature, fail-stop signature, group signature, proxy signature, signcryption, forward-secure signature, designated-verifier signature, public-key certificate (aka digital certificate), digital timestamping, copy protection, software licensing, digital cheque (aka electronic cheque), electronic cash, electronic voting, BAP (Byzantine Agreement Protocol), electronic commerce, MAC (Message Authentication Code), key escrow, online verification of credit card, multihash signature, etc.

Those information-hiding applications include steganographic and watermarking schemes like stego-key in steganography, secret key in symmetric watermarking, private key in asymmetric watermarking, etc. Meanwhile, the non-cryptographic applications are PRNG (Pseudo-Random Number Generator) and CSPRBG (Cryptographically Secure Pseudo-Random Bit Generator). Hence, there exist lots of needs to have big memorizable secret for lots of cryptographic, information-hiding, and non-cryptographic applications in the field of information engineering.

### —Single Master Key Generating Multiple Slave Keys for Multiple Accounts—

There are lots of situations that require a user to have many online and offline accounts. Examples of online and offline accounts are login access and file encryption, respectively. For safer security, a secret cannot be re-used to avoid password domino cracking effect, where an attacker starts the password cracking process from the weakest link. However, according to R. Kanaley, in the article “Login Error Trouble Keeping Track of All Your Sign-Ons? Here's a Place to Keep Your Electronic Keys, but You'd Better Remember the Password”, San Jose Mercury News dated 4 Feb. 2001, an Internet user manages an average 15 keys on a daily basis. Yet in another survey by A. Adams and M. A. Sasse in the article “Users are not the Enemy”, Communications of the ACM, 42(12), pp. 41-46, 1999, a user can only be expected to handle 4 to 5 unrelated and regularly used keys. Hence, there is a memory burden to the user unless these secrets are written down somewhere. However, important password the secret is discouraged to be jotted down somewhere.

To solve this problem for online accounts, a single sign-on server and its proxy servers are used. Microsoft Windows Live ID (aka Microsoft Passport Network) is one of these examples. Its weaknesses are single point of failure and high cost of integration.

Another method to reduce the memory burden of online account passwords uses key hashing and key strengthening (aka key stretching) of a master key concatenated with a domain name and optional username. Exemplary applications of this method are (i) LPWA (Lucent Personal Web Assistant) by E. Gabber, P. Gibbons, Y. Matias, A. Mayer, in article “How to Make Personalized Web Browsing Simple, Secure, and Anonymous”, LNCS 1318, pp. 17-31, 1997; (ii) HP Site Password (aka System-Specific Passwords or Site-Specific Passwords) by A. H. Karp and D. T. Poe in article “System-Specific Passwords”, US Patent Application: US2004/0025026, filed on 2 Aug. 2002; (iii) Password Multiplier by J. A. Halderman, B. Waters, and E. W. Felten, in article “A Convenient Method for Securely Managing Passwords”, Proceedings of the 14th International Conference on World Wide Web 2005, Chiba, Japan, pp. 471-479, 2005; (iv) PwdHash by B. Ross, C. Jackson, N. Miyake, D. Boneh, and J. C. Mitchell, in article “Stronger Password Authentication Using Browser Extensions”, Proceedings of the 14th USENIX Security Symposium (SEC'05), Baltimore, Md., USA, pp. 17-32, 2005; and (v) Passpet by K. P. Yee, and K. Sitaker, in article “Passpet: Convenient Password Management and Phishing Protection”, Proceedings of the Symposium on Usable, Privacy and Security 2006, Pittsburgh, Pa., USA, pp. 32-43, 2006.

There is also a method using unique random number assignment to different online accounts called CPG (Compass Password Generator) (aka Common Password Method) by H. Luo and P. Henry, in article “A Common Password Method for Protection of Multiple Accounts”, Proceedings of the 14th IEEE 2003 International Symposium on Personal, Indoor and Mobile Radio Communication (PIMRC 2003), Beijing, China, vol. 3, pp. 2749-2754, 2003. Yet there is another method using the key hashing of one-time ticket, server name, and master password to generate different site keys or slave keys called SPP (Single Password Protocol) by M. G. Gouda, A. X. Liu, L. M. Leung, and M. A. Alam, in article “Single Password, Multiple Accounts”, Proceedings of the 3rd International Conference on Applied Cryptography and Network Security (ACNS 2005), Industry/Short Paper Track, New York, N.Y., USA, 2005.

All these methods of single master key generating multiple site keys or slave keys apply only to online accounts having a domain name. Its weakness is a change of master key requires all the accounts to be updated one by one, which is required by some key management strategies. For offline account, the current prior art uses a password vault to store all the unique passwords the secret. These password vaults can be simply an encrypted spreadsheet or document file, or application software like Password Safe by Bruce Schneier <URL: http://www.schneier.com/passsafe.html>. The disadvantage of password vault is its low mobility and danger of disclosing the ciphertext of password vault to the public domain. Hence, there exists a need to have a method to generate multiple slave keys of online and offline accounts from a master key, and yet an individual slave key can be changed without changing the master key and other slave keys.

With the realization of big memorizable secret for cryptographic, information-hiding, and non-cryptographic applications, especially MePKC, there are even more types of offline accounts like asymmetric private key, stego-key, symmetric watermarking key, asymmetric watermarking private key, and PRNG seed. Among them, for MePKC cryptographic applications like encryption, signature, authentication, key exchange, and other schemes, different schemes require a different pair of asymmetric key pair, by the technical and law requirements to have a safer electronic information society. Hence, there exists a need to generate multiple private keys as slave keys from a common memorizable master key.

—Object-Designated Message with Specific Meaning, Function, or Recipient—

One of the many applications of secret is to assign a particular message with particular object like meaning, function, or recipient. For instance, to prevent and trace the public disclosure of government documents by the press, Margaret Thatcher, who was British former Prime Minister in the 1980s, inserted certain unique number of white spaces (aka blanks) as secret in documents distributed to different cabinet ministers, so as to identify the recipients of the documents who have disclosed the documents to the press. This is in fact a type of covert text watermarking with recipient-designated message. The recipients of cabinet ministers here are designated objects for the message of distributed government documents.

Likewise, the secret of blanks can be used to represent other objects like specific meaning and function. Anonymity and non-repudiation are two of its not yet well-established requirements. Comparing with watermarking, digital signature has stronger security strength in terms of randomness, integrity, and robustness. Nevertheless, so far there is no object-designated message using digital signature scheme. Hence, there exists a need to create object-designated signature scheme with optional properties of anonymity and non-repudiation.

### —Detection of Stego-Image and Searching of Stego-Key in Steganography—

Steganography is a branch of information hiding. Secret message acts as embedded data into a cover data under the control of a stego-key to form a stego-data. Stego-data in its forms of storage and transmission through an insecure channel shall be like a normal data without triggering the suspicion of a person sensing the stego-data. To retrieve the secret message, the stego-data is processed using the stego-key to get back the embedded data. In the current prior art, reliable detection of stego-image can be done successfully as in “Reliable Detection of LSB Steganography in Color and Grayscale Images”, U.S. Pat. No. 6,831,991, filed on 22 Jun. 2001 by Jessica Fridrich and Miroslav Goljan. Yet the stego-key searching can also be done within promising time for a short stego-key. This is reported by Jessica Fridrich, Miroslav Goljan, and David Soukal in “Searching for the Stego-Key”, Proceedings of the SPIE on Security, Steganography, and Watermarking of Multimedia Contents VI, San Jose, Calif., USA, 18-22 Jan. 2004, pp. 70-82, that as long as embedded message is not occupying 100% of image capacity, then stego-key searching is independent of encryption key and takes about 12 hours to crack a 30-bit stego-key. Hence, there exists a need to have a big and yet memorizable stego-key, and to somehow fully occupy the data capacity for higher complexity to resist the cracking of steganographic system.

### —Fund Transfer Using Electronic Cheque—

Among the various applications of digital signature scheme, electronic cheque (aka digital cheque) is a special and important type of messages. Electronic cheque as proposed by John Doggett, Frank A. Jaffe, and Milton M. Anderson, on 7 Apr. 1995 in U.S. Pat. No. 5,677,955, “Electronic Funds Transfer Instruments”, introduced another form of electronic fund transfer using conventional digital signature scheme. The popularity of these method and system are low due to the drawbacks of PKC, i.e. low mobility of partially or fully encrypted private key, and management difficulty of certificate revocation list. Furthermore, the digital signature of Doggett's method carries only the information of electronic fund transfer from a payer to a payee via one or more banks.

In fact, a physical cheque has various processing states for accounting records like blank cheque, signed for payment, paid cheque, returned cheque by payee, withdrawn payment by payer, withdrawn payment by payer's bank, bounced cheque, advanced cheque, outdated cheque, fake cheque, etc. And yet the electronic cheque, that can transfer fund between accounts electronically at a very fast speed throughout the world in the networked computer systems, shall have more optional security protection beyond the digital signature because money is a sensitive and critical object needed to be tracked for the convenient investigation of criminal activities and civil cases. Hence, there exists a need to boost the PKC popularity, to add more embedded information, and to increase the security strength of electronic cheque, by applying fully memorizable private key, object-oriented signature scheme, and optional fragile watermarking scheme, respectively.

### —Electronic Software Licensing—

Yet in another application of PKC, software licensing is part of software copy protection besides code obfuscation against reverse engineering, watermarking against software piracy, and tamper-proofing against tampering. In the current prior art, software licensing scheme uses fully or partially encrypted private key of PKC. Token containing the encrypted private key is subject to loss and damage; whereas server containing the encrypted private key is subject to virtual hacking and subsequently guessing attack, dictionary attack, and pre-computation attack. For computer software, its representative monetary value is its software product ID key rather than the duplicable electronic executable and storage device like floppy disk, CD-ROM, DVD, BD, HD DVD, etc., that stores the executable. Hence, there exists a need for current software licensing scheme to apply the fully memorizable private key for higher security and mobility, as well as to add more information using object-designated signature scheme, and to have extra optional security protection to the software product ID key by using the fragile watermarking scheme.

### —Computer Password Authentication Protocol—

In this networked info-computer age, computer-computer mutual authentication uses asymmetric key cryptography, but human-computer and human-human mutual authentications till now still stick to symmetric key cryptography. In fact, the most frequently used application of secret is authentication access of a human to a computer for online account access. The online computer authentication methods using password the secret include (i) simple transmission of key, (ii) transmission of encrypted key, (iii) transmission of key through encrypted channels, (iv) hash-based challenge-response method, (v) zero-knowledge password proof, and (vi) PAKE (Password-Authenticated Key Exchange). All of these six methods are based on a shared secret between a user and the server.

The first method using simple transmission of key in the clear channel is an insecure approach. The second method using transmission of encrypted key is in fact firstly proposed by H. Feistel in his three patents, U.S. Pat. Nos. 3,798,359 “Block Cipher Cryptographic System”, 3,798,360 “Step Code Ciphering System”, and 3,798,605 “Centralized Verification System”, filed on the same day on 30 Jun. 1971. For the third method using transmission of key through encrypted channels, the encrypted channels are based on the protocols like SSL (Secure Sockets Layer) or TLS (Transport Layer Security). Later, hash function is created and subsequently the fourth method called hash-based challenge-response method using hashed password, where a server stores the hash value of a password. The second, third, and fourth methods remain as the current most popular online computer authentication methods till today.

For the fifth method called zero-knowledge password proof, it is more complicated where a secret owner can prove to a verifier its ownership of a secret without revealing the secret. The fifth method is somehow modified to become the sixth method called PAKE. Examples of PAKE include EKE (Encrypted Key Exchange), PAK (Password-Authenticated Key exchange), PPK (Password-Protected Key exchange), SPEKE (Simple Password Exponential Key Exchange), SRP-6 (Simple Remote Password Protocol version 6), etc.

For a good computer password authentication protocol, there are three main issues to be fulfilled: Resistance to dictionary attack, (perfect) forward secrecy, and non-plaintext equivalence. Forward secrecy means resistance to compromise secret information if another part of the protocol is compromised. Perfect forward secrecy means the compromise of long-term key used to derive an agreed ephemeral key does not compromise the agreed keys from earlier runs. Non-plaintext equivalence means a data that cannot be used to gain the same access level of a key/password.

Computer password authentication protocols that can resist dictionary attack are EKE (Encrypted Key Exchange) family of protocols and a few public-key assisted protocols. Protocols that can fulfill the conditions of resistance to dictionary attack and prefect forward secrecy are the strongest members of EKE family of protocols like DH-EKE (Diffie-Hellman Encrypted Key Exchange) and SPEKE (Simple Password Exponential Key Exchange). SPEKE was firstly proposed by D. P. Jablon on 9 Jun. 2004 in U.S. Pat. No. 7,010,692 “Cryptographic Methods for Remote Authentication”. For protocol that can fulfill all the three issues of resistance to dictionary attack, prefect forward secrecy, and non-plaintext equivalence, there is currently only one called SRP-6 (Simple Remote Password Protocol version 6). SRP was firstly proposed by T. J. Wu on 14 Jul. 1998 in U.S. Pat. No. 6,539,479 “System and Method for Securely Logging onto a Remotely Located Computer”.

Nevertheless, the PAKE of SRP-6 still has a long-term shared secret and is not yet a fully asymmetric key cryptosystem. Hence, if the long-term shared secret is re-used, SRP-6 is subject to malicious server attack, where the faulty server having the username, salt, and verifier can pretend to be the another actual server using the same secret. Moreover, it is lacking of mutual authentication. As compared with the MePKC authentication methods and systems in the preferred embodiment of this article, SRP-6 also has more rounds of message exchange, more IP packets and longer processing time.

For authentication protocol operating on the platform of asymmetric key cryptosystem, split private key cryptosystem has a few protocols for these purposes. However, the private key of split private key cryptosystem is only partially memorizable and another portion of private key is stored in the authentication server. The weakness of split private key cryptosystem is a malicious authentication server can launch guessing attack and dictionary attack over the first portion of memorizable split private key. Hence, there exists a need to have a password authentication protocol for human-computer and human-human interfaces that operates on the asymmetric key cryptosystem using a fully memorizable private key for each user.

### —Digital Certificate and Password Throttling—

In using PKC, a user needs to bind one's public key with one's identity. The file binding the user's identity and public key is called digital certificate (aka public-key certificate). Digital signature is used to bind the user's identity and public key by an introducer using web of trust or by a trusted third party (TTP) using certification authority (CA). In the current prior art, there is only one public key per digital certificate. In PKC, different key sizes correspondent to different protection periods. A short key size like RSA-1024 will have to be changed or revoked frequently. Frequent certificate revocation may cause complicated management problems. Hence, a private key has to be steady throughout its validity period to avoid frequent certificate revocation. Successful cracking of encrypted private key, as well as forgetfulness of symmetric key encrypting the private key and partially memorizable private key tend to fail this purpose. Therefore, the ciphertext of the encrypted private key has to be hidden from the public domain.

For online account using split private key cryptosystem, attackers may launch online dictionary attack to the server. The method of locking an account after a pre-set number of unsuccessful login attempts is not practical because it is subject to denial-of-service attack. The follow-up services to re-activate the account through phone and face-to-face communications are tedious and costly. Consequently, split private key cryptosystem was improved by Ravi Sandhu, Colin deSa, and Karuna Ganesan, on 19 Dec. 2000 in the U.S. Pat. No. 6,883,095 “System and Method for Password Throttling” to have the function of password throttling using the increasing complexity of time response and bit length for unsuccessful authentication. The time response will be slower or the bit length of the challenge will be longer whenever a previous login attempt is unsuccessful until a maximum pre-set value tolerable by a user. A slight modification is to measure based on limited number of login attempts per time unit.

The disadvantage of this method is that a digital certificate with short asymmetric key pair like RSA-1024 will still have to be changed frequently. Another disadvantage is that there is a maximum of time response and processing time like one second that a user can tolerate. A delay of one second adds only by about 20 bits on the platform of contemporary computing technologies. Yet in some password generation systems, key strengthening (aka key stretching) is use to harden a password by hashing a password seed for many rounds of iteration for a pre-set time unit like one second to freeze the demand of better computing technologies for longer key length. This tells that password throttling using time response may be not tolerable if it is used together with key strengthening. Hence, there exists a need to improve this method to have lower frequency of certificate revocation and yet fast time response. Moreover, there is a need to have bigger memorizable secret to resist online dictionary attack and malicious server attack over the split private key cryptosystem.

Another method to resist machinery online dictionary attack is to use CAPTCHA (Completely Automated Public Turing test to tell Computers and Humans Apart) by asking a user to key in some data presented by a computer that cannot be interpreted by another remotely networked computer trying to attack the account. This method is quite effective but it cannot extend the validity of a digital certificate with short asymmetric key pair like RSA-1024 that is still changed or revoked frequently. Hence, there exists a need to extend the validity of digital certificate to reduce the frequency of certificate revocation through a better password throttling method.

### —Digital Certificate and Ladder Authentication—

For Internet banking using password the secret for authentication access, usually more than one factor and one authentication process are needed for different services due to the sensitiveness and criticality of monetary matters. For instance, a first symmetric key through computer communications network is needed to login to an Internet banking account. A second random number the secret, that is sent from a bank server to a user's mobile phone through another communication channel, is needed to activate some financial services like fund transfer and utility bill payment, as well as non-financial services like changes of mailing address, email, and phone number. These different authentication processes for different sensitive services of an account is called ladder authentication.

Although this method is effective, it limits to users' with mobile phone and the costs of SMS (Short Message Service) to deliver the random number can be quite a large amount when the Internet banking is prevalent. For example in Malaysia, there are a population of 27 million and an average household size of five members per family in 2007. Let each household have five types of utility bills per month: Water, electricity, one wired phone, and two wireless phones. Then, there are 27 million bills per month throughout Malaysia. If an SMS is charged one cent by the services provider of mobile phone, then it is MYR$3.24 million annually.

The operating costs become higher if a mobile phone is registered overseas. This is a norm of phenomenon for a Malaysian using Singapore Internet banking services, and vice versa. To solve this problem in Singapore, where lots of its residents are occasionally residing overseas, Singapore banks use the one-time-password token (OTP token) like RSA SecurID token. The seeded OTP token creates temporary password with a finite usable life such as thirty seconds. For every cycle of usable life, another temporary password is generated. An authentication server knows the seed and each usable temporary password as well as its usable life, based upon shared algorithms with the OTP token. An overseas user uses the temporary password from the OTP token to replace the random number of an SMS.

Nevertheless, the OTP token is subject to loss, damage, and mobility convenience. Bank will charge the users for replacement of an OTP token due to loss or damage. Currently in Singapore, the replacement cost is SGD$20 per unit of OTP token. Moreover, the temporary password of OTP token is displayed in plaintext mode. Anyone who gets the OTP token can subsequently obtain the temporary password. In a summary, in the current prior art, the ladder authentication methods using SMS of mobile phone and OTP token incur a high operating cost. Hence, there is a need to apply specific PKC digital certificate using fully memorizable private key to implement a cost-saving and yet securer ladder authentication system.

### —Recording Storage of Voice and Video Calls—

Yet there is another important application of PKC using fully big memorizable secret. Here, the application of secret to mobile phone (aka wireless phone, cellular phone, cell phone, and hand phone) is discussed. Since the invention of wireless telephone in the 1907 by Nathan B. Stubblefield in the U.S. Pat. No. 887,357 “Wireless Telephone”, filed on 5 Apr. 1907, its number of functions keeps on increasing until now that even there is camera capturing real-time image and making video call a reality. One of the many inventions is by Charles A. Gladden and Martin H. Parelman in the U.S. Pat. No. 4,152,647 “Rapidly Deployable Emergency Communication System”, filed on 23 Feb. 1978, to introduce the concepts of frequency reuse and handoff. For mobile phone, it is possible to record SMS, voice mail, local image and video. A user needs a passcode (aka pin) the secret to access the voice mailbox. However, it is yet impossible to download voice mail from a website and record interactive voice and video calls. Moreover, the memory of mobile phone is limited due to its size and publicly affordable selling price.

Nevertheless, there are commercial activities, legal cases, personal matters, etc., that are constrained by physical distance and the most convenient communications channel is a phone connection. Here, normally a wired phone will be used together with a recorder to keep a copy of the conversation contents as electronic evidence. However, having every household to own a phone recorder is not cost-effective. Hence, there exist needs to download voice mail from a website, as well as to record, encrypt, store, access, manage, copy, download, and decrypt the interactive voice and video calls from a website as electronic evidence. Distributed servers located in the CO (Central Office) (aka telephone exchange) of wired phone and MTSO (Mobile Telephone Switching Office) of wireless phone shall be fully utilized for recording storage of voice and video calls. Computer password authentication protocol using symmetric key cryptosystem, PKC, or MePKC shall be used to access, manage, and download the recorded voice mail, voice and video calls.

### —Electronic Commerce Transactions—

And yet there is crucial cryptosystem using secret to be improved soonest possible. This cryptosystem is the current prevalent electronic commerce (aka e-commerce) transactions. In the current prior art, the electronic commerce transactions operate in series of bipartite communication mode using credit card and password the secret. Once a user has selected a list of products to be purchased online at a certain website, normally a credit card, such like MasterCard or VISA, is then used to pay the bill, by sending the credit card number and an optional secure code behind the card to the online merchant. For more security, password the secret protecting the credit card may be requested by some merchants. Examples of the services providers of credit card password are PayPal, MasterCard SecureCode, and Verified by VISA.

Besides merchant and credit card verifier for password, sometimes there exists online loyalty point website demanding for another password authentication. Hence, there are at least three rounds of bipartite communications for different stages of authentication. In fact, a comprehensive electronic commerce transaction involves many other entities such as merchant's bank, customer's bank, insurance company, various departments of local, state, and federal governments, transportation agent, storehouse agent, and so on. Each of this entity is now either usually paired with merchant or rarely customer to one round of bipartite communication to initiate and endorse a sub-process of an electronic commerce transaction.

Here, it can be observed that every individual round of bipartite communications using token of credit card number and/or secret of a symmetric key is not so secure and effective. It is in fact quite redundant and time-wasting. The nature of an electronic commerce transaction is in fact a multipartite communication.

In dealing with cryptography and multipartite communications, there is a branch of knowledge called BGP (Byzantine Generals Problem). BGP involves a group of entities where loyal entities have to reach a common agreement called BA (Byzantine Agreement) at the end of a sufficient round of message exchanges, regardless of the malicious and arbitrary messages communicated by faulty entities. The solution of BGP is known as BAP (Byzantine Agreement Protocol), in which BA can be successfully achieved based on the provided functions of PKC (Public-Key Cryptography) like access control, authentication, non-repudiation, and integrity. However, PKC popularity has to be boosted up by using fully big memorizable secret to realize the MePKC.

There are various types of available BAP. For the entities of electronic commerce, they can be basically partitioned into three groups: Essential, government, and non-essential groups. Here, there is a BAP also optimally divides a network of entities into three partitions. This specific BAP is called tripartite ANN based BAP (Tripartite Artificial Neural Network Based BAP) (aka Tripartite BAP-ANN or Tripartite BAP with ANN) and developed from ANN based BAP. The ANN here functions as a classifier and provides majority function over rows and columns of MEM (Message Exchange Matrix) formed from three message exchange rounds of Byzantine communications. For more details of ANN based BAP and tripartite ANN based BAP, please refer to a master's thesis published on 25 Oct. 2002 at Multimedia University, Malaysia, entitled “Artificial Neural Network Based Byzantine Agreement Protocol” by Kok-Wah Lee @ Xpree Jinhua Li.

Again to emphasize here, e-commerce transaction involves multipartite communications by nature and not many rounds of bipartite communications. The BGP can model this multipartite cryptography problem of electronic commerce. BAP is the solution of BGP, and hence multipartite communications of electronic commerce. Tripartite ANN based BAP is well-suited to a network of e-commerce entities divided into three groups. Hence, there exists a need to realize e-commerce transaction based on multipartite communications of BGP and BAP using MePKC, wherein the main purposes are to speed up the processing time from many rounds of bipartite communications and to rely on stronger security protection than the current prior art using symmetric key cryptography.

### —Risks of Public Key Infrastructure—

The applications of PKI (Public Key Infrastructure) in healthcare, finance, government, communications, etc., are presented by Kapil Raina in year 2003 in a book entitled “PKI Security Solutions for the Enterprise”, ISBN: 0471-31529-X. Meanwhile, for the applications of PKI in the Internet protocols, one can refer to a book “Cryptography and Public Key Infrastructure on the Internet” by Klaus Schmeh in 2001, ISBN: 0470-84745-X. For the details operations on how a user applies for a digital certificate through a CA (Certification Authority), one can refer to a book “PKI: Implementing and Managing E-Security” by Andrew Nash, William Duane, Celia Joseph, and Derek Brink in 2001, ISBN: 0072-13123-3. It can be observed in the third book that in the current prior, the CA generates the asymmetric key pair for the user. This is not good because it may have malicious CA attack.

Yet Carl Ellison and Bruce Schneier discussed 10 PKI risks in their article “Ten Risks of PKI: What You're not Being Told about Public Key Infrastructure”, Computer Security Journal, 16(1), pp. 1-8. The first risk on “Who do we trust, and for what?” questions on how well the CA maintains its private keys well. The current digital certificate having only one digital signature to certify its authenticity is not having a strong enough trust. The successful cracking of a CA private key or existence of malicious CA remains as a PKI risk. The third risk on “How secure is the verifying computer?” questions on the possibility of attacker adding its own public key to the list of certificate verification. Again, the current digital certificate having only one digital signature to certify its authenticity is not having a strong enough trust. The sixth risk on “Is the user part of the security design?” questions on the degree of user involvement in the PKI. So far, the user role is not strong in keeping one's secret because the asymmetric key pair is still generated by the CA. A user holds only a symmetric key protecting the private key of the asymmetric key pair. Hence, there exists a need to innovate the PKI to allow the user to generate the asymmetric key pair oneself, and to boost up the trust level of PKI.

The identity-related crime conspired by an organized crime group is getting serious in today electronically networked info-computer age. One may refer to UNODC (United Nations Office on Drugs and Crime) website to know more about this identity-related crime at URL: http://www.unodc.org/unodc/en/organized-crime/index.html. Some human interaction models are needed to simulate the group efficiency of the organized crime group to fake the digital certificate. From the simulation, one can design PKI that can make the organized crime group to be inefficient and hence the PKI trust level can be increased.

Kaneyuki Kurokawa has proposed some very interesting and good human interaction models in his paper entitled “Modeling Human Interactions”, IEEE Potentials, April/May 1997, 16(2), Part 2, pp. 26-28. The studied models are committee meeting, labour division, exploratory group, and technology transfer. This article has somehow showed the coefficient of inefficiency of Parkinson's Law by Professor Cyril Northcote Parkinson, in his book “Parkinson's Law: Or the Pursuit of Progress”, ISBN: 0141-18685-2. The coefficient of inefficiency ranges from 20 to 22 or more to trigger the phenomena that a human group starts to become inefficient. Hence, there exists a need to apply the results of these human interaction models over the organized crime group to fake digital certificate in order to boost up the trust level of the digital certificate.

### CONCLUSIONS

In a nutshell, the current memorizable sizes of secret for password, private key, stego-key, watermarking key, PRNG seed key, etc., are not big enough. There exists a need to invent new methods and systems to increase the memorizable size of secret to achieve higher security levels for longer protection periods. Availability of big memorizable secret can realize lots of useful and important cryptographic, information-hiding, and non-cryptographic applications in information engineering, especially MePKC (Memorizable Public-Key Cryptography) (aka MoPKC (Mobile Public-Key Cryptography)).

### SUMMARY OF THE INVENTION

The present invention broadly provides novel generation methods and systems of big memorizable secrets to practically realize stronger security levels of cryptographic, information-hiding, and non-cryptographic applications in information engineering, especially MePKC (Memorizable Public-Key Cryptography). The first independent embodiment of the present invention is the methods and systems to create big and yet memorizable secrets. The second independent invention embodiment is various types of applications due to the existence of big memorizable secrets. The third independent invention embodiment is mutlihash key using hash iteration and hash truncation to create multiple slave keys from a single master key. And yet the fourth independent embodiment of the invention is multihash signature that allows object-designated message with specific meaning, function, or recipient.

### —Methods and Systems to Create Big Memorizable Secret—

Accordingly, the present invention mainly provides some methods and systems to create big memorizable secrets. These methods and systems include (i) self-created signature-like Han character; (ii) two-dimensional key (2D key); (iii) multilingual key; (iv) multi-tier geo-image key; and (v) multi-factor key using software token. Every method and system can be used individually or mixed as a hybrid combination. The size of big memorizable secret is at least 128 bits. FIG. 1 illustrates the main and basic operations for the generations and applications of one or more big memorizable secret(s).

### —Method and System of Self-Created Signature-Like Han Character—

In a first preferred embodiment of the present invention to create big memorizable secret, self-created signature-like Han character is encoded for this usage. For the word etymology of “Chin” and “Han”, they are originated from the names of two early dynasties called Qin [symbol] and Han [symbol] in China. Even though there are many rounds of renaming in Chinese language for the country of China, its English name remains unchanged till today in carrying the phoneme of “Qin” for “Chin”. Therefore, Chinese character is also called Han character ( [symbol] or [symbol] ). The repertoire size of Han characters is 85,568 in the dictionary of Zhonghua Zihai (Word Dictionary of Chinese Language) published in 1994. Han characters are used in CJKV languages, in which it is called Hanzi in the Chinese language, Kanji in the Japanese language, Hanja in the Korean language, and Hán T [symbol] in the Vietnamese language.

It is to note that the entropy of Han characters is higher than the ASCII characters. Due to the logographic type of language, Han characters carry visual meaning and hence are easily memorizable. In other words, Han characters have the intrinsic features of high entropy and good memorizability, which mean their suitability for the creation of big and yet memorizable secret. Nevertheless, Han characters have input problem. The number of Han characters is too many to be represented by a single keyboard. Another problem is that direct application of Han characters as password the secret is vulnerable to guessing attack, dictionary attack, and pre-computation attack.

To solve the first problem, a Han character can be encoded using its character structure (or symbolic shape) and/or phonetic pronunciation based on ASCII characters. This process is called Romanization. For example, when pronunciation system of hanyu pinyin [symbol] and character structure system of sijiao haoma (or four-corner method) [symbol] are used to encode and romanize the Han character of {han} [symbol] in simplified form, the code is {han4} from hanyu pinyin and {37140} from sijiao haoma, forming one of many possible codes like {han437140} called CLPW (Chinese Language Password). However, the second problem of vulnerability to guessing attack, dictionary attack, and pre-computation attack, has not yet been solved.

To solve the second problem, the randomness of the CLPW using Han character has to be increased. A Han character from any encoding like Unicode encoding can be modified to become a self-created signature-like Han character new to the current available repertoire of Han characters. Phonetic pronunciation system and character structure system using ASCII characters can be used to encode and romanize the self-created signature-like Han character into a CLPW that can resist the guessing attack and dictionary attack. FIG. 2B illustrates an example of self-created signature-like Han character by modifying the Han character of {han} [symbol] in FIG. 2A from {hanyu pinyin=han4} and {sijiao haoma=37140} to {hanyu pinyin=han4} and {sijiao haoma=37141}. In other words, the CLPW has been modified from {han437140} to {han437141}. The adoption of self-created signature-like Han character shares the similar habit with Chinese people to use a general name aliasing with another rare name. A name using frequently used Chinese characters allows easier memorizability and pronunciation, but harder differentiation due to name clashing. A second alias name using rarely used Chinese characters helps to make a person's name unique and differentiable from the others, but carries a problem of harder pronunciation. Hence, pronounceable name is for easy calling and unique name is for easy differentiation.

Self-created signature-like Han characters enlarge the key space of CLPW to 4,150,000. When tone mark and fuhao [symbol] are included, it becomes 207,500,000 or an entropy of 27.63 bits per Han character. The efficiency of CLPW is hence greatly increased. To further increase the randomness, a Chinese language password (CLPW) can be upgraded to a Chinese language passphrase (CLPP) by adding textual semantic noises like character stuffing, capitalization, permutation, punctuation marks, misspelling, mnemonic substitution, and/or alternative symbols from ASCII mutual substitution table. One unit of CLPW can be set to a fixed length like 13 ASCII characters or other size, and a few units of CLPW form a unit of CLPP. For a unit of CLPW, its 13 ASCII characters are formed from phonetic syllable of length 6, tone mark of length 1, sijiao haoma with fuhao of length 5, and non-alphanumeric character as a separator of length 1.

Character stuffing is like bit stuffing in data communication to enable the syllable length at a fixed value of 6. It is 6 because the maximum syllable length is 6 in hanyu pinyin, by excluding the tone mark. Of course, other phonetic pronunciation systems, especially Chinese dialects and CJKV languages, like jyutping for Cantonese language and rōmaji for Japanese language, can be used as well. Similarly, other encodings of Han characters could be used. For the example of 13-character CLPW with textual semantic noises using the Han character of {han} [symbol] , it can be in the forms of {h@n4***&37140}, {37140&HaN4***}, and so on. When the textual semantic noises are good enough from prediction, the ideal entropy of fully random absolute rate at an entropy of 85.41 bits per unit of CLPW (or unit of Han character with modification and added noises) can be approached. A few serial units of CLPW form a CLPP that has good memorizability, resistance to guessing attack and dictionary attack, as well as suitability for general usages. CLPP of size beyond 128 bits can realize the AES-128, AES-192, AES-256, DSA-256, ECC-256, and so on. When CLPP is used for MePKC operating on the platforms of FFC and ECC, even the pre-computation attack can be avoided. Table 1 shows the numbers of CLPP units for various key sizes. People knowing Han characters can memorize a CLPP with 2 to 4 units of CLPW as easy as remembering a person's name using rarely used Han characters.

### —Method and System of Two-Dimensional Key (2D Key)—

Nevertheless, the current prior art of single-line key/password input field is not that friendly when there are two or more CLPW. There exists a user interface problem to input password with long key size in a single line. This problem happens also to other passphrases having a lot of characters. Whenever there is a pause or interrupt during the input process of a passphrase, it is hard to determine the starting points of every word or unit of a passphrase. In other words, a long passphrase like three to four units of CLPP has to be entered instantly without an interrupt or error. Any uncertainty in keying in a passphrase to a single-line key field requires the whole re-keying process of that passphrase.

In a second preferred embodiment of the present invention to solve this problem for creating big memorizable secret, two-dimensional key (2D key) as in FIG. 4 is invented here to particularly facilitate the recognition of reference points of each sub-unit of a passphrase like CLPW of CLPP; and generally the creation of various secret styles of 2D key like multiline passphrase, crossword, ASCII graphics/art, Unicode graphics/art, colorful text, sensitive input sequence, and two or more of their hybrid combinations as partially illustrated in FIG. 3A-D, for Latin language users.

2D key has a 2-dimensional display alike a 2D matrix, where each character of a key is an element of the matrix. The font used for 2D key has to be fixed-width font. Fixed-width font is also called non-proportional font and monospaced font. It is a typeface using fixed width for every glyph. Examples of fixed-width fonts are Courier for ASCII and MS Mincho for Unicode. When ASCII encoding is used, the 2D key has 6.57 bits per character. Meanwhile, when Unicode is used, it has 16.59 bits per character. Even though Unicode-based 2D key has higher entropy, it is inconvenient to enter a Unicode symbol for the mean time, and the fixed-width font for all the Unicode symbols in a single font file has not yet been created. Hence, ASCII-based fixed-width font is used is this article for the discussions as well as prototype demonstration. Nevertheless, for those skilled in the art, ASCII-based 2D key can be extended to Unicode-based 2D key after reading the informative idea disclosure in this article.

To use 2D key input method and system, firstly select the row size and column size. Then, the user can input ASCII characters using keyboard as the elements of the 2D matrix. The input characters can have any secret style or a mixed style of 2D key. These styles have good memorizabilty, and the 2D nature of 2D key generates more references at the user interface for key input. Single-line key field has only one reference at the first location of the only line. 2D key has a number of horizontal lines and each first location of the horizontal lines acts as references for key input. In addition, the first locations of the vertical lines can be secondary set of references for key input. This solves the problem of user interface in facilitating a user to enter a big key.

Good memorizability allows the user to repeat a high-entropy key. The elements of 2D matrix can be either partially, fully, or extraordinary filled. To fill extraordinarily means adding some extra trailing characters as noise after the last element of the 2D matrix. The characters entered into the 2D key field will be read by a computer line by line horizontally from top to bottom, hashed, and processed as usual alike the single-line key field. The hashing process is one round if key strengthening is not used. If key strengthening is used, the hashing iteration is set according to the computer response time per access ranging from 0.05 to 1 second, or any other tolerable ranges.

The advantages of 2D key are good memorizability, high-entropy key, more references at the user interface to facilitate key input, and resistance to guessing attack and dictionary attack. Even pre-computation attack can be avoided if the 2D secret is used on the platform of MePKC. Its disadvantages are more time for key input and possible shoulder-surfing attack. Nevertheless, for a long passphrase having many individual units like word, the key input time of 2D key is faster than the single-line key field whenever there is some interrupt and the user has forgotten the input sequence. This is because only that particular sub-unit has to be re-keyed in and not the whole secret, such like the secret style of multiline passphrase.

The 2D secret styles of multiline passphrase, crossword, ASCII graphics/art, and Unicode graphics/art are illustrated in FIG. 3A-D, respectively, and their embodiments are explained in the Section of “Detailed Description for the Embodiments of the Invention Using Tables, Drawings, and Mind Mapping Points”. These four secret styles can be coded using the present programming languages without special encoding. However, for another two potential secret styles like colorful text and sensitive input sequence, they need special encoding from the present programming languages to support them.

For the secret style of colorful text, it needs some additional supports, such as color encoding, special graphical user interface, and special computer processing. Although these supports make the user interface complicated for the computer, they can be implemented and have better memorizability for the human users. Color is definitely a main element of good memorizability. For instance, by having 16 types of colors, every character in the 2D key will have an additional 4 bits. ASCII-based 2D key will become 10.57 bits per character; whereas Unicode-based 2D key is 20.59 bits per character. The entropies per character of ASCII-based and Unicode-based 2D key will be increased by 60.9% and 24.1%, respectively. The additional color secret also carries more randomness to resist dictionary attack.

For the secret style of sensitive input sequence, it is an additional feature over the current 2D secret style where there is added entropy from the input sequence of a character to a specific element location of the 2D matrix. If a 2D key has the dimensions of (m*n), the key space is increased by [(m*n)!]. If a 2D key of dimensions 4*5 as in FIG. 3A is used, the key space is increased by [20!] or 61.08 bits from 131.40 bits to 192.47 bits, which is close to the example in FIG. 3B for a 2D key of dimensions 5*6 with 197.10 bits. This secret style requires the space encoding for the element location of 2D matrix, table-like graphical user interface of (m*n) matrix, and human memory for the sequence of characters. In term of memorizability, there is not much improvement. However, the time to enter a 2D key of similar size is greatly reduced for the same amount of entropy.

From Table 1, the settings sufficiency of some key input methods and systems for various key sizes is shown. It can be observed that larger key sizes than 128 bits for cryptographic, information-hiding, and non-cryptographic applications like AES-128, AES-192, AES-256, ECC-256, etc., can be realized, especially the MePKC using fully memorizable private key.

### —Method and System of Multilingual Key—

In a third preferred embodiment of the present invention to create big memorizable secret, graphical password/key method and system is somehow innovated to have both the features of cognometrics and locimetrics by using graphic symbols of multilingual languages from any symbol encoding code, such as Unicode, specifically. This invention is especially effective for logographic, bilingual, and multilingual language users. In this new secret creation method, there is a huge key space comprising black-and-white and/or colorful Unicode graphic symbols grouped into tabular pages as in FIG. 5 illustrating one of the exemplary tabular pages {4E00-4EFF}. For this black-and-white multilingual key, a user knowing a particular language has the property of cognometrics to recognize a graphic symbol. Furthermore, there exists also the property of locimetrics for a user to locate a tabular page, subsequently a graphic symbol, and finally a partitioned area of a Unicode graphic symbol. The input method of multilingual key is normally a computer mouse, where it can also be other input devices like touch screen, tablet, stylus, keyboard, sound recognition, eye-tracking technology, Microsoft Surface, etc. The monitor tend towards wide-screen LCD at lower cost shall popularize the multilingual key.

To increase the entropy per image selection and its randomness to resist guessing attack and dictionary attack, invisible grid partitioning is applied to every graphic symbol based on the setting of 3*3, particularly, or any other settings such as 2*2, 4*4, and so on, as in FIG. 6. These partitioned areas increases the entropy of multilingual key by 2, 3, and 4 bits, respectively, for 2*2, 3*3, and 4*4 settings. Every partitioned area represents the concatenation of a few bits to the bitstream encoding a graphic symbol using Unicode in a tabular page consisting of 256 symbols or flexibly any other amount. Among the settings of grid partitioning, 3*3 is selected as the optimum settings and used for further explanation.

There are nine partitioned areas in the setting of 3*3. The outer 8 partitioned areas are encoded by 3 bits. Meanwhile, the central partitioned area adds no bit. For Han characters and other multilingual languages, two Unicode planes are used in the multilingual key, where more Unicode planes can also be added. These are BMP (Basic Multilingual Plane) and SIP (Supplementary Ideographic Plane), where both can support 65536 (=2¹⁶) graphic symbols. For computer context, graphic symbols from different Unicode planes are encoded by bit 0 for BMP and bit 1 for SIP; whereas the 9 partitioned areas have the central area to carry blank value, and the outer areas to represent bit values of 0, 1, 2, to 7 for BMP and 8, 9, 10, to 15 for SIP, as in FIGS. 7C and 7D, respectively. For human context, to ease memorization and references, the 3*3 partitioned areas are again encoded by digits from 0, 1, 2, to 9 as in FIG. 7B. The central area represents digits 0 and 5; whereas the outer areas represent 1, 2, 3, 4, 6, 7, 8, and 9 for both graphic symbols from BMP and SIP. Hence, the 3×3 grid partitioning adds either 0 bit with one-fifth (⅕) probability, or 4 bits with four-fifth (⅘) probability, to the Unicode value of a selected graphic symbol.

For instance, for a Chinese language secret of [symbol] (Qin Han), the code of multilingual key without grid partitioning is {79E66F22}₁₆ based on Unicode, where {79E6}₁₆ represents [symbol] (Qin) and {6F22}₁₆ represents [symbol] (Han). When 3*3 grid partitioning is used, two more digits of secret are added. Let the first digit to be {4}₁₀ to represent the western piece of partitioned areas of [symbol] (Qin), and the second digit to be {5}₁₀ to represent the central piece of partitioned areas of [symbol] (Han). Consequently, the constructed secret is [ [symbol] 4 [symbol] 5] (Qin 4, Han 5). Since both the Han characters of [symbol] (Qin Han) are in the BMP, then the encoded secret for a computing device is {79E636F22}₁₆. The concatenated hexadecimal digit of {3}16 to the end of the Unicode value of {79E6}₁₆ is constructed from {0011}₂ where the first bit represents the BMP and the last three bits represent the western piece of partitioned areas. For the numeric secret of {5}₁₀, no hexadecimal digit is added because digits {0}₁₀ and {5}₁₀ to represent no concatenated value to the Unicode value of selected graphic symbol. The concatenation of these numeric secrets representing different partitioned areas can be at any location of the Unicode values of the selected graphic symbols.

Therefore, for black-and-white multilingual key with 3*3 grid partitioning, a selected image by clicking a partitioned area carries 16.59 or 20.59 bits, with probabilities of ⅕ and ⅘, respectively. For a sequence of many selected partitioned image areas, the average entropy per image selection for this type of multilingual key is 19.79 bits.

To further increase the key space for higher entropy, colorful multilingual key is an added option. The (16+1)-color scheme of colorful multilingual key as in FIG. 8 is selected for explanation, where it can also be other settings. The (2+1)-, (4+1)-, (8+1)-, and (16+1)-color schemes of colorful multilingual key additionally add 2, 4, 6, and 8 bits, respectively, to the black-and-white multilingual key with 3*3 grid partitioning. This means that a selected partitioned image area of (16+1)-color multilingual key has 24.59 or 28.59 bits and an average entropy of 27.79 bits. Also, besides Unicode character and partitioning digit, a user needs to remember a third secret for the combination of foreground and background colors.

Yet to further increase the key space, some special text processing techniques can be used, wherein examples include special effects like directional shadow, 3D styles, and lighting; enclosed character using shapes like circle, square, triangular, or diamond; typeface variation like font type, font size, as well as font format of single strike through, double strike through, and underscore/underline; mirror images on the left, right, up/down; 45°-, 90°-, and 135°-degree clockwise and anti-clockwise rotated images; solid and hollow images; and background watermark.

Nevertheless, the potential huge key space of colorful multilingual key with and without special text processing techniques has memory storage problem due to its huge image size if tabular pages of graphic symbols are stored in normal image file format like BMP, GIF, JPG, and PNG. For black-and-white multilingual key, its problem is not the image storage, but the image loading to the limited RAM, which is also a second problem to the colorful multilingual key. To solve the limited RAM problem of black-and-white multilingual key, the image file format of PNG (Portable Network Graphics), which is good for image compression of line art, can be used for efficient size of image database. Yet for better file compression, algorithm of DJVU file format can be further applied by splitting a tabular page into many layers for separate compression. However, the best current possible and practical solution to both the problems is to have real-time font rasterization from font files like outline font or vector font storing all the Unicode graphic symbols to the monitor display.

Another problem of multilingual key is shoulder-surfing attack from a person or camera nearby the monitor and able to watch and record the image area selection of sequential Unicode graphic symbols. The first solution relies on the human memorizability limit and asks a user to do false selection of image areas by toggling a key on the keyboard, or single-double or left-middle-right clicking of mouse. The second solution is to allow a user to enter a textual password/key into a key field at any interim session during the input of a graphical password/key. In other words, the second solution is a hybrid method combining the textual and graphical passwords/keys.

Yet another problem of multilingual key is its huge key space causes the search of a graphic symbol to be slow if only images of Unicode graphic symbols are stored. To solve this problem, there can be some tabular pages specially designed to list and show the frequently used Unicode graphic symbols, especially Latin and Han characters, or Latin and other languages, to speed up the image area selection of a Unicode graphic symbol. A second solution is to have a fast input method and system of Unicode graphic symbol to search and locate the tabular page and specific location of a particular graphic symbol, which is now possible for Latin languages and CJKV languages using Han characters.

Subsequently, big memorizable secret for cryptographic, information-hiding, and non-cryptographic applications in information engineering can be created from multilingual key as in FIG. 9 according to the specific demand thresholds for various key sizes in Table 1. More importantly, MePKC using fully memorizable private key can be specifically realized.

### —Method and System of Multi-Tier Geo-Image Key—

In a fourth preferred embodiment of the present invention to create big memorizable secret, a second new type of graphical password/key is invented using a hybrid combination of recognition-based cognometrics and locimetrics over a map, as well as recall-based textual password/key of a space name and characteristics. This space map can be continents of Earth, seafloor of oceans, constellations of star sky, and so on.

Let's take the Earth map of continents as an example for multi-tier geo-image key. The current best GPS (Global Positioning System) resolution for civilian usages is about 15 meters (m) per pixel. The radius of Earth globe is r=6.37×10⁶ m and its surface area is S_{Earth}=4πr²=5.099×10¹⁴ m². Assume only 2⁻⁷ of Earth surface is memorizable populated areas like metropolis, city, town, village, etc. Assume also a pixel represents an area of 15² m², and a partitioned area of Earth map at the first tier has 20*20 pixels. At a monitor image resolution of 800*600 pixels, there are 1200 partitioned areas at the first tier of Earth map. Simple estimation will show that four to five tiers of map are needed to locate a specific location on the Earth surface after subsequently selected image areas.

Through some calculation, the whole Earth surface including continents and oceans has a surface area per pixel of Sₚᵢₓₑₗ=4πr²/15²=2.266×10¹² m²/pixel, or an entropy of E_{Earth}=41.04 bits. Considering a click area of 20×20 pixels after image partitioning, the surface area per click area is S_{click}=4πr²/(15²×20²)=5.665×10⁹ m²/click area, or an entropy of 32.40 bits. When the factor of easily memorizable Earth space like populated area is included, the usable Earth surface to create a big memorizable secret is S_{memorizable}=2⁻⁷×S_{click}=4.426×10⁷ m²/click area, or an entropy of 25.40 bits. Hence, a partial image secret of multi-tier geo-image key has about 25.40 bits.

In addition to a partial image secret of a space, a user is also required to enter a second partial textual secret related to the name and/or characteristics of that particular selected image space or location. This is used to increase the key entropy and to resist the shoulder-surfing attack. For every partial image secret, there shall be a partial textual secret. Preferably, the key length of the partial textual secret is at least 6 characters. If ASCII encoding is used, then the textual password/key adds another 39.42 bits. In total, a unit of multi-tier geo-image key has an entropy of 64.82 bits. Some units of multi-tier geo-image key are sufficient for many applications using secret. To specifically realize the MePKC, three and four units of multi-tier geo-image key can support 160- and 256-bit MePKC, respectively, using ECC. The monitor tend towards wide-screen LCD at lower cost shall popularize the multi-tier geo-image key as well.

Table 1 shows the required unit of geo-image key for various key sizes, and FIG. 10 illustrates the operation of this method. To further increase the key space of this method, the preceding tiers of geo-image key before the last tier can be included, and early secret selection of larger geographical area is allowed. Yet another method to increase the key space is to invest more resources to recruit the architects to draw the geographical map of populated areas using the architectural normal scaling of 1:500 (or 1 cm:500 cm, or 1 cm:5 m), which is a resolution better than the civilian GPS resolution 15 m/pixel.

### —Method and System of Multi-Factor Key Using Software Token—

In a fifth preferred embodiment of the present invention to create big memorizable secret, especially for MePKC realization, the key sizes larger than 256 bits, such like 384 and 512 bits, are hard to be memorizable, and a possible solution is multi-factor key using software token as in FIGS. 11-12. For instance, 512-bit MePKC using ECC is needed to realize the bits of security at 256 bits and to resist future quantum computer attack. Hence, in the fifth preferred embodiment, multi-factor key using software token is invented to halve the memorizable key sizes at equivalent security levels, especially designed for MePKC operating on the FFC or ECC.

For 2n-bit ECC, where 2n can be as big as 512, its 2n-bit private key can be derived from a memorizable secret and a 2n-bit hash value. This 2n-bit hash value is obtained from the hashing of a big multimedia data file with its size at least 512 bits by 2n-bit hash function like SHA-512. This multimedia data file may be random or non-random bitstream, text, image, audio, animation, video, or hybrid combinations. The 2n-bit hash value is encrypted by an n-bit memorizable symmetric key using n-bit AES like AES-256 to create a software token. Here, 2n-bit ECC and n-bit AES have equivalent bits of security strength at n bits in the scale of symmetric key cryptosystem. This software token is then stored in a local storage device like USB flash drive, floppy disk, CD-ROM, DVD, etc., or in a remote server.

Whenever a user needs to use the 2n-bit MePKC like 2n-bit ECC, one is either to get the local device storing the software token or to download it from a server through roaming network. Then, by using n-bit memorizable symmetric key S, one decrypts the 2n-bit software token to get 2n-bit hash value, which is later used together with S to derive the 2n-bit private key of 2n-bit MePKC. Hence, this bi-factor key using an n-bit symmetric key and 2n-bit software token can halve the key sizes of MePKC by sacrificing some mobility. This method can be extended to become multi-factor key easily by undergoing the similar processes in split private key cryptography. For instance, the software token may require bi-factor or multi-factor authentication, including at least a biometrics factor to access the software token.

### —Applications of Created Big Memorizable Secret(s)—

In another preferred embodiment of the present invention, these are the useful applications of the created big memorizable secret(s). These applications include (i) methods and systems to realize memorizable symmetric key the secret till resistance to quantum computer attack; (ii) methods and systems to realize memorizable public-key cryptography (MePKC); (iii) methods and systems to improve security strength of other cryptographic, information-hiding, and non-cryptographic applications of secret beyond 128 bits; (iv) method and system to harden the identification of embedded data in steganography although stego-data has been detected; (v) method and system to transfer fund electronically over a remote network using MePKC; (vi) method and system to license software electronically over a remote network using MePKC; (vii) methods and systems to authenticate human-computer and human-human communications at a local station or over a remote network using MePKC; (viii) method and system to use digital certificate with more than one asymmetric key pair for different protection periods and password throttling; (ix) method and system to use three-tier MePKC digital certificates for ladder authentication; (x) method and system to store, manage, and download voice and video calls of mobile phone and wired phone at online distributed servers; (xi) method and system of multipartite electronic commerce transactions; as well as (xii) Method and system to boost up the trust level of MePKC digital certificate by using more than one certification authority (CA) and/or introducer of trust of web.

To apply big memorizable secret(s) to the novel methods and systems using MePKC from (iv) to (xii), two more independent inventions are claimed here to enhance the features of MePKC. These two inventions are multihash key and multihash signature (aka object-designated signature). Multihash key includes some methods and systems to generate multiple slave keys from a single master key. Meanwhile, multihash signature includes a method and system to generate object-designated signature message with specific feature, meaning, function, or recipient.

### —Methods and Systems to Realize Memorizable Symmetric Key the Secret Till Resistance to Quantum Computer Attack—

Due to the successful cracking of 56-bit DES (Data Encryption Standard) in the 1990s, stronger symmetric ciphers with larger symmetric key sizes like 80-bit 2TDES, 112-bit 3TDES, as well as 128-, 192-, and 256-bit AES (developed from Rijndael cipher) are introduced to replace the DES. The NIST (National Institute of Standards and Technology), USA, proposes different protection periods for security through years 2010, 2030, and beyond 2030, for 80, 112, and 128 bits, respectively. ECRYPT of European Union (EU) proposes in its technical reports that 80-, 96-, 112-, 128-, and 256-bit security have protection periods of 4 years through year 2010, 10, 20, 30 years, and foreseeable future to be against quantum computer attack, respectively. Nevertheless, conventional methods and systems normally can only realize a key size of 128 bits or less.

Hence, the first preferred embodiment of the present invention in applying the created big memorizable secret is to realize higher security levels of symmetric ciphers like AES-192 and AES-256. By using the methods and systems as in FIG. 1 and Table 1, it can be observed that the current highest security level of symmetric cipher at 256 bits can be practically realized and achieved using big memorizable 256-bit secret.

### —Methods and Systems to Realize Memorizable Public-Key Cryptography (MePKC)—

The second preferred embodiment of the present invention in applying the created big memorizable secret is to improve from the token-based public-key cryptography (PKC) to the realization of secret-based PKC using fully memorizable private key, which is named as MePKC (Memorizable Public-Key Cryptography) or MoPKC (Mobile Public-Key Cryptography) here. The main advantages of MePKC are full secret memorizability and mobility convenience. Yet another quite important advantage is that secret-based MePKC can resist some side-channel attacks vulnerable to token-based PKC, such as those attacks over the fully or partially encrypted private key. For illustration of MePKC, refer to FIG. 13.

The current lowest key size requirement of asymmetric private key is 160 bits operating in FFC and ECC. From Table 1 listing all the claimed novel methods and systems to create big memorizable secret, a 160-bit secret for 160-bit fully memorizable private key can be supported by self-created signature-like Han character for CLPW and CLPP, 2D key, multilingual key, and multi-tier geo-image key. This group of big memorizable secret creation method and system can easily support memorizable private key up to 256 bits at the symmetric bits of security strength of 128 bits and for a protection period of 30 years.

For higher security levels up to 512-bit secret used by 512-bit MePKC, multi-factor key using software token has to be adopted to halve the key size requirement towards a practical realization. Here, the mobility convenience is somehow sacrificed. To generate this software token, firstly a big multimedia data file like random or non-random bitstream, text, image, audio, animation, or video, is hashed by a 2n-bit hash function to produce 2n-bit hash value. The 2n-bit hash value is encrypted by using an n-bit symmetric key and n-bit AES to further produce a software token. Then, the multimedia data file is destroyed or hide at a safe location like safety box, and the software token is either stored in a local storage device like USB flash drive or in a remote server accessible through roaming network. A user remembers only the n-bit secret of symmetric key. Whenever 2n-bit MePKC is needed for various applications, the software token is acquired and decrypted using the n-bit memorizable secret of symmetric key to obtain the 2n-bit hash value. This n-bit secret and 2n-bit hash value are then used to derive the 2n-bit MePKC private key.

The MePKC can be used for major PKC cryptographic applications like encryption and digital signature schemes. Other minor applied cryptographic schemes are key exchange, authentication, blind signature, multisignature, group-oriented signature, undeniable signature, threshold signature, fail-stop signature, group signature, proxy signature, signcryption, forward-secure signature, designated-verifier signature, public-key certificate (digital certificate), digital timestamping, copy protection, software licensing, digital cheque (aka electronic cheque), electronic cash, electronic voting, BAP (Byzantine Agreement Protocol), electronic commerce, MAC (Message Authentication Code), key escrow, online verification of credit card, multihash signature, etc.

The blind signature scheme includes its further applications for electronic cash (aka e-cash, electronic money, e-money, electronic currency, e-currency, digital cash, digital money, digital currency, or scrip), and electronic voting (aka e-voting, electronic election, e-election, electronic poll, e-poll, digital voting, digital election, or digital poll).

Advancement of computing technologies requests for longer key sizes for a fixed protection period. To freeze this unwanted request, key strengthening (aka key stretching) through many rounds of hash iteration, together with hash truncation and a hash function with longer hash value like 1024 bits or more, can be used.

MePKC is extended to a novel claimed invention here called multihash signature scheme, and novel innovations of some cryptographic schemes like digital cheque, software licensing, human-computer and human-human authentication via a computer communications network, as well as MePKC digital certificate with multiple public keys for password throttling and ladder authentication. Also, depending on further research and evaluation, shorter private key size at equivalent or better bits of security strength can be achieved by using hyperelliptic curve cryptography (HECC) and possibly other cryptosystems like torus-based cryptography (TBC).

For HECC, the genera 2 and 3 have so far been tested to have shorter key size requirement than ECC by twice and thrice. Between them, genus-2 HECC has a higher security without the demand to have a correction factor for its key size. In other words, the correction factor of HECC of genus 2 is 1. As information, genus-3 and genus-4 HECC have a correction factor of 1.05 and 1.286 times of its field, respectively, for the key size to get a larger group order at equivalent bits of security strength. For more information, please refer to an article entitled “High Performance Arithmetic for Special Hyperelliptic Curve Cryptosystems of Genus Two” [DOI: http://dx.doi.org/10.1109/ITCC.2004.1286706] by Jan Pelzl, Thomas Wollinger, and Christof Paar in the IEEE Proceedings of the International Conference on Information Technology Coding and Computing (ITCC'04), 2004, volume 2, pp. 513-517.

—Methods and Systems to Improve Security Strength of Other Cryptographic, Information-Hiding, and Non-Cryptographic Applications of Secret beyond 128 bits—

The third preferred embodiment of the present invention in applying the created big memorizable secret is various other cryptographic, information-hiding, and non-cryoptographic applications needing a big memorizable secret(s). The other cryptographic applications include various PAKE (Password-Authenitcated Key Exchange) like SRP-6 (Secure Remote Password Protocol version 6). Meanwhile, information-hiding applications include stego-key in steganography, secret key in symmetric watermarking, and private key in asymmetric watermarking. Lastly, non-cryptographic applications include seed for PRNG (Pseudo-Random Number Generator) and CSPRBG (Cryptographically Secure Pseudo-Random Bit Generator).

—Multihash Key: Methods and Systems to Generate Multiple Slave Keys from a Single Master Key—

In yet another preferred embodiment of the present invention, new methods and systems called multihash key and its variants are presented here to generate multiple slave keys (aka site keys) from a single master key for both the offline and online accounts. Among various cryptographic, information-hiding, and non-cryptographic applications needing secrets for various types of key, here are some of the popular applications of secret key: (i) Master key for password vault hiding various keys; (ii) Internet banking; (iii) online stock trading; (iv) insurance; (v) tax; (vi) office, school and home email accounts; (vii) instant messengers; (viii) encrypted files; (ix) database accounts at the office and school; (x) library accounts; and (xi) verification key for credit card. Hence, the impact contribution of multihash key shall be very high in the aspects of reducing the human memorization burden and system operating costs.

The multihash key method and system uses the hash iteration and hash truncation, followed by optional n-bit CSPRBG to increase the randomness, as for a basic model as in FIG. 15, to generate slaves keys from a master key and an optional passcode. The master key and hash function shall be at least 2n bits. The passcode shall be at least 4 digits or more. The hash iteration applies the key strengthening for a period ranging from 0.2 to 2 seconds, or longer to 10 seconds in some of the variants of multihash key. Hash truncation halves the hash value or message digest. Multihash key supports infinite number of online accounts and limited number of offline accounts depending on the performance of the computer. Examples of online accounts are webmail, login, email, and instant messenger. Examples of offline accounts are encrypted file, public-key certificate, bank ATM card, and software token.

For instance, for the first computer system of desktop PC, Pentium II 266 MHz, 192 MB RAM, running on Windows XP Professional Edition, the lower and upper bounds for 1-second hash iteration, as in FIG. 14, are 7600 and 8200, respectively. In other words, the first computer system can only support 20 offline accounts for a security level partitioning of 8 bits or 2⁸. Yet in the second computer system of laptop PC, Centrino Duo 1.66 GHz, 1.5 GB RAM, running on Windows XP Home Edition, the lower and upper bounds for 1-second hash iteration are 81,700 and 93,700 respectively. For this specification, the second computer system can support 256 offline accounts for a security level partitioning of 8 bits or 2⁸.

To support more offline accounts, especially the various cryptographic schemes of MePKC, multihash key is further enhanced. Firstly, hashing the concatenation of a master key and a filename is proposed as in FIG. 16A. As long as the filename is unique, infinite offline accounts can be supported. However, the problem is name clashing and renaming. Secondly and thirdly, a random number is used without and with multihash key, respectively, as in FIGS. 16B-C, where this random number is concatenated with master key in a hashing process to generate a slave key. For a ciphertext encrypted using this slave key, the random number has to be retrieved first. Hence, this random number is encrypted using the master key and stored as a concatenation to a file ciphertext encrypted by the slave key to become an output file. When a user wants to open the file ciphertext, one splits the output file to get the ciphertexts of file and random number. Decrypt the ciphertext of random number using the master key. Then, generate the slave key using the master key and the recovered random number. Subsequently, the file ciphertext is decrypted by the slave key. Using AES-256, this method using a random number can support 2²⁵⁶ offline accounts. However, its drawbacks are major modification to the current computer systems and no support for secrets of offline accounts without any ciphertext storage, such as split private key cryptosystem and MePKC.

Then, a fourth method, as in FIG. 16D, using a two-tier structure of multihash key is proposed. For the examples of the first and second computer systems, 400 and 65536 offline accounts, respectively, can be supported. This method is compatible with the current computer system. Yet the special advantage of this method is its support for secrets of offline accounts without any ciphertext storage. In other words, the partially and fully memorizable private keys of split private key cryptosystem and MePKC are now supported.

Besides the basic model, multihash key has been innovated to have some variants. The first variant in FIG. 17 supports more offline accounts by using automatically selected tiers and security levels. The second variant in FIG. 18 also supports more offline accounts by using automatically selected permutation sequence of security levels. The third variant in FIG. 19 is a hybrid combination of the first and second variants. For the fourth variant in FIG. 20, it is a specific application of multihash key to act as a further authentication factor in the Internet banking, online share trading, or other situations. The fifth variant in FIG. 21 is another specific application of multihash key, where it acts as a simple key escrow method and system for supervisor-wise non-critical secrets.

Variants 1, 2, and 3 optionally require the passcode to work automatically or are upgraded to become a big memorizable secret created as in FIGS. 2, 4, 9-11. After the passcode has been replaced by a big memorizable secret with at least 128 bits, the sequence ID Q can be optionally used to make the generated slave keys unique. Yet in the current Internet banking, a random number in an SMS (Short Message Service) through mobile phone network, or a one-time-password token (OTP token), like RSA SecurID token, is used as a second authentication factor. Meanwhile, variant 4 alternatively uses downcounting or upcounting of hash iteration number to generate various slave keys from a master key to function as the second authentication factor. Lastly, variant 5 is designed for the key management of supervisor-wise non-critical secret in an organization like government, company, university and school, to function as a simple key escrow method and system.

—Multihash Signature: Method and System to Generate Object-Designated Signature Message with Specific Meaning, Function, or Recipient—

Yet as the fourth independent preferred embodiment of the present invention, multihash signature method and system to provide object-designated signature message with specific meaning, function, or recipient is invented as illustrated in FIG. 22. A message is hashed iteratively for variable rounds by a signor, and later signed using signor's asymmetric private key to generate a new type of digital signature. This new digital signature only differs from the conventional digital signature in the aspect that it carries the information of hash iteration number as well. In other words, a message can have multiple digital signatures from an asymmetric key pair, and each hash iteration number can be designated for any object, action, feature, function, meaning, recipient, etc., as a representation. Here, the signor keeps a table matching the hash iteration number and its represented object.

Advantages of multihash signature are designated recipient function to alternate with watermarking, object-designated meaning, referral function, anonymity support, avoidance of name clashing and renaming problems, stronger collision resistance than method using the hashing of the concatenation of message digest and object name like Hash(Hash(Message)∥Object Name), as well as recipient non-repudiation. The example of object-designated meaning is the cheque validity status including status like valid, invalid, paid, void, on hold, late processing, rejected, withdrawn, cancelled, etc. The examples of referral functions are to trace a file downloaded from different websites, to referee an advertiser broadcasting the news of a sponsor, and to monitor the leaking source that has publicly disclosed a classified digital file.

Here, multihash signature is used in some other inventions of this article. One of them is called triple-watermark digital cheque and another is triple-watermark software licensing schemes, together with MePKC, steganography, and watermarking. The security of multihash signature has the same strength with the conventional digital signature scheme. For higher security to trace the identity of an Internet user signing a message and one's Internet geographical region, a message is suggested to be hashed and concatenated with MAC address and/or IP address, and then undergoes an optional conventional digital signature or multihash signature.

Signature=Multihash Signature(Hash(Message)∥MAC Address∥IP Address)

### —Method and System to Harden the Identification of Embedded Data in Steganography Although Stego-Data Has Been Detected—

The fourth preferred embodiment of the present invention in applying the created big memorizable secret is to boost up the key size of stego-key to be more than 128 bits. Based on extrapolation of an article “Searching for the Stego-Key” by Jessica Fridrich, Miroslav Goljan, and David Soukal in January 2004, for an 80-bit stego-key, it has a protection period of about 5 years or usable by year 2010 alike the 80-bit symmetric key. It is the contribution of the present embodiment to harden the identification of embedded data in steganography even after the stego-data has been detected as in FIGS. 23-24. Here, this embodied invention is called as “random space steganography”.

Firstly, a stego-key is shared between the sender and receiver using some key exchange protocol like PAKE and MePKC key exchange scheme. Then, a symmetric key is created from a CSPRBG and use it to encrypt an embedded secret data to produce ciphertext of embedded data C_{M}. The symmetric key is later encrypted by recipient's public key to produce ciphertext of symmetric key C_{K}. To identify the address locations to hide the C_{M} and C_{K}, another CSPRBG is seeded with the stego-key and used to produce a list of addresses. Every unique address is recorded in an index table. If a generated address clashes with an address in the index table, then its subsequent address not in the index table is used.

After the C_{M} and C_{K} are hidden into the cover data, then use a third CSPRBG to generate random garbage bitstreams G and use them to fully occupy the remaining data capacity. Consequently from the full occupation of data capacity, the complexity to search for a stego-key will be higher when even encryption key searching is needed for cracking. To paralyze the stego-data detection, a sender can often broadcast dummy stego-data with noises as the embedded data.

—Method and System to Transfer Fund Electronically over a Remote Network Using MePKC—

The fifth preferred embodiment of the present invention in applying the created big memorizable secret is a method and system to transfer fund electronically over a remote network using MePKC, CSPRBG, lossless data compression, as well as information-hiding techniques like steganography and fragile watermarking, as in FIGS. 25-27. Stronger security and prettier aesthetics are needed for digital cheque that is faster, more efficient, and more environment-friendly than paper cheque and electronic textual cheque using PKC merely.

There are three watermarks in the digital cheque. The first watermark marks the information of payer's bank, payer, and cheque account signed by a payer's bank. The second watermark marks the information of payee and cheque amount signed by a payer. The third watermark marks the cheque status after processed by the payer's bank like valid, invalid, paid, void, on hold, late processing, rejected, withdrawn, cancelled, etc. To save the image size, lossless image compression file format like PNG (Portable Network Graphics) and TIFF (Tagged Image File Format) shall be used besides BMP (Bitmap file format). Moreover, the digital cheque can also be in the data type of text. Also, this method and system can be modified and applied in other fields like software licensing.

—Method and System to License Software Electronically over a Remote Network Using MePKC—

The sixth preferred embodiment of the present invention in applying the created big memorizable secret is a method and system to license software electronically over a remote network using MePKC, CSPRBG, lossless data compression, as well as information-hiding techniques like steganography and fragile watermarking, as in FIGS. 28-30. Ethics, self-discipline, and education are mostly needed to fight against the software piracy.

There are three watermarks in the digital software license. The first watermark marks the information of software licensing vendor, reseller (or sales agent), and reseller's account signed by a vendor. The second watermark marks the information of licensee and license selling price signed by a reseller. The third watermark marks the software license status after processed by the vendor like granted, upgraded, resold, void, withdrawn, evaluation, transferred, etc. To save the image size, lossless image compression file format like PNG (Portable Network Graphics) and TIFF (Tagged Image File Format) shall be used besides BMP (Bitmap file format). Moreover, the digital software license can also be text data type. Also, this method and system can be modified and applied in other fields like digital cheque.

—Methods and Systems to Authenticate Human-Computer and Human-Human Communications at a Local Station or over a Remote Network Using MePKC—

Yet in the seventh preferred embodiment of the present invention in applying the created big memorizable secret, two MePKC human-computer and human-human authentication schemes between a human user and a local computer or remote server (or human user) over an insecure computer communication network are presented. Challenge-response authentication protocol is adopted for these authentication schemes without any shared secret and transmission of secret key over the insecure channel. The challenge has a nonce to resist replay attack. Nonce stands for “number used once” and may be a one-time random number, counter, or timestamp. Yet one of many advantages is no storage of encrypted password, hashed password, verifier, or shared secret in the local or remote computing system. Subsequently, this MePKC authentication scheme can also resist phishing attack and spoofing attack that try to steal user password.

Since there is no storage of password, system and network administrators will no longer know the secret of any user's key. This allows a user to use the same asymmetric key pair for different offline/online accounts. By sharing the same asymmetric key pair among different accounts, the memorizability of a user is improved, and hence there is no more need to jot down various keys in the notebook. Since there is no encrypted password, hashed password, or verifier, the pre-computation attack can be avoided. Other attacks such as guessing attack, dictionary attack, and brute force attack will still be possible. However, guessing attack and dictionary attack can be avoided if the 2D key, multilingual key, multi-tier geo-image key, or multi-factor key is used properly as for the key style of ASCII art and Unicode art. If the same asymmetric key pair is used together with multihash key to create different slave keys for different online accounts, this allows pseudo-one-set password entry to multiple websites without having password domino cracking effect as in the symmetric key cryptosystems.

However, the disadvantage of MePKC authentication schemes is the slow processing speed of PKC. Hence, the size of challenge message has to be limited to only a few units of encryption block of PKC, like block size of 256 to 512 bits for 256- to 512-bit MePKC, respectively. A wonderful authentication scheme over a computer communication network shall have the features of non-plaintext equivalence, prefect forward secrecy, and resistance to dictionary attack. For the first basic model of the MePKC authentication scheme as in FIGS. 31-32, it has the features of non-plaintext equivalence internally and resistance to dictionary attack externally by using secret creation method of 2D key, multilingual key, multi-tier geo-image key, or multi-factor key. The first basic model is still lacking of the feature of prefect forward secrecy, because the compromise of long-term private key used to derive an agreed ephemeral key does compromise the agreed keys from earlier runs.

To include the feature of prefect forward secrecy, the second model of MePKC authentication scheme as in FIGS. 33-35 is innovated. Now, a human user may use multihash key and has a long-term asymmetric key pair [K_{PteUL}, K_{pubUL}] and a one-time asymmetric key pair [K_{pteU}, K_{pubU}] acting as rolling key for each login or authentication access. Now, the compromise of long-term private key used to derive an agreed ephemeral key does not compromise the agreed keys from earlier runs. An added feature for this second model is the optional inclusion of a key exchange scheme to establish a shared key between the human user and remote server.

Mutual human-computer authentication for both the first and second models is possible, and it is also extendable to mutual human-human authentication over a computer network. For failed authentication, there are some re-authentication rules for another login attempt and so on. These re-authentication rules include limited time, limited usage amount of a factor, limited number of allowable attempts per unit of time, CAPTCHA activation, secret question(s) and answer(s), as well as password throttling using time, bit length, and cryptosystem, etc.

—Method and System to Use Digital Certificate with More than One Asymmetric Key Pair for Different Protection Periods and Password Throttling—

Yet in the eighth preferred embodiment of the present invention in applying the created big memorizable secret, the multihash key allows the usages of multiple secrets for various applications and this can realize the MePKC digital certificate having more than one asymmetric key pair. Due to technical security and legal factors, a pair of asymmetric key cannot be re-used for different cryptographic schemes like encryption, signature, and authentication. Hence, it is very common for a user to own more than one asymmetric key pair. Here, MePKC digital certificate with four public keys is illustrated in FIG. 36 for one of its various functions according to private key sizes, protection periods, and difficulty levels of cracking.

The illustrated public key settings of a MePKC digital certificate are 160, 256, 384, and 512 bits, in which their private keys may be created from multi-factor key. For re-authentication rules after failed login attempts, password throttling based on cryptosystem is presented as one of its potential main functions. Other password throttling techniques use different periods of response time and lengths of challenge message. After series of password throttling, the authentication scheme may resort to symmetric key cryptosystem and secret Q&A (Questions and Answers) session for limited information access, or phone/face-to-face authentication to re-activate the account. Another potential function is to let the MePKC digital certificate to have at least a bait asymmetric key pair. This bait will detect if there is any criminal crony interested with any MePKC digital certificate.

### —Method and System to Use Three-Tier MePKC Digital Certificates for Ladder Authentication—

In the ninth preferred embodiment of the present invention in applying the created big memorizable secret, three-tier MePKC digital certificates can perform the functions of persistent private key, rolling private key, and ladder authentication as in FIG. 37. The number of tier can also be other values depending on the design requirements. The first group at the first tier acts as the introducer or endorser for the other groups. The user information of the digital certificates in the second and third groups can be updated easily from time to time.

The second group has two subgroups with the optional feature of rolling private key, which means regular replacement of asymmetric key pair. Each rolling private key is updated when the salt value is updated according to one of the two equations, where the first equation is from the second model of the MePKC authentication scheme as in FIGS. 33-35, and the second equation applies the multihash key.

For the private key in the first subgroup of the second group, it is non-persistent in computer memory for ephemeral or transient usages like one-time authentication. For the private key in the second subgroup of the second group, it is persistent in computer memory within limited time, limited number, or limited number per time unit, for steady usages like changing personal particulars, fund transfer and bill payment. The second subgroup of second group can be further divided into many sub-subgroups for ladder authentication to resist MITM (Man-In-The-Middle) attacks. The private key in the first, second, third, . . . , n-th sub-subgroups of the second subgroup of the second group may be used to independently access, manage, modify, endorse, delete, etc., first, second, third, . . . , n-th groups of information, respectively. The first and second groups can function to alternate and complement the current prior art of authentication scheme in Internet banking, where first authentication using password, and second authentication using SMS random number or one-time-password token (OTP token). This SMS random number is called specifically as TAC (Transaction Authorisation Code or Transaction Authentication Code), TAP (Transaction Authorization Pin), Auth Code, and Authorization Code in Internet banking as a second layer of protection. The ladder authentication using different groups from different tiers of MePKC digital certificate can be applied to Internet banking, as well as online share trading.

For highest security, the private key of the third group is only used when the networked computer is offline or disconnected from the computer communications network like Internet and LAN. When anonymity feature is needed, then at least an additional set of MePKC digital certificate from the first, second, and/or third group is needed.

### —Method and System to Store, Manage, and Download Voice and Video Calls of Mobile Phone and Wired Phone at Online Distributed Servers—

In the tenth preferred embodiment of the present invention in applying the created big memorizable secret, MePKC authentication scheme is used to access a user online account storing the recorded data like voice mail, voice call, and video call of wired phone (aka wireline phone) and wireless phone (aka handphone, mobile phone, wireless phone, cellular phone, cell phone) as in FIG. 38.

A user's handphone has two buttons to select the call modes. For calling user, if a first button is pressed, then a voice/video session will be recorded and stored at the distributed server. For called user, if the first button is pressed, the voice/video call will be diverted to recording mode directly without receiving the call. Otherwise if second button is pressed, the voice/video call of called user is received and there is interaction between the calling and called users. After the second button has been pressed, if the first button of called user is not pressed until the end of a call, then no data will be recorded. Otherwise if the first button of called user is pressed after the second button has been pressed, then the following communicated data like voice, image, and video is recorded, encrypted, and stored. Yet calling and called users may press the third and fourth buttons accordingly to pause or terminate a recording session.

The distributed servers at the CO (Central Office) of PSTN (Public Switched Telephone Network) of wired phone and/or CM (Communication Management) of MTSO (Mobile Telecommunications Switching Office) of wireless phone records, encrypts using MePKC, and stores the communicated voice/video call between the calling and called parties. The voice/video data is named, encrypted using MePKC, and saved into the user account. The user can then surf the website of the wired phone and wireless phone services provider to access one's account using MePKC authentication scheme or other methods. Upon gaining access to the user account, the user may be optionally required to gain a MePKC ladder authentication to further manage and download the recorded and stored voice mail, voice call, and video call. After downloading the encrypted data to a local computer, the user can decrypt the data using MePKC schemes like hybrid encryption scheme of PKC and symmetric key cryptography, where a symmetric key used to encrypt the voice/video call is encrypted by a public key. Likewise, this method can be extended to other online electronic data storage using MePKC authentication scheme.

### —Method and System of Multipartite Electronic Commerce Transactions—

In the eleventh preferred embodiment of the present invention in applying the created big memorizable secret, MePKC cryptographic schemes like encryption and signature schemes are used in the method and system of multipartite electronic commerce (aka e-commerce) transactions using tripartite ANN based BAP (Artificial Neural Network Based Byzantine Agreement Protocol) (aka tripartite BAP-ANN (Tripartite BAP with ANN)) as in FIGS. 39-44 and article “Faulty Node Detection in the Tripartite ANN based BAP” by Kok-Wah Lee and Hong-Tat Ewe, in the Proceedings of the MMU International Symposium on Information and Communications Technologies 2003 (MMU-M2USIC 2003), Petaling Jaya, Selangor, Malaysia, TS 3A-2, pp. 45-48, 2-3 Oct. 2003. The MePKC provides the security like confidentiality, integrity, authentication, access control, and non-repudiation to the tripartite ANN based BAP. Other BAP can also be used for the multipartite e-commerce transactions.

FIG. 39A shows the operating stages of a basic ANN based BAP. FIGS. 39B-C show the FCN (Fully Connected network) model and ANN architecture for 4-node distributed network. The number of entities involved in the e-commerce ranges from 4 to more than 30. The simplest network of an e-commerce model includes merchant, customer, bank, and a credit card company. For a big e-commerce model, it can be observed that the partitioning of the large network into a few groups for k-partite ANN based BAP is more efficient. This is because the bottleneck of processing time is the number of exchanged messages that needs to undergo the MePKC encryption, decryption, signing, and verifying processes. It is well-known that the operating time of PKC is so slow that it is 1000 times slower than the symmetric key cryptosystem.

From FIGS. 40A-B and 41B, it is known that tripartite partitioning is the optimal k-partite ANN based BAP. FIG. 41A shows the way to partition a network into three partitions. Furthermore, from FIG. 42, it is shown that the e-commerce entities can be basically divided into three groups: Essential group, government group, and non-essential group. For the first group, the entities of merchant and customer are critical and cannot be replaced; whereas other entities are non-critical and can be replaced. For the second group, all the entities are critical and cannot be replaced. For the third group, all the entities are non-critical and can be replaced. The source node now is the customer to confirm or cancel a buy order.

FIG. 43 shows a first implementation example of using BAP for the multipartite e-commerce transaction having customer as the only source node. Individual group BA, A_{I}, of each node equals to group BA, A_{G}, for loyal nodes but not faulty nodes. Yet in a second implementation, both customer and merchant can be source nodes for two independent Byzantine communications of e-commerce, where one is the customer confirming the money payment for the buy order, and another one is the merchant confirming the product/service delivery for the buy order. And yet in another third implementation as in FIG. 44, the trusted parties can be excluded if the individual group BA of each node is broadcasted to the nodes of other groups and used directly to derive the network BA.

—Method and System to Boost Up the Trust Level of MePKC Digital Certificate by Using More Than One Certification Authority (CA) and/or Introducer of Trust of Web—

In the twelfth preferred embodiment of the present invention in applying the created big memorizable secret, method and system to boost up the trust level of MePKC digital certificate by using more than one certification authority (CA) and/or introducer of trust of web is designed. When one refers to the FIGS. 36-37 for the MePKC digital certificate, one will know that the private key and public key of a user's asymmetric key pair is generated by the user and not the CA. This step can avoid the malicious CA attack by giving the user to fully control one's private key secret, and hence alleviating the sixth risk of Carl Ellison and Bruce Schneier on “Is the user part of the security design?” questioning on the degree of user involvement in the PKI.

For the first group of the user's asymmetric key pair of the three-tier MePKC digital certificate as in FIG. 37, it acts as the introducer of trust of web to the other groups at tiers 2 and 3. For the certification of the first group instead, the current prior art uses a single digital signature from a CA or introducer of trust of web. However when the MePKC prevails, this prior art is not that appropriate in view of the high demand of trust for the first group of three-tier MePKC digital certificate. Innovated approach has to use to build up stronger trust by failing the organized crime to fake MePKC digital certificate.

The possibility that the asymmetric key can be generated by a user allows the user to bind one's identity, public key, and other data, into a binding file oneself. A user can then request one or more CA and/or introducer of trust of web to sign, certify, and issue digital signature. Every pair of binding file and a CA/introducer's digital signature acts as a MePKC digital signature. Due to the independent trust of each pair, other users only accept a binding file when all the pairs are verified. Whenever there is one pair fails to be verified, then the user's binding file is rejected. Hence, the more pair is the MePKC digital certificate, the lower is the probability to successfully fake the user's MePKC digital certificate, the harder is the organized crime group to be efficient, and the higher is the trust level of the user's first group of MePKC digital certificate.

Coming to here, the Kaneyuki Kurokawa's human interaction models are used to simulate the organized crime group to fake MePKC digital certificate. Organized crime group has at least three persons to conspire a crime. FIG. 45 illustrates the group efficiency of committee meeting. FIG. 46 illustrates the group efficiency of exploratory group. FIG. 47 illustrates the success probability of technology transfer. The models in FIGS. 45-47 are all developed by Kurokawa and they are used in this article to derive FIGS. 48-50. Kurokawa's model on committee meeting agrees with the coefficient of inefficiency of Parkinson's Law ranging from 20 to 22 or more. In other words, if an organized crime group similar to committee meeting has 20 to 22 persons or more, then it starts to be inefficient. If the organized crime group is similar to the exploratory group, then its inefficiency starts when the group has five or more members.

Nevertheless, for the personnel in the CA, the situation is similar to the committee meeting and getting 20 to 22 or more digital signatures from the CA personnel is not that practical. For the introducer of trust of web, the situation is similar to exploratory group. It is quite easy to get five of more digital signature to certify a user's binding file. However, the trust level of introducer is limited to how well the people know the introducer. It becomes quite impractical when other users are asked if they know all the five or more introducers certifying a user's binding file. Hence, other approach has to be implemented.

Up to here, we know that the organized crime group, whether similar to committee meeting and/or exploratory group, becomes inefficient when the number of group members is more and hits a threshold. This is because criminals in an organized crime group are normally lacking of a high level of trust among themselves. They normally try their best to get rid of giving chances to other criminals to hold the evidence of their criminal activities. The more members in an organized crime group, the harder it is to be efficient. Furthermore, membership has to keep low to maintain a certain level of profit sharing as reflected by the Sayan Chatterjee's article “Does increased equity ownership lead to more strategically involved boards?”, Journal of Business Ethics.

A proof given to the Parkinson's Law is the time required to achieve a final agreement on the works to be done tends to be more when more people are involved and/or more time limit is given. This phenomenon is explained in articles Elliot Aronson and Eugene Gerard, “Beyond Parkinson's Law: The Effect of Excess Time on Subsequent Performance”, Journal of Personality and Social Psychology, March 1966, 3(3), pp. 336-339; Elliot Aronson and David Landy, “Further Steps Beyond Parkinson's Law: A Replication and Extension of the Excess Time Effect”, Journal of Experimental Social Psychology, July 1967, 3(3), pp. 274-285; as well as David Landy, Kathleen McCue, and Elliot Aronson, “Beyond Parkinson's Law: III. The Effect of Protractive and Contractive Distractions on the Wasting of Time on Subsequent Tasks”, Journal of Applied Psychology, June 1969, 53(3), Part 1, 236-239. One more possible explanation is the longer time to achieve a common agreement as in the BGP (Byzantine Generals Problem) together with the capability to detect the faulty node. For organized crime group, all the members have to achieve a common agreement and detect those possible faulty members before any action is taken. As in the BGP, we know very well that, the larger is a network like the human group, the more messages or time are needed to achieve the common consensus. Therefore, to make the organized crime group to be inefficient, we have to design a PKI similar to the Kurokawa's human interaction models.

FIG. 48 illustrates the group efficiency of exploratory group formed from leaders of some committee meetings without the condition for common consensus among the members. This is an intermediate step to tell that when common consensus among all the members is not needed, the group efficiency increases as the members of exploratory groups and committee meetings increase. FIG. 49 illustrates the group efficiency of exploratory group formed from leaders of some committee meetings with the condition for common consensus among all the members. Here, all the personnel in the CA represent a committee meeting, and each CA/introducer represents a member of the exploratory group. Since other users only accept a MePKC digital certificate when all the CA/introducer's digital signatures are verified, the organized crime group consisting of the malicious CA and/or introducer has lower efficiency as the network size increases. FIG. 50 illustrates the success probability of exploratory group formed from leaders of some committee meetings with the condition for common consensus among all the members of the organized crime group.

It can be deduced that the more the criminals needed to succeed faking a MePKC digital certificate, the lower is the success probability. One of the optimal implementation is to have four (m=4) or more groups of digital signatures for binding file certification from the CA and/or introducers of trust of web, where each CA contributes three (n=3) or more digital signatures from its different personnel. In this case, the success probability of the organized crime group is less than 6%. FIG. 51 illustrates the operations of the method and system to boost up the trust level of the MePKC digital certificate. Now, the first PKI risk informed by Carl Ellison and Bruce Schneier on “Who do we trust, and for what?” questioning on how well the CA maintains its private keys well and the third risk on “How secure is the verifying computer?” questioning on the possibility of attacker adding its own public key to the list of certificate verification, can also be improved by having more than one CA/introducer certifying a digital certificate. This is possible because users can generate their own asymmetric key pairs. The CA or introducer of trust of web may be a government authority, and people working in the fields of religion, law, police, security, politics, army, finance, diplomacy, etc., who have a high trust level in the society like judge, Commissioner for Oaths, lawyer, etc.

### BRIEF DESCRIPTION OF THE TABLES AND DRAWINGS

The present invention will now be described in greater detail, with reference to the accompanying tables and drawings, in which:

Table 1 shows the various key sizes corresponding to the numbers of ASCII characters, Unicode (version 5.0) characters, and password units of various secret creation methods, as well as the settings sufficiency of some key input methods and systems; and

Table 2 shows the binary-to-text encoding Bin2Txt(H) of multihash key methods and systems.

FIG. 1 illustrates the main and basic operations for the generations and applications of one or more big memorizable secrets;

FIG. 2 illustrates an example of self-created signature-like Han character by modifying the Han character of {han} [symbol] in simplified form in FIG. 2A from {hanyu pinyin=han4} and {sijiao haoma=37140} to {hanyu pinyin=han4} and {sijiao haoma=37141} in FIG. 2B;

FIG. 3 illustrates the secret styles of two-dimensional key (2D key): (FIG. 3A) Multiline passphrase; (FIG. 3B) Crossword; (FIG. 3C) ASCII art; and (FIG. 3D) Unicode art;

FIG. 4 illustrates the operation of 2D key input method and system;

FIG. 5 illustrates one of the exemplary tabular pages of multilingual key consisting of the first 256 Han characters in the Unicode and starting from Unicode value {4E00};

FIG. 6 illustrates a Han character from Unicode before and after the grid partitioning for various settings: (FIG. 6A) Without grid partitioning, (FIG. 6B) With grid partitioning of 2*2, (FIG. 6C) With grid partitioning of 3*3, and (FIG. 6D) With grid partitioning of 4*4;

FIG. 7 illustrates the grid partitioning encoding of a graphic symbol, wherein (FIG. 7A) illustrates the 3*3 settings where red lines are invisible; (FIG. 7B) illustrates the encoding for human memorization and reference in the human context; (FIG. 7C) illustrates the concatenated bit values to the Unicode value of a graphic symbol in the BMP (Basic Multilingual Plane) when a partitioned area is selected in the computer context; and (FIG. 7D) illustrates the concatenated bit values to the Unicode value of a graphic symbol in the SIP (Supplementary Ideographic Plane) when a partitioned area is selected in the computer context;

FIG. 8 illustrates the (16+1)-color scheme for colorful multilingual key;

FIG. 9 illustrates the operation of multilingual key input method and system;

FIG. 10 illustrates the operation of multi-tier geo-image key input method and system;

FIG. 11 illustrates the software token generation of multi-factor key input method and system;

FIG. 12 illustrates the software token acquisition and application of multi-factor key input method and system;

FIG. 13 illustrates the operation of MePKC method and system;

FIG. 14 illustrates the pseudo-code to determine the numbers of hash iteration for multiple security levels of multihash key methods and systems;

FIG. 15 illustrates the operation of the basic model of multihash key method and system;

FIG. 16 illustrates methods and systems to support more offline accounts for multihash key: (FIG. 16A) Using filename; (FIG. 16B) Using random number without multihash key; (FIG. 16C) Using random number with multihash key; (FIG. 16D) Using two-tier structure of multihash key with manually selected security levels;

FIG. 17 illustrates a first variant of multihash key method and system to support more offline accounts using automatically selected tiers and security levels;

FIG. 18 illustrates a second variant of multihash key method and system to support more offline accounts using automatically selected permutation sequence of security levels;

FIG. 19 illustrates a third variant of multihash key method and system to support more offline accounts using a hybrid combination of automatically selected tiers and security levels, and automatically selected permutation sequence of security levels;

FIG. 20 illustrates a fourth variant of multihash key method and system for the specific application to act as a further authentication factor in the Internet banking or other situations;

FIG. 21 illustrates a fifth variant of multihash key method and system for the specific application to act as a simple key escrow method and system for supervisor-wise non-critical secrets;

FIG. 22 illustrates the multihash signature method and system to provide object-designated signature message;

FIG. 23 illustrates the data embedding process into a cover data for method and system to harden the identification of an embedded data in steganography although stego-data has been detected;

FIG. 24 illustrates the data extracting process of embedded data from a stego-data for method and system to harden the identification of an embedded data in steganography although stego-data has been detected;

FIG. 25 illustrates the samples of digital cheque in triple-watermark digital cheque scheme, wherein (FIG. 25A) blank cheque issued by bank to payer; (FIG. 25B) written cheque signed by payee; and (FIG. 25C) processed payee's cheque by bank;

FIG. 26 illustrates the creation of blank cheque by a bank and written cheque by a payer in the triple-watermark digital cheque method and system;

FIG. 27 illustrates the cheque crediting process by a payee in the triple-watermark digital cheque method and system;

FIG. 28 illustrates the samples of digital software license in triple-watermark digital software license scheme, wherein (FIG. 28A) blank software license issued by software vendor to reseller (or sales agent); (FIG. 28B) written software license signed by reseller; and (FIG. 28C) processed software license by vendor;

FIG. 29 illustrates the creation of blank software license by a vendor and written software license by a reseller in the triple-watermark digital software license method and system;

FIG. 30 illustrates the endorsement process of a software license by a licensee in the triple-watermark digital software license method and system;

FIG. 31 illustrates the various not-so-frequent operations of the basic model of MePKC authentication schemes with feature of non-plaintext equivalence: (FIG. 31A) Creating a sufficiently big and yet memorizable user's private key; (FIG. 31B) Account registration of a new user; and (FIG. 31C) Replacing a user's public key by a user;

FIG. 32 illustrates the basic model of MePKC authentication scheme between a human user and a computer with features of non-plaintext equivalence and optional mutual authentication;

FIG. 33 illustrates the various not-so-frequent operations of the second model of MePKC authentication schemes with features of non-plaintext equivalence and perfect forward secrecy: (FIG. 33A) Account registration of a new user by creating a sufficiently big and yet memorizable user's private key; and (FIG. 33B) Replacing a user's authentication dataset like user's public key and salt by a user;

FIGS. 34-35 illustrate the second model of MePKC authentication scheme between a human user and a computer with features of non-plaintext equivalence, perfect forward secrecy, and optional key exchange scheme;

FIG. 36 illustrates the MePKC digital certificate with four public keys for various applications, such as password throttling;

FIG. 37 illustrates the three-tier MePKC digital certificates for various applications, such as persistent private key, rolling private key, and ladder authentication;

FIG. 38 illustrates the operations to record, store, access, manage, and download the voice mail, voice call, and video call in the distributed servers at the CO (Central Office) of PSTN (Public Switched Telephone Network) of wireline phone and/or CM (Communication Management) of MTSO (Mobile Telecommunications Switching Office) of wireless phone;

FIG. 39 illustrates the ANN based BAP and its smallest model of 4-node distributed network: (FIG. 39A) Block diagram of ANN based BAP; (FIG. 39B) FCN model of 4-node distributed network; and (FIG. 39C) ANN model of 4-node distributed network;

FIG. 40 illustrates the total number of exchanged messages for different types of BAP: (FIG. 40A) Traditional BAP and basic ANN based BAP; and (FIG. 40B) basic ANN based BAP and tripartite ANN based BAP;

FIG. 41 illustrates the partitioning of a distributed network and its optimal partitioning selection: (FIG. 41A) Partitioning of a 10-node distributed network into three groups; and (FIG. 41B) Optimal selection of network partitioning for tripartite ANN based BAP;

FIG. 42 illustrates the partitioning of the entities involved in the electronic commerce transactions into three groups: Essential group, government group, and non-essential group;

FIG. 43 illustrates the tripartite ANN based BAP with trusted party and faulty node detection for multipartite electronic commerce transaction using MePKC cryptographic schemes for communications;

FIG. 44 illustrates the tripartite ANN based BAP without trusted party but still with faulty node detection for multipartite electronic commerce transaction using MePKC cryptographic schemes for communications;

FIG. 45 illustrates the group efficiency of a committee meeting according to the Kurokawa's human interaction model;

FIG. 46 illustrates the group efficiency of an exploratory group according to the Kurokawa's human interaction model;

FIG. 47 illustrates the success probability of technology transfer according to the Kurokawa's human interaction model;

FIG. 48 illustrates the group efficiency of an exploratory group formed from leaders of some committee meetings (without condition for common consensus) as modified and enhanced from the Kurokawa's human interaction models;

FIG. 49 illustrates the group efficiency of an exploratory group formed from leaders of some committee meetings (with condition for common consensus) as modified and enhanced from the Kurokawa's human interaction models;

FIG. 50 illustrates the success probability of an exploratory group formed from leaders of some committee meetings (with condition for common consensus) as modified and enhanced from the Kurokawa's human interaction models; and

FIG. 51 illustrates the method and system to boost up the trust level of MePKC digital certificate by using more than one certification authority (CA) and/or introducer of trust of web.

### DETAILED DESCRIPTION FOR THE EMBODIMENTS OF THE INVENTION USING TABLES DRAWINGS, AND MIND MAPPING POINTS

### Detailed Description of the Invention Using Tables

Table 1 (or T100) shows the various key sizes corresponding to the numbers of ASCII characters, Unicode (version 5.0) characters, and password units of various secret creation methods, as well as the settings sufficiency of some key input methods and systems. The summarized secret creation methods include single-line key input space using ASCII and Unicode, CLPW, ASCII-based 2D key, Unicode-based 2D key, black-and-white multilingual key with and without invisible grid, (16+1)-color multilingual key with and without invisible grid, multi-tier geo-image key, and multi-factor key using software token. The 256-bit MePKC can be realized by lots of methods here, but 512-bit MePKC can only be effectively realized by multi-factor key and hybrid secret creation method.

Table 2 (or T200) shows the binary-to-text encoding Bin2Txt(H) of multihash key methods and systems. For highest randomness, four groups of ASCII characters are included so as to be as even as possible. These ASCII types are lowercase alphabet, uppercase alphabet, digit, and punctuation mark. This encoding can also be used for other secret creation methods.

### Detailed Description of the Invention Using Figures

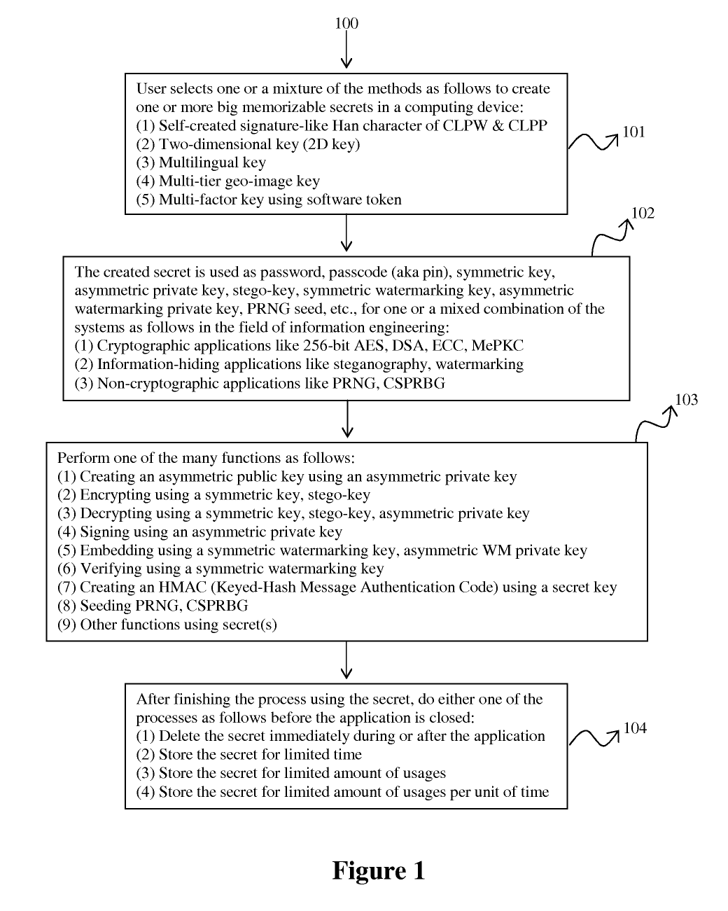

FIG. 1 depicts the main and basic operations for the generations and applications of one or more big memorizable secrets. Starting from Entry 100, Box 101 lists the available invented methods and systems to create big memorizable secret: Self-created signature-like Han character of CLPW & CLPP; 2D key; multilingual key; multi-tier geo-image key; and multi-factor key using software token. Box 102 lists the potential applications of big memorizable secret as password, passcode (aka pin), symmetric key, asymmetric private key, stego-key, symmetric watermarking key, asymmetric watermarking private key, PRNG seed, etc., for cryptographic, information-hiding, and non-cryptographic applications. Box 103 lists the potential functions of big memorizable secret: Creating an asymmetric public key using an asymmetric private key; encrypting using a symmetric key, stego-key, decrypting using a symmetric key, stego-key, asymmetric private key; signing using an asymmetric private key; embedding using a symmetric watermarking key, asymmetric watermarking private key; verifying using a symmetric watermarking key; creating an HMAC (Keyed-Hash Message Authentication Code) using a secret key; seeding PRNG, CSPRBG; and other functions using secret(s). Box 104 shows the option to treat the secret after it has been used: Delete the secret immediately during or after the application; store the secret for limited time; store the secret for limited amount of usages; and store the secret for limited amount of usages per unit of time.

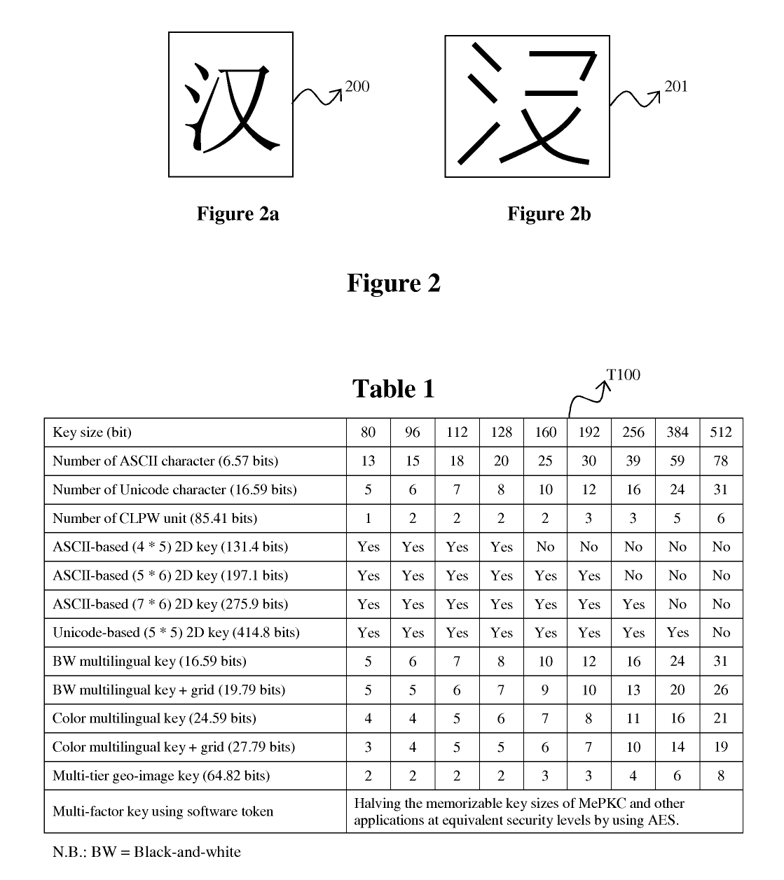

FIG. 2 depicts an example of self-created signature-like Han character by modifying the Han character of {han} ( [symbol] ) in simplified form in FIG. 2A (or 200) from {hanyu pinyin=han4} and {sijiao haoma=37140} to {hanyu pinyin=han4} and {sijiao haoma=37141} in FIG. 2B (or 201). Creating non-existed Han character can resist guessing attack and dictionary attack, and yet still has good memorizability due to the graphic nature of Han character. Other phonetic system, character structure system, and Romanization encoding can be used.

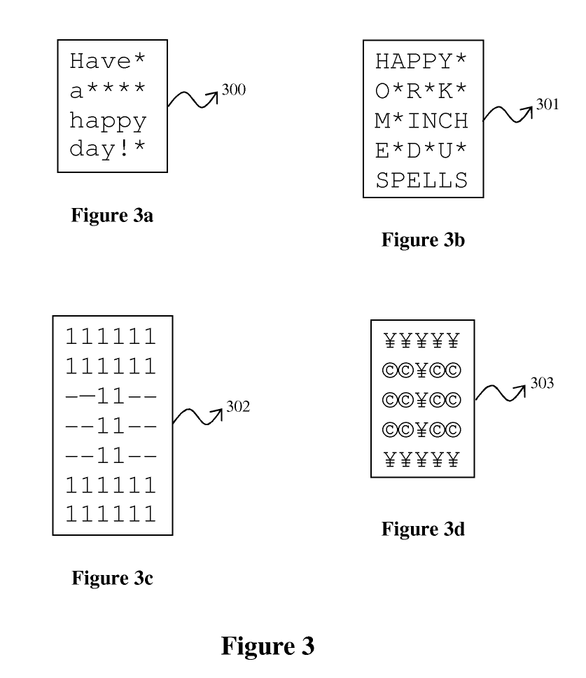

FIG. 3 depicts the secret styles of two-dimensional key (2D key). FIG. 3A (or 300) shows the first style of multiline passphrase, where different words of a passphrase are in different lines. This can have more reference points and faster key input. Character stuffing is used to let each word at each line to have same width. FIG. 3B (or 301) shows the second style of crossword, where the guessing attack and dictionary attack can be avoided. FIG. 3C (or 302) shows the third style of ASCII art, where its resistance to guessing attack and dictionary attack is even higher, but stronger memorizabilty due to its graphic nature. FIG. 3D (or 303) shows the fourth style of Unicode art, which is similar to ASCII art but has double key entropy and harder for its character input interface.

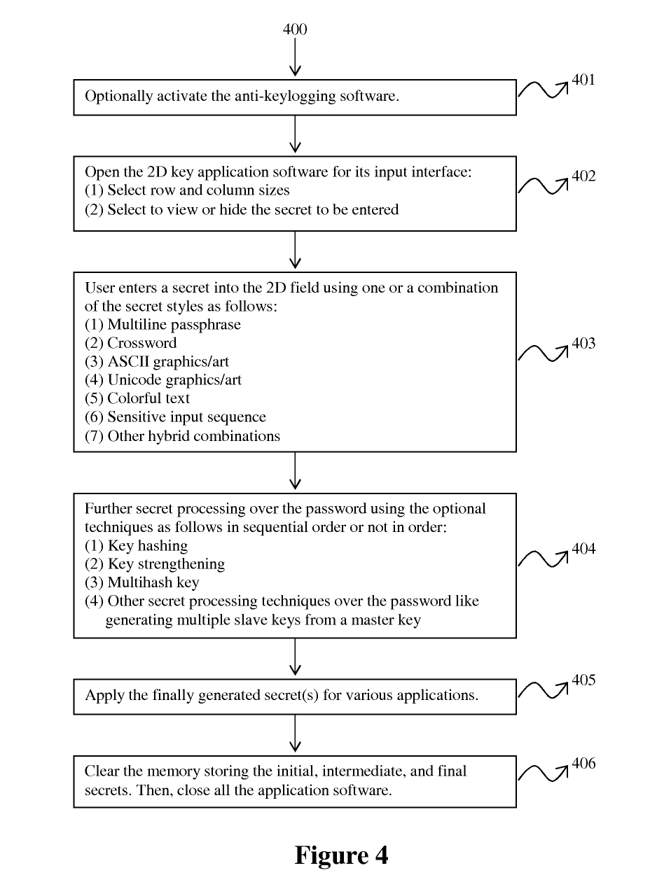

FIG. 4 depicts the operation of 2D key input method and system. Starting from Entry 400, firstly at Box 401, optionally activate the anti-keylogging software. At Box 402, open the 2D key software, select the row size and column size, and decide to hide or view the secret to be entered. At Box 403, enter the secret according to one or a mixture of the listed secret styles: Multiline passphrase; crossword; ASCII graphics/art; Unicode graphics/art; colorful text; sensitive input sequence; or other hybrid combinations. Box 404 shows the optional further secret processing of the created secret in the previous Box 403. These processing includes one or many of key hashing, key strengthening (aka key stretching), multihash key, and/or other secret processing techniques over the password like generating multiple slave keys from a master key. Box 405 applies the created and processed secret. Finally at Box 406, clear the initial, intermediate, and final secrets stored in the computer memory. Then, close all the application software.

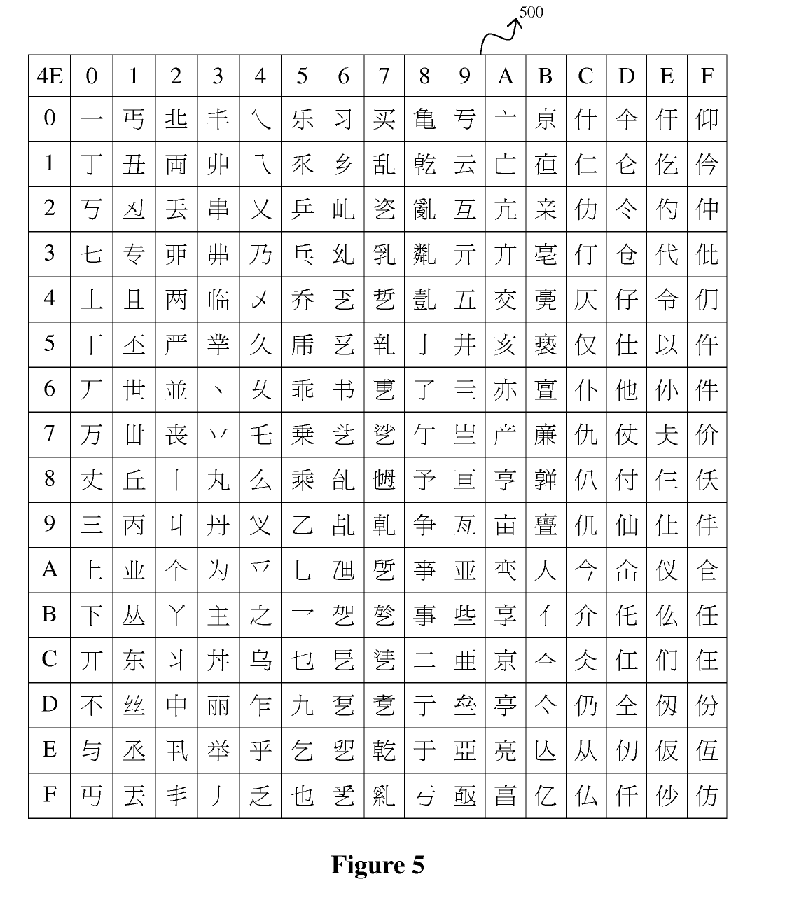

FIG. 5 (or 500) depicts one of the exemplary tabular pages of multilingual key consisting of the first 256 Han characters in the Unicode and starting from Unicode value {4E00}. A user can create a secret by clicking on a character image. This character image may be further invisibly partitioned by 3*3 grids to have higher randomness and resistance to dictionary attack. Hence, it has the features of cognometrics and locimetrics. Any style of character encoding can be used. Here, Unicode is used due to its comprehensiveness.

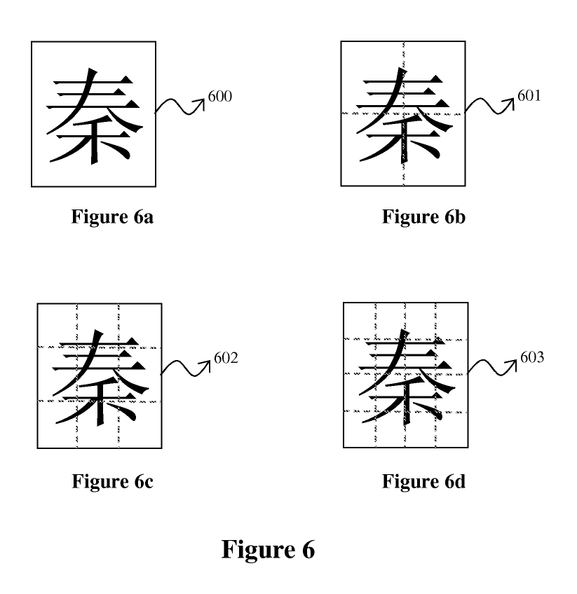

FIG. 6 depicts a Han character from Unicode before and after the grid partitioning for various settings. FIG. 6A (or 600) is a Unicode character image without grid partitioning. FIG. 6B (or 601) is a Unicode character image with grid partitioning of 2*2. FIG. 6C (or 602) is a Unicode character image with grid partitioning of 3*3. FIG. 6D (or 603) is a Unicode character image with grid partitioning of 4*4.

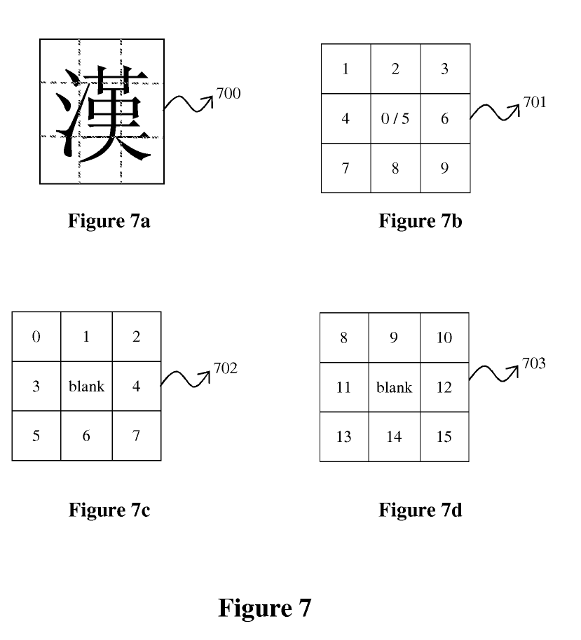

FIG. 7 depicts the grid partitioning encoding of a graphic symbol, wherein FIG. 7A (or 700) illustrates the 3*3 settings where red lines are invisible; FIG. 7B (or 701) illustrates the encoding of human-version grid position for human memorization and reference in the human context; FIG. 7C (or 702) illustrates the concatenated bit values to the Unicode value of a graphic symbol in the BMP (Basic Multilingual Plane) when a partitioned area is selected in the computer context; and FIG. 7D (or 703) illustrates the concatenated bit values to the Unicode value of a graphic symbol in the SIP (Supplementary Ideographic Plane) when a partitioned area is selected in the computer context. FIGS. 7C-D are the encodings of computer-version grid position in the BMP and SIP, respectively. For instance, if the image location of a Unicode character of [symbol] (Han) in BMP and its grid position at west is selected as a secret, then the human memorizes { [symbol] 4} as the secret of [symbol] from Unicode and {4}₁₀ from human-version grid position, and computer encodes the secret as {6F223}₁₆ where {6F22}₁₆ is the Unicode encoding of [symbol] and {3}₁₆ is the computer-version grid position.

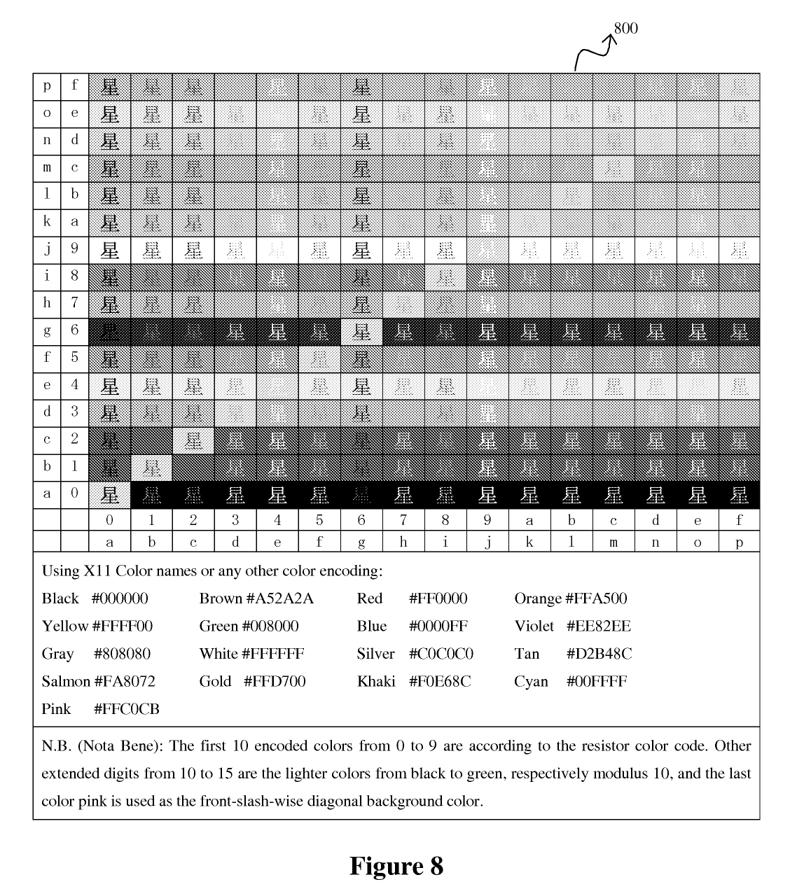

FIG. 8 (or 800) depicts the (16+1)-color scheme for colorful multilingual key. The (16+1) colors of colorful multilingual key are black, brown, red, orange, yellow, green, blue, violet, gray, white, silver, tan, salmon, gold, khaki, and cyan for 16 foreground colors, and black, brown, red, orange, yellow, green, blue, violet, gray, white, silver, tan, salmon, gold, khaki, cyan, and pink for 17 background colors. The first 10 colors of the (16+1)-color scheme has good memorizability based on the color code of resistor. The next 6 colors are lighter colors than the corresponding colors modulus 10. The last color pink is used as the front-slash-wise diagonal background color. After a user has selected a Unicode character image like Box 500, the user is directed to a colorful page for that particular Unicode character like Box 800. There are additional 8 bits from the color secret. Four bits each from the foreground color and background color. For instance, if foreground color of green and background color of blue are selected, then human remembers the {green-blue} and computer encodes as {56}₁₆ where {5}₁₆ is from foreground color and {6}₁₆ is from background color. So for the Han character image of [symbol] {xing} and grid position at east, then the full secret is {661F456}₁₆ where {661F}₁₆ is Unicode encoding of [symbol] , {4}₁₆ is computer-version grid position, {5}₁₆ is foreground color, and the last digit {6}₁₆ is background color. For human, one remembers the full secret as { [symbol] 6 green blue}. This colorful page of Unicode character [symbol] may be form using real-time font rasterization from a font file. Compression algorithms like DJVU may be used, where a colorful page is divided into more than one layer. For the particular case of colorful multilingual key, there are a foreground layer and a background layer.

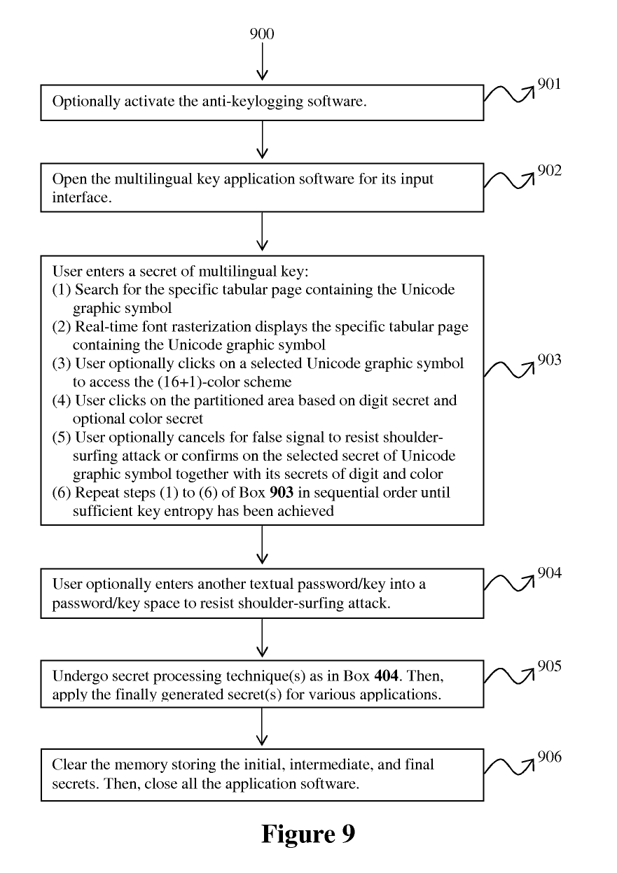

FIG. 9 depicts the operation of multilingual key input method and system. Starting from Entry 900, firstly at Box 901, optionally activate the anti-keylogging software. At Box 902, open the multilingual key software. At Box 903, enter the secrets by first searching for the specific tabular page containing the Unicode graphic symbol, optionally clicking on a selected Unicode graphic symbol to access the (16+1)-color scheme, clicking on the partitioned area based on digit secret and optional color secret, optionally canceling for false signal to resist shoulder-surfing attack or confirming on the selected secret of Unicode graphic symbol together with its secrets of digit and color, and repeating previous steps in Box 903 in sequential order until sufficient key entropy has been achieved. At Box 904, user optionally enters another textual password/key into a password/key space to resist shoulder-surfing attack. At Box 905, undergo secret processing technique(s) as in Box 404, and then apply the finally generated secret(s) for various applications Finally at Box 906, clear the initial, intermediate, and final secrets stored in the computer memory, and close all the application software.

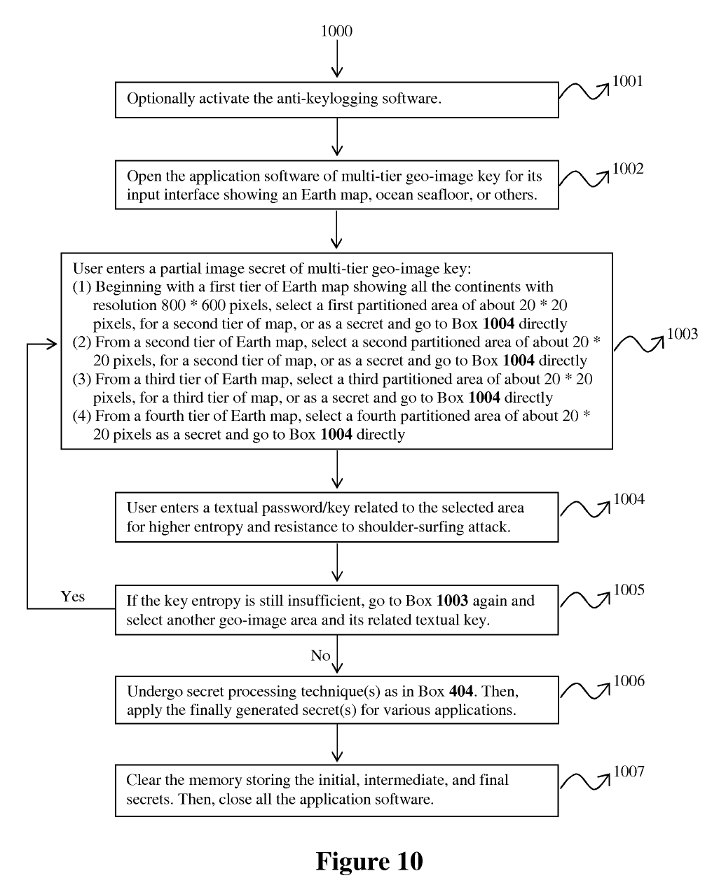

FIG. 10 depicts the operation of multi-tier geo-image key input method and system. Starting from Entry 1000, firstly at Box 1001, optionally activate the anti-keylogging software. At Box 1002, open the multi-tier geo-image key software. At Box 1003, enter a partial image secret. Beginning with a first tier of Earth map showing all the continents with resolution 800*600 pixels, select a first partitioned area of about 20*20 pixels, for a second tier of map, or as a secret and go to Box 1004 directly. From a second tier of Earth map, select a second partitioned area of about 20*20 pixels, for a second tier of map, or as a secret and go to Box 1004 directly. From a third tier of Earth map, select a third partitioned area of about 20*20 pixels, for a third tier of map, or as a secret and go to Box 1004 directly. From a fourth tier of Earth map, select a fourth partitioned area of about 20*20 pixels as a secret and go to Box 1004 directly. At Box 1004, user enters a textual password/key related to the selected area for higher entropy and resistance to shoulder-surfing attack. At Box 1005, if the key entropy is still insufficient, go to Box 1003 again and select another geo-image area and its related textual key; else if key entropy is sufficient, go to Box 1006. At Box 1006, undergo secret processing technique(s) as in Box 404, and then apply the finally generated secret(s) for various applications Finally at Box 1007, clear the initial, intermediate, and final secrets stored in the computer memory, and close all the application software.

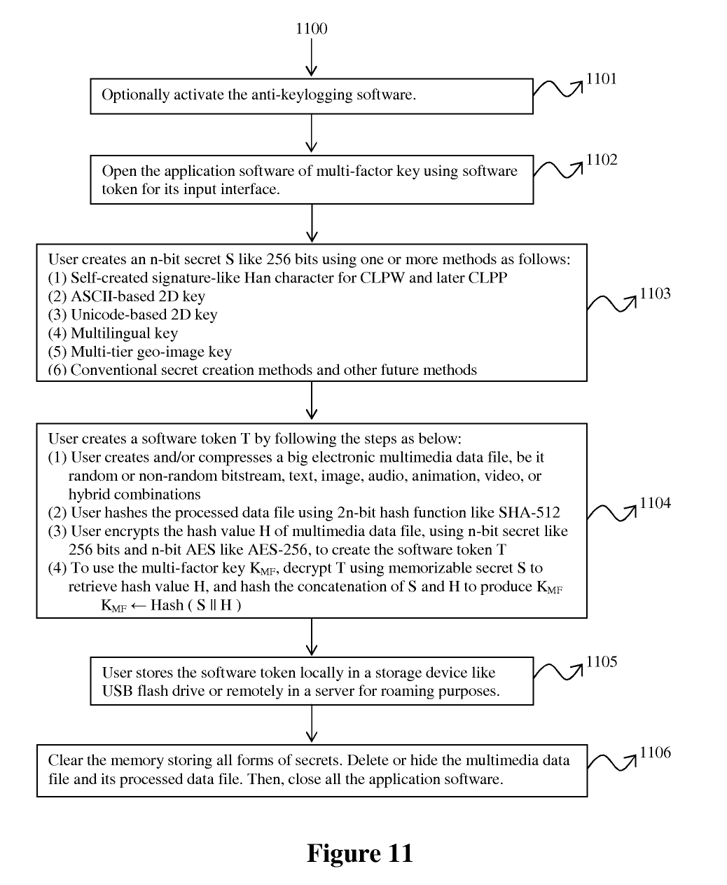

FIG. 11 depicts the software token generation of multi-factor key input method and system. Starting from Entry 1100, firstly at Box 1101, optionally activate the anti-keylogging software. At Box 1102, open the multi-factor key using software token software. At Box 1103, user starts creating an n-bit secret S like 256 bits using one or more methods like self-created signature-like Han character for CLPW and later CLPP, ASCII-based 2D key, Unicode-based 2D key, multilingual key, multi-tier geo-image key, or conventional secret creation methods and other future methods. At Box 1104, user creates a software token T by first creating and/or compressing a big electronic multimedia data file, be it random or non-random bitstream, text, image, audio, animation, video, or hybrid combinations. Then, hash the processed data file using 2n-bit hash function like SHA-512. Later, user encrypts the hash value H of multimedia data file, using n-bit secret like 256 bits and n-bit AES like AES-256, to create the software token T. Lastly, to use the multi-factor key K_{MF}, decrypt T using memorizable secret S to retrieve hash value H, and hash the concatenation of S and H to produce K_{MF}, where K_{MF}←Hash (S∥H). At Box 1105, user stores the software token locally in a storage device like USB flash drive or remotely in a server for roaming purposes. At Box 1106, clear the memory storing all forms of secrets, delete or hide the multimedia data file and its processed data file, and then close all the application software.

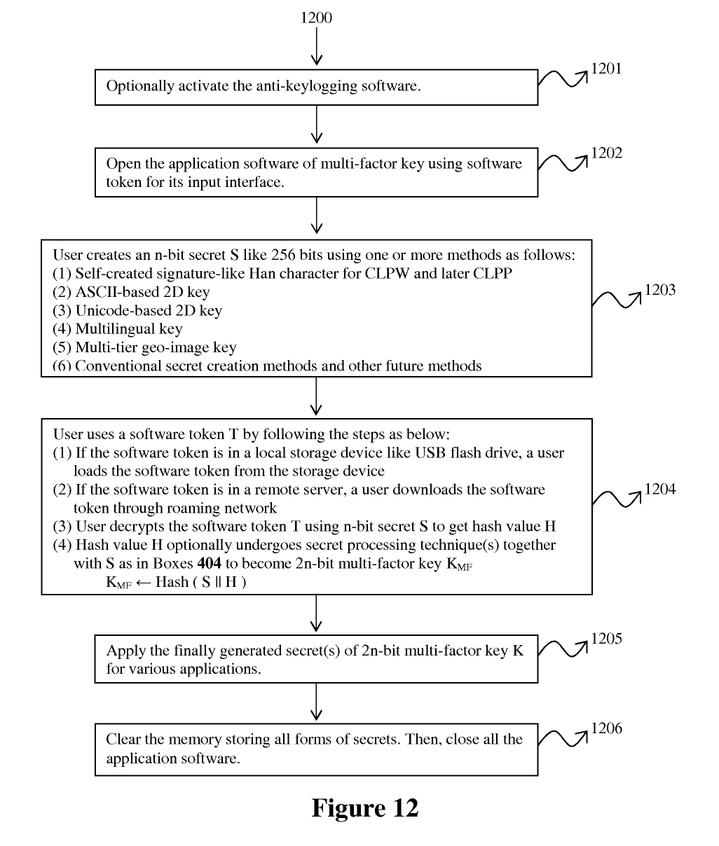

FIG. 12 depicts the software token acquisition and application of multi-factor key input method and system. Starting from Entry 1200, firstly at Box 1201, optionally activate the anti-keylogging software. At Box 1202, open the multi-factor key using software token software. At Box 1203, user starts creating an n-bit secret S like 256 bits using one or more methods like self-created signature-like Han character for CLPW and later CLPP, ASCII-based 2D key, Unicode-based 2D key, multilingual key, multi-tier geo-image key, or conventional secret creation methods and other future methods. At Box 1204, user uses a software token T by following some steps. First, if the software token is in a local storage device like USB flash drive, a user loads the software token from the storage device. Second, if the software token is in a remote server, a user downloads the software token through roaming network. Third, user decrypts the software token T using n-bit secret S to get hash value H. Fourth, hash value H optionally undergoes secret processing technique(s) together with S as in Boxes 404 to become 2n-bit multi-factor key K_{MF}, where K_{MF}←Hash (S∥H). At Box 1205, apply the finally generated secret(s) of 2n-bit multi-factor key K for various applications Finally at Box 1206, clear the memory storing all forms of secrets and then close all the application software.

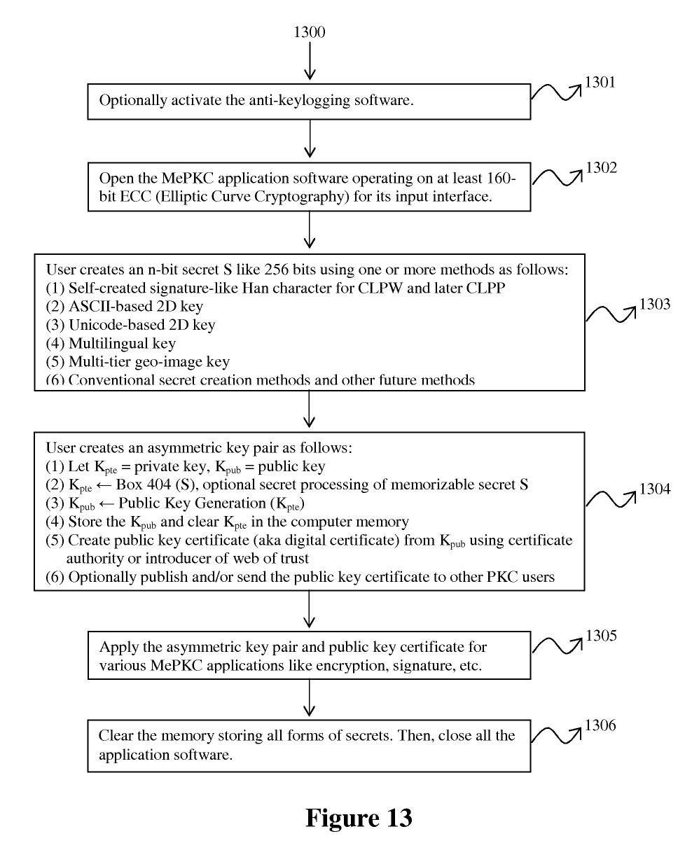

FIG. 13 depicts the operation of MePKC method and system. Starting from Entry 1300, firstly at Box 1301, optionally activate the anti-keylogging software. At Box 1302, open the MePKC application software operating on at least 160-bit ECC (Elliptic Curve Cryptography). At Box 1303, user creates an n-bit secret S like 256 bits using one or more methods like self-created signature-like Han character for CLPW and later CLPP, ASCII-based 2D key, Unicode-based 2D key, multilingual key, multi-tier geo-image key, or conventional secret creation methods and other future methods. At Box 1304, user creates an asymmetric key pair consisting of private key Kₚₜₑ and public key K_{pub}. The Kₚₜₑ may be optionally produced from some secret processing techniques over a memorizable secret as in Box 404, where Kₚₜₑ←Box 404 (S). Then, Kₚₜₑ is used to generate K_{pub}. The K_{pub} is stored and Kₚₜₑ is cleared from computer memory. Later, create public key certificate (aka digital certificate) from K_{pub} using certificate authority or introducer of web of trust. User optionally publishes and/or sends the public key certificate to the other PKC users. At Box 1305, apply the asymmetric key pair and public key certificate for various MePKC applications like encryption, signature, etc Finally at Box 1306, clear the memory storing all forms of secrets and then close all the application software.

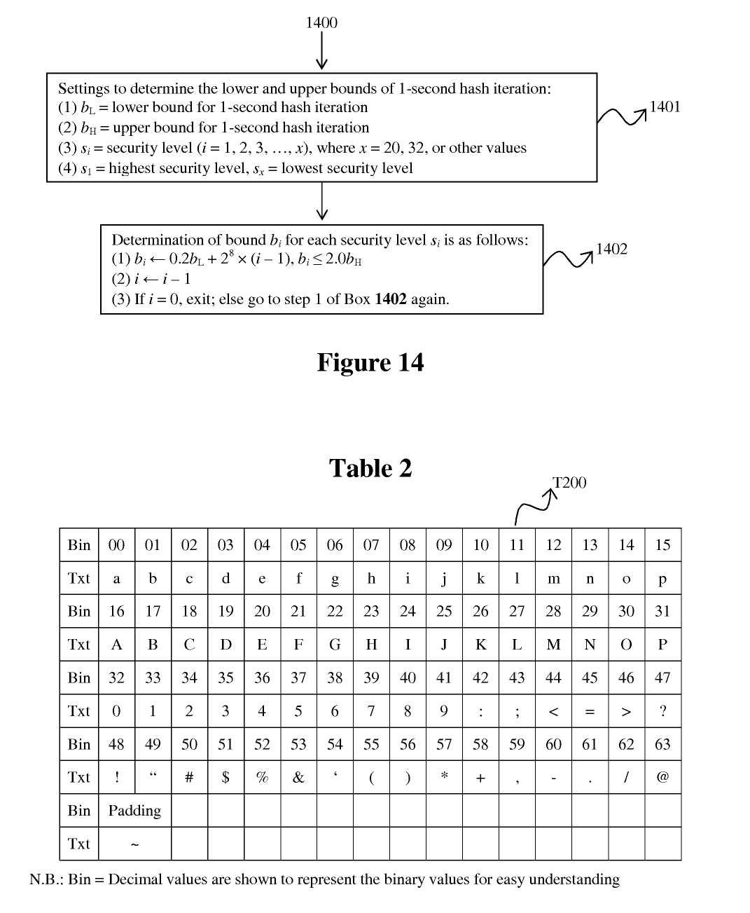

FIG. 14 depicts the pseudo-code to determine the numbers of hash iteration for multiple security levels of multihash key methods and systems. Starting from Entry 1400, at Box 1401, to determine the lower and upper bounds of 1-second hash iteration, let b_{L}=lower bound for 1-second hash iteration, b_{H}=upper bound for 1-second hash iteration, sᵢ=security level (i=1, 2, 3, . . . , x), where x=20, 32, or other values, s₁=highest security level, and sₓ=lowest security level. At Box 1402, determine the bound bᵢ for each security level sᵢ by following steps (1-3) in this box, where bᵢ←0.2b_{L}+2⁸×(i−1), bᵢ≦2.0b_{H}. The acceptable response time is set from 0.2 to 2 seconds.

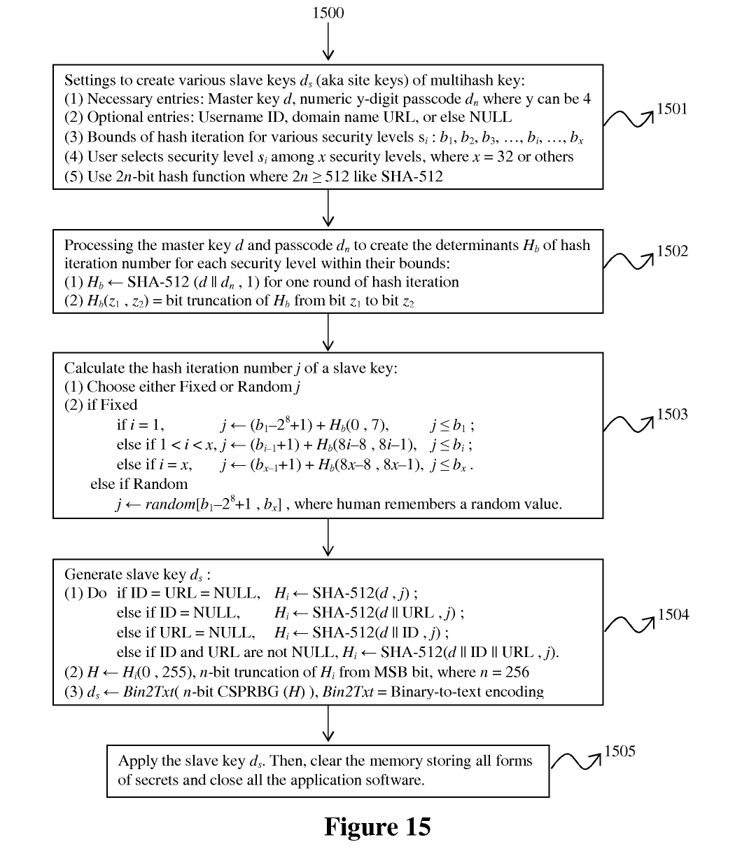

FIG. 15 depicts the operation of the basic model of multihash key method and system. Starting from Entry 1500, Box 1501 gives the settings to create various slave keys dₛ (aka site keys) of multihash key. Necessary entries are master key d, and numeric y-digit passcode dₙ, where y can be 4. Optional entries are username ID, domain name URL, or else NULL. Bounds of hash iteration for various security levels sᵢ are b₁, b₂, b₃, . . . , bᵢ, . . . , bₓ. User selects security level sᵢ among x security levels, where x=20, 32 or others. This method uses 2n-bit hash function, where 2n≧512 like SHA-512. At Box 1502, master key d and passcode dₙ are processed to create the determinants H_{b} of hash iteration number for each security level within their bounds, where H_{b}←SHA-512 (d∥dₙ, 1) for one round of hash iteration. H_{b}(z₁, z₂) means bit truncation of H_{b} from bit z₁ to bit z₂. At Box 1503, calculate the hash iteration number j of a slave key based on a fixed or random option. If fixed option, use the d, dₙ, and selected security level to determine the hash iteration number; else if random option, user remembers the hash iteration number and enters it whenever needed. At Box 1504, slave key dₛ is generated by using the entries, hash iteration number, key strengthening, hash truncation, and binary-to-text encoding. At Box 1505, apply the slave key, clear the memory storing all forms of secrets, and then close all the application software. The passcode here can be optionally replaced by a big memorizable secret for more randomness to support more offline accounts up to S_{AC0}=x. Security level x can be increased up to the maximum of hash iteration number jₘₐₓ. Also, hash functions beyond 512 bits like 768 and 1024 bits may be needed.

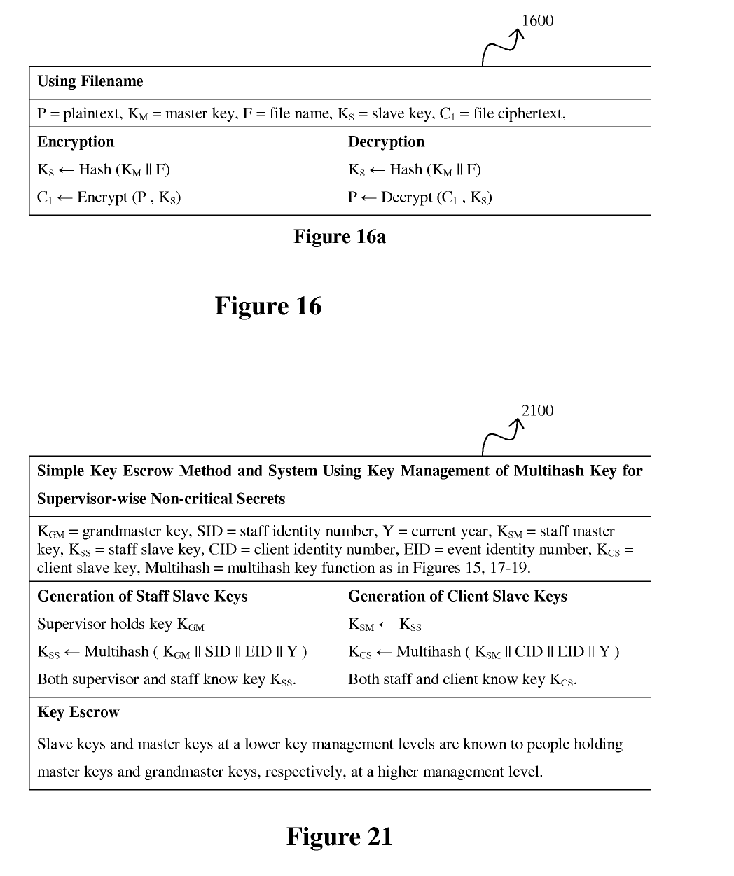

FIG. 16 depicts methods and systems to support more offline accounts for multihash key. FIG. 16A (or 1600) shows the first approach using filename. This method can support almost infinite offline accounts, but its weakness is only the file owner can modify the filename without causing a problem. FIG. 16B (or 1601) shows the second approach using random number without multihash key. This method can also support almost infinite offline account, but there is no key strengthening to freeze the quest for longer key size due to the advancement of computing technologies. Also, an additional ciphertext of random number is required, which means it cannot support secret applications without a ciphertext like MePKC. FIG. 16C (or 1602) shows the third approach using random number with multihash key. This method can support almost infinite offline account, and there is key strengthening to freeze the quest for longer key size. However, it still needs a ciphertext of random number, and hence MePKC is not yet supported. FIG. 16D (or 1603) shows a fourth approach using two-tier structure of multihash key with manually selected security levels. The first slave key from the first tier of multihash key is the master key to the second tier of multihash key. The second slave key from the second tier is the final slave key for various applications. It has key strengthening to freeze the quest for longer key size and yet no ciphertext is needed, which means MePKC is supported. However, the number of supported slave keys is limited to the square of number of security levels x² like 20² and 32². Furthermore, user needs to jot down both the selected security levels somewhere.

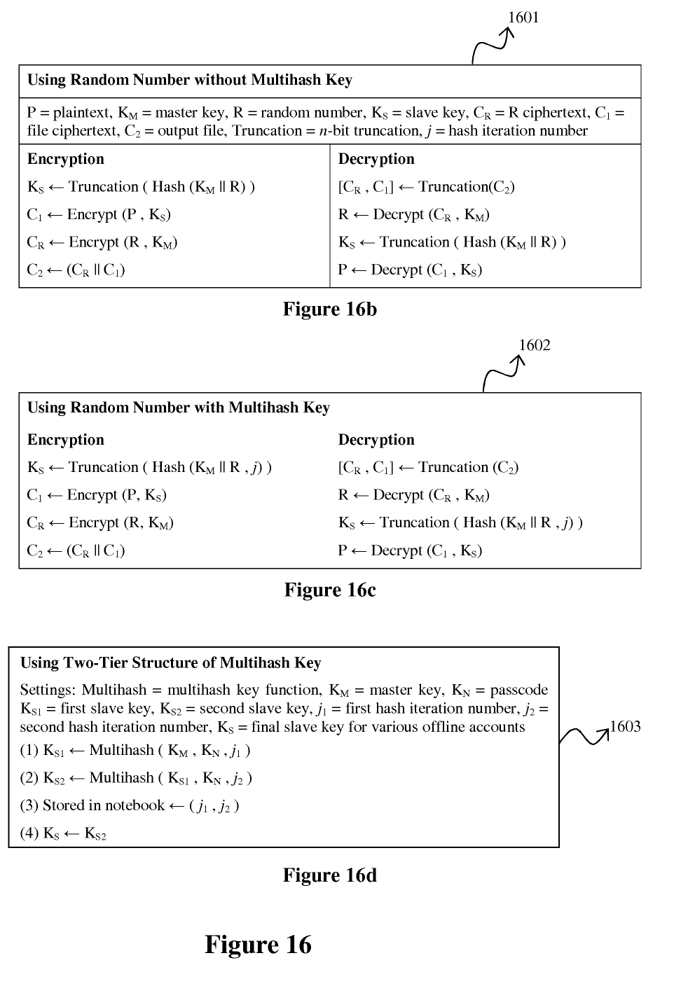

FIG. 17 depicts a first variant of multihash key method and system to support more offline accounts using automatically selected tiers and security levels. Starting from Entry 1700, Box 1701 gives the settings to create various slave keys dₛ (aka site keys) of multihash key. Necessary entries are master key d, numeric y-digit passcode dₙ, where y can be 4, and sequence ID Q. Sequence ID Q can be in plaintext and is used to create multiple unique offline and online slave keys. Q can be jotted down into a notebook, or stored at local and remote servers for future acknowledgment to the user about the Q value of one's account. Optional entries are username ID, domain name URL, or else NULL. Bounds of hash iteration for various security levels sᵢ are b₁, b₂, b₃, . . . , bᵢ, . . . , bₓ. Concatenation of (d∥dₙ∥Q) selects security level sᵢ among x security levels, where x=20, 32 or others. This method uses 2n-bit hash function, where 2n≧512 like SHA-512. H_{b}(z₁, z₂) means bit truncation of H_{b} from bit z₁ to bit z₂. At Box 1702, master key d, passcode dₙ, and sequence ID Q are processed to create the determinants H_{b} of hash iteration number jₜ within their bounds and security levels i=xₜ for each tier of multihash key, and then calculate the hash iteration number jₜ and security level xₜ of each tier t. Here, an intermediate slave key Hₜ is derived at each tier and replaces the dₙ. Repeat step (1) in Box 1702 whenever the maximum number of tier m has not been reached. At Box 1703, final slave key dₛ is generated by directly taking the slave key at the final tier or hashing the concatenation of derived secrets from each tier. At Box 1704, jot down Q or store Q at a remote server as like salt for future access, apply the slave key dₛ, clear the memory storing all forms of secrets, and then close all the application software. The passcode here can be optionally replaced by a big memorizable secret for more randomness to support more offline accounts up to S_{AC1}=x^{m}. Security level x can be increased up to the maximum of hash iteration number jₘₐₓ. Also, hash functions beyond 512 bits like 768 and 1024 bits may be needed.

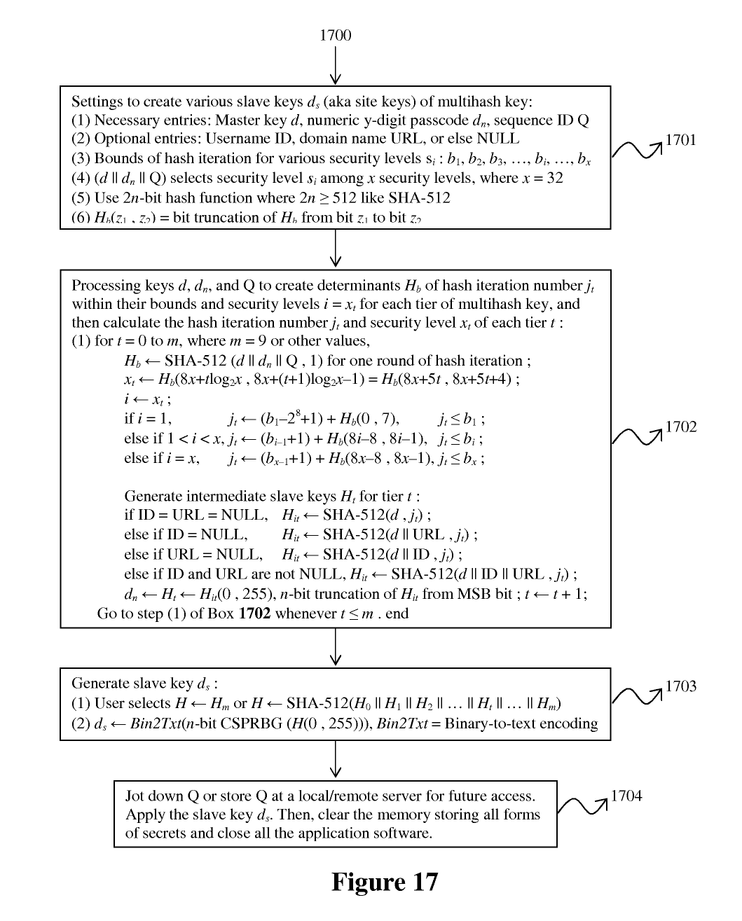

FIG. 18 depicts a second variant of multihash key method and system to support more offline accounts using automatically selected permutation sequence of security levels. Starting from Entry 1800, Box 1801 gives the settings to create various slave keys dₛ (aka site keys) of multihash key. Necessary entries are master key d, numeric y-digit passcode dₙ, where y can be 4, and sequence ID Q. Sequence ID Q can be in plaintext and is used to create multiple unique offline and online slave keys. Q can be jotted down into a notebook, or stored at local and remote servers for future acknowledgment to the user about the Q value of one's account. Optional entries are username ID, domain name URL, or else NULL. Bounds of hash iteration for various security levels sᵢ are b₁, b₂, b₃, . . . , bᵢ, . . . , bₓ. Concatenation of (d∥dₙ∥Q) selects security level sᵢ among x security levels, where x=20, 32 or others. This method uses 2n-bit hash function, where 2n≧512 like SHA-512. At Box 1802, master key d, passcode dₙ, and sequence ID Q are processed to create the determinants H_{b} of hash iteration number jᵢ within their bounds and permutation number pq (=p_{q}) to select a security level i. H_{b}(z₁, z₂) means bit truncation of H_{b} from bit z₁ to bit z₂. At Box 1803, calculate the hash iteration number j, for each security level i. At Box 1804, generate intermediate slave keys Hᵢ at each security level and then slave key dₛ. For the selection of Hᵢ, permutation number p_{q} is generated. The final slave key is the hashing of the concatenation of multiple Hᵢ based on p_{q}. There may be a special permutation number meaning NULL value where no bitstream is concatenated. If all the selected Hᵢ are NULL, then select another dₙ and repeat all the steps. At Box 1805, jot down Q or store Q at a remote server as like salt for future access, apply the slave key dₛ, clear the memory storing all forms of secrets, and then close all the application software. Let T be the maximum number of concatenated Hᵢ based on p_{q}. The passcode here can be optionally replaced by a big memorizable secret for more randomness to support more offline accounts up to

$${S}_{AC 2} = {\sum }_{y = 1}^{y = T} {x}^{y} .$$

Security level x can be increased up to the maximum of hash iteration number jₘₐₓ. Also, hash functions beyond 512 bits like 768 and 1024 bits may be needed.

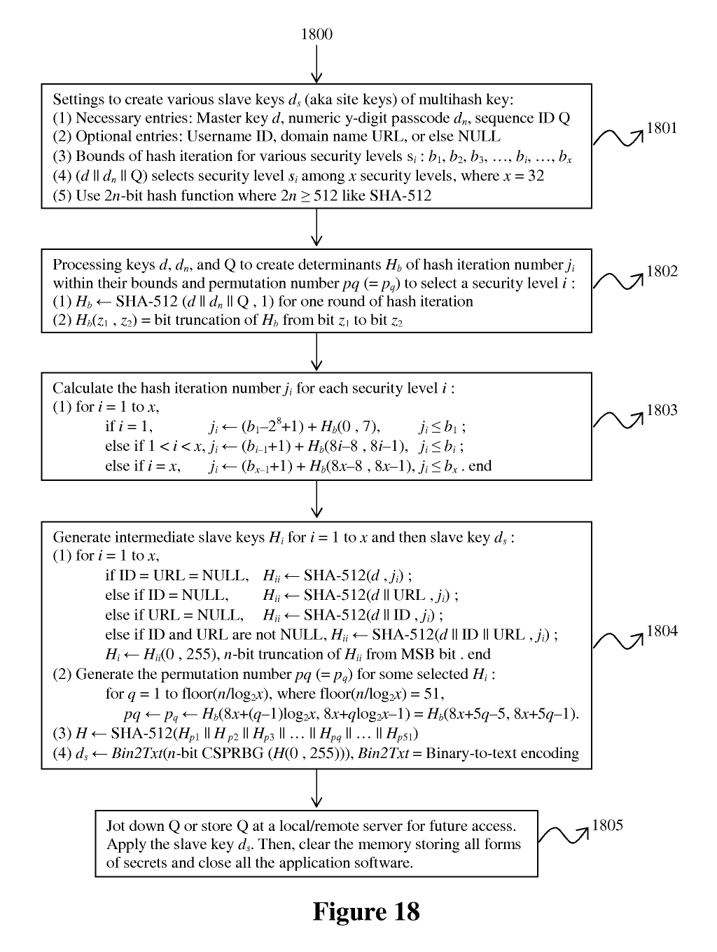

FIG. 19 depicts a third variant of multihash key method and system to support more offline accounts using a hybrid combination of automatically selected tiers and security levels, and automatically selected permutation sequence of security levels. This variant is in fact the hybrid combination of the first and second variants. Firstly, do the operations in Box 1701. Then, at Box 1900, master key d, passcode dₙ, and sequence ID Q are processed to create the determinants H_{b} of hash iteration number jᵢ within their bounds, permutation number pq (=p_{q}) to select a security level i, and security levels i for each tier t of multihash key. Here, calculate the hash iteration number jᵢ for each security level i at tier t. Generate first intermediate slave keys H₁ᵢ for i=1 to x at tier t. Generate the permutation number pq (=p_{q}) for some selected H₁ᵢ at tier t. Generate second intermediate slave keys H₂ₜ for tier t and replaces the dₙ. Repeat steps (1.0-1.4) in Box 1900 whenever the maximum number of tier m has not been reached. There may be a special permutation number meaning NULL value where no bitstream is concatenated. If all the selected Hᵢ are NULL, then select another dₙ and repeat all the steps. At Box 1901, final slave key dₛ is generated by directly taking the slave key at the final tier or hashing the concatenation of derived secrets from each tier. At Box 1902, jot down Q or store Q at a remote server as like salt for future access, apply the slave key dₛ, clear the memory storing all forms of secrets, and then close all the application software. Sequence ID Q can be in plaintext and is used to create multiple unique offline and online slave keys. Q can be jotted down into a notebook, or stored at local and remote servers for future acknowledgment to the user about the Q value of one's account. Let T be the maximum number of concatenated H₁ᵢ based on p_{q}. The passcode here can be optionally replaced by a big memorizable secret for more randomness to support more offline accounts up to

$${S}_{AC 3} = {( {\sum }_{y = 1}^{y = T} {x}^{y} )}^{m} .$$

Security level x can be increased up to the maximum of hash iteration number jₘₐₓ. Also, hash functions beyond 512 bits like 768 and 1024 bits may be needed.

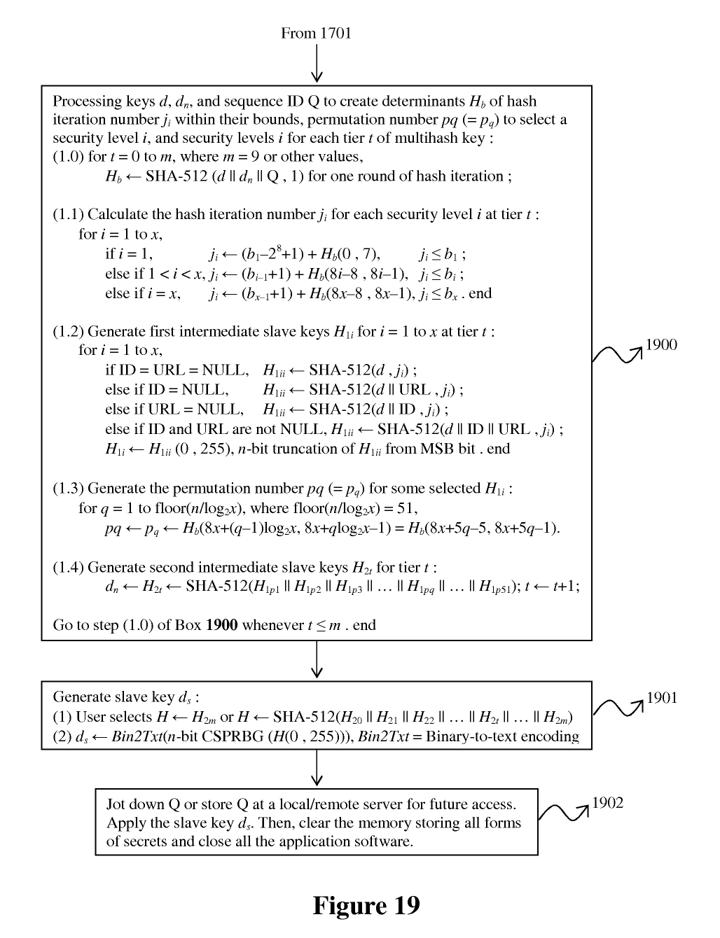

FIG. 20 depicts a fourth variant of multihash key method and system for the specific application to act as a further authentication factor in the Internet banking or other situations. Starting from Entry 2000, at Box 2001, bank and user apply a key exchange protocol to establish a shared master key d, optional passcode dₙ, and initial downcount/upcount number N for hash iteration in multihash key. Set N=N_{c} initially. At Box 2002 for Internet banking transaction needing a second authentication factor, it is triggered by a user requesting for execution of a transaction that needs further authentication. Bank server then sends a first message with random value R, timestamp T, current downcount/upcount number N_{c} to the remote user in a secure channel like SSL. At Box 2003 for user response to the bank's challenge, user uses the downcount/upcount number N_{c} as the hash iteration number of a multihash key process to generate a slave key dₛ₁ from master key d and pin dₙ. Then, user uses the slave key dₛ₁ to encrypt the first message to create a second message using symmetric key cipher. Later, user sends the second message as response to the bank server in a secure channel like SSL for further authentication. At Box 2004 for verification of user's response by bank server, bank uses the downcount/upcount number N_{c} as the hash iteration number of a multihash key process to generate a slave key dₛ₂ from shared keys d and dₙ. Then, bank decrypts the second message using slave key dₛ₂ to get a third message. If the first message and third message are identical, then the user is verified and authenticated for further user-selected transaction. Otherwise if the first message and third message are not identical, then the user is rejected for further user-selected transaction. If the user is verified for further authentication, decrement the N_{c} by one unit for downcount, or increment the N_{c} by one unit for upcount. If the user is rejected for further authentication, user chooses to go to step (1) in Box 2002 for re-try or go to Box 2005 for exit. For re-try or new request for further authentication, go to step (1) in Box 2002. Otherwise, go to Box 2003 to clear the memory storing all forms of secrets and close all the application software.

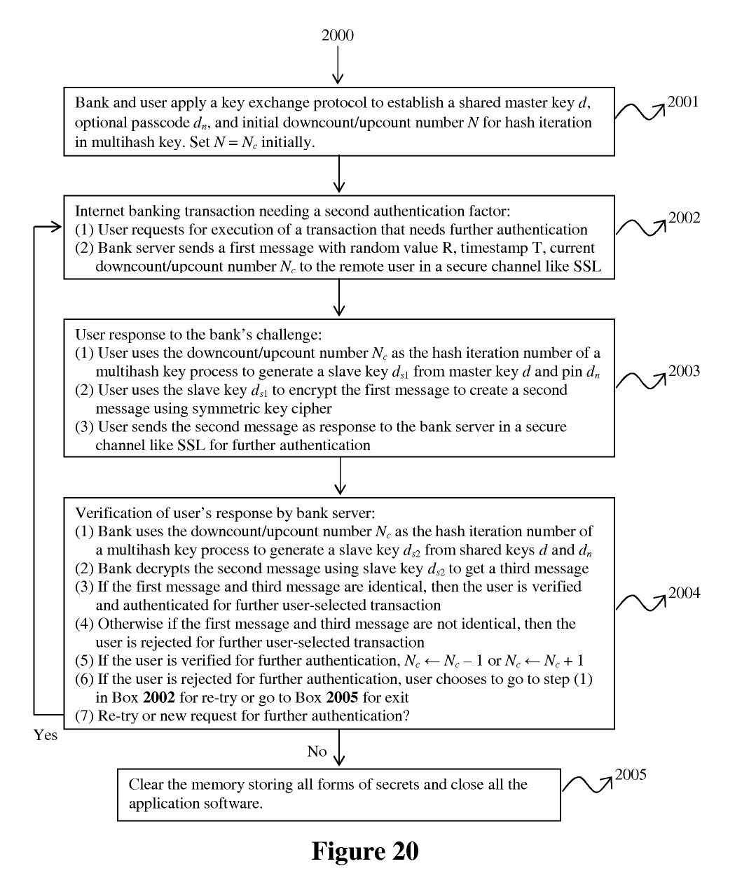

FIG. 21 (or 2100) depicts a fifth variant of multihash key method and system for the specific application to act as a simple key escrow method and system for supervisor-wise non-critical secrets. Key management of multihash key is applied here. Slave keys and master keys at a lower key management levels are known to people holding master keys and grandmaster keys, respectively, at a higher management level. For the generation of staff slave keys, a supervisor holding grandmaster key K_{GM} uses the staff identity number SID, event identity number EID, and current year Y, to generate staff slave keys K_{SS} from multihash key for different applications, where K_{SS}←Multihash (K_{GM}∥SID∥EID∥Y). A staff stores all one's staff slave keys into one's password vault. For the generation of client slave keys, a staff slave key becomes a staff master key K_{SM}. K_{SM} is used together with client identity number CID, event identity number EID, and current year Y to generate client slave keys from multihash key again for different applications, where K_{CS}←Multihash (K_{SM}∥CID∥EID∥Y). A client stores all one's client slave keys into one's password vault. In this way, the higher management people have escrowed the slave keys at the lower levels. This approach can be used for supervisor-wise non-critical secrets but confidential to the external parties.

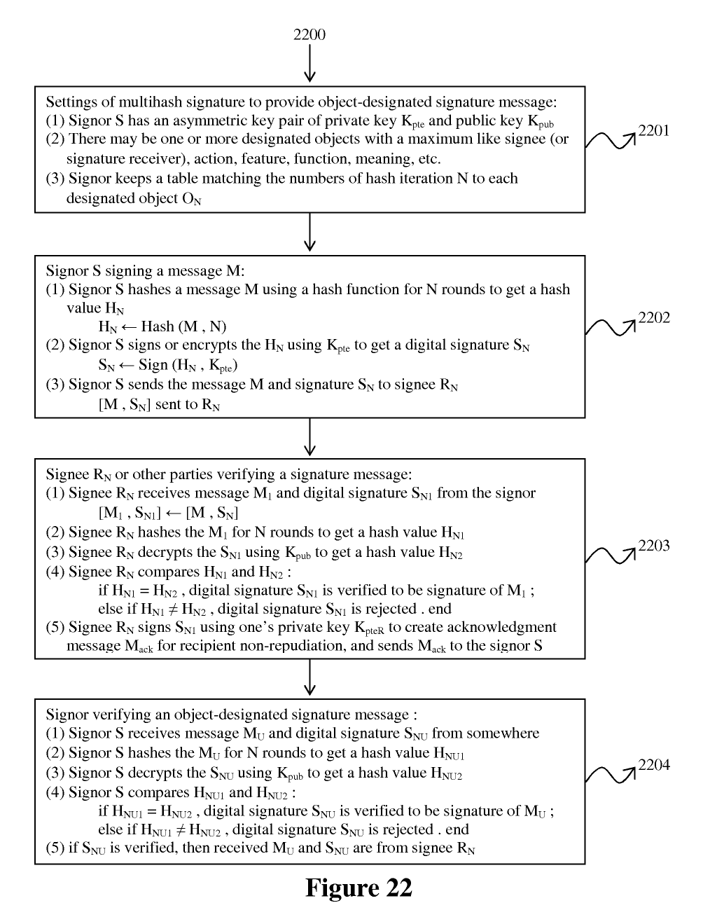

FIG. 22 depicts the multihash signature method and system to provide object-designated signature message. Starting from Entry 2200, Box 2201 shows settings of multihash signature to provide object-designated signature message. Signor S has an asymmetric key pair of private key Kₚₜₑ and public key K_{pub}. There may be one or more designated objects with a maximum like signee (or signature receiver), action, feature, function, etc. Signor keeps a table matching the numbers of hash iteration N to each designated object O_{N}. At Box 2202, it shows the operations for the signor S signing a message M. Signor S hashes a message M using a hash function for N rounds to get a hash value H_{N}. Signor S signs or encrypts the H_{N} using Kₚₜₑ to get a digital signature S_{N}. Signor S sends the message M and signature S_{N} to signee R_{N}. At Box 2203, it shows the operations for signee R_{N} or other parties verifying a signature message. Signee R_{N} receives message M₁ and digital signature S_{N1} from the signor. Signee R_{N} hashes the M₁ for N rounds to get a hash value H_{N1}. Signee R_{N} decrypts the S_{N1} using K_{pub} to get a hash value H_{N2}. Signee R_{N} compares H_{N1} and H_{N2}. If H_{N1}=H_{N2}, digital signature S_{N1} is verified to be signature of M₁; else if H_{N1}≠H_{N2}, digital signature S_{N1} is rejected. Signee R_{N} signs S_{N1} using one's private key K_{pteR} to create acknowledgment message M_{ack} for recipient non-repudiation, and sends M_{ack} to the signor S. At receives message M_{U} and digital signature S_{NU} from somewhere. Signor S hashes the M_{U} for N rounds to get a hash value H_{NU1}. Signor S decrypts the S_{NU} using K_{pub} to get a hash value H_{NU2}. Signor S compares H_{NU1} and H_{NU2}. If H_{NU1}=H_{NU2}, digital signature S_{NU} is verified to be signature of M_{U}; else if H_{NU1}≠H_{NU2}, digital signature S_{NU} is rejected. If S_{NU} is verified, then received M_{U} and S_{NU} are from signee R_{N}. Signor S can also use the M_{ack} as the non repudiation message for signee R_{N}. The specific object-designated signature message here is a recipient. Likewise, it can be any other objects like action, feature, function, or meaning, such as the cheque validity status.

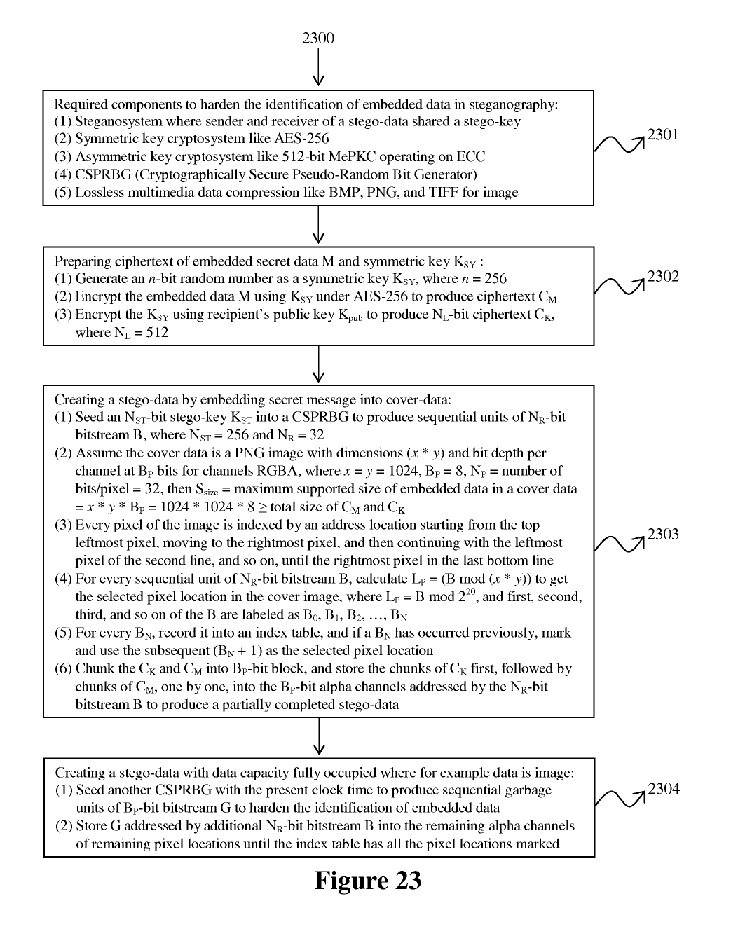

FIG. 23 depicts the data embedding process into a cover data for method and system to harden the identification of an embedded data in steganography although stego-data has been detected. Starting from Entry 2300, Box 2301 shows the required components to harden the identification of embedded data in steganography. These components are steganosystem where sender and receiver of a stego-data shared a stego-key, symmetric key cryptosystem like AES-256, asymmetric key cryptosystem like 512-bit MePKC operating on ECC, CSPRBG (Cryptographically Secure Pseudo-Random Bit Generator), and lossless multimedia data compression like BMP, PNG, and TIFF for image. Box 2302 shows the operation to prepare the ciphertext of embedded secret data M and symmetric key K_{SY}. Firstly, generate an n-bit random number as a symmetric key K_{SY}, where n=256. Then, encrypt the embedded data M using K_{SY} under AES-256 to produce ciphertext C_{M}. Later, encrypt the K_{SY} using recipient's public key K_{pub} to produce N_{L}-bit ciphertext C_{K}, where N_{L}=512. Box 2303 shows the operations to create a stego-data by embedding secret message into cover-data. Firstly, seed an N_{ST}-bit stego-key K_{ST} into a CSPRBG to produce sequential units of N_{R}-bit bitstream B, where N_{ST}=256 and N_{R}=32. Assume the cover data is a PNG image with dimensions (x*y) and bit depth per channel at B_{P} bits for channels RGBA, where x=y=1024, B_{P}=8, N_{P}=number of bits/pixel=32, then S_{size}=maximum supported size of embedded data in a cover data=x*y*B_{P}=1024*1024*8≧total size of C_{M} and C_{K}. Every pixel of the image is indexed by an address location starting from the top leftmost pixel, moving to the rightmost pixel, and then continuing with the leftmost pixel of the second line, and so on, until the rightmost pixel in the last bottom line. For every sequential unit of N_{R}-bit bitstream B, calculate L_{P}=(B mod (x*y)) to get the selected pixel location in the cover image, where L_{P}=B mod 2²⁰, and first, second, third, and so on of the B are labeled as B₀, B₁, B₂, . . . , B_{N}. For every B_{N}, record it into an index table, and if a B_{N} has occurred previously, mark and use the subsequent (B_{N}+1) as the selected pixel location. Chunk the C_{K} and C_{M} into B_{P}-bit block, and store the chunks of C_{K} first, followed by chunks of C_{M}, one by one, into the B_{P}-bit alpha channels addressed by the N_{R}-bit bitstream B to produce a partially completed stego-data. Box 2304 shows the operations to create a stego-data with data capacity fully occupied, where for example data is an image. Seed another CSPRBG with the present clock time to produce sequential garbage units of B_{P}-bit bitstream G to harden the identification of embedded data Finally, store G addressed by additional N_{R}-bit bitstream B into the remaining alpha channels of remaining pixel locations until the index table has all the pixel locations marked.

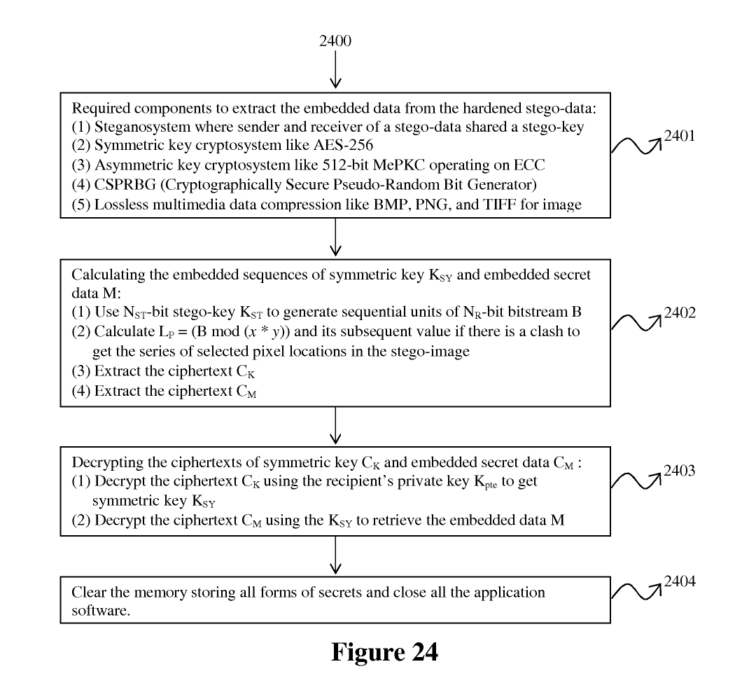

FIG. 24 depicts the data extracting process of embedded data from a stego-data for method and system to harden the identification of an embedded data in steganography although stego-data has been detected. Starting from Entry 2400, Box 2401 shows the required components to harden the identification of embedded data in steganography. These components are steganosystem where sender and receiver of a stego-data shared a stego-key, symmetric key cryptosystem like AES-256, asymmetric key cryptosystem like 512-bit MePKC operating on ECC, CSPRBG (Cryptographically Secure Pseudo-Random Bit Generator), and lossless multimedia data compression like BMP, PNG, and TIFF for image. Box 2402 shows the operations to calculate the embedded sequences of symmetric key K_{SY} and embedded secret data M. Firstly, use N_{ST}-bit stego-key K_{ST} to generate sequential units of N_{R}-bit bitstream B. Secondly, calculate L_{P}=(B mod (x*y)) and its subsequent value if there is a clash to get the series of selected pixel locations in the stego-image. Then, extract the ciphertext C_{K}, followed by ciphertext C_{M}. Box 2403 shows the operations to decrypt the ciphertexts of symmetric key C_{K} and embedded secret data C_{M}. Decrypt the ciphertext C_{K} using the recipient's private key Kₚₜₑ to get symmetric key K_{SY}. Then, decrypt the ciphertext C_{M} using the K_{SY} to retrieve the embedded data M. Lastly at Box 2404, clear the memory storing all forms of secrets and close all the application software.

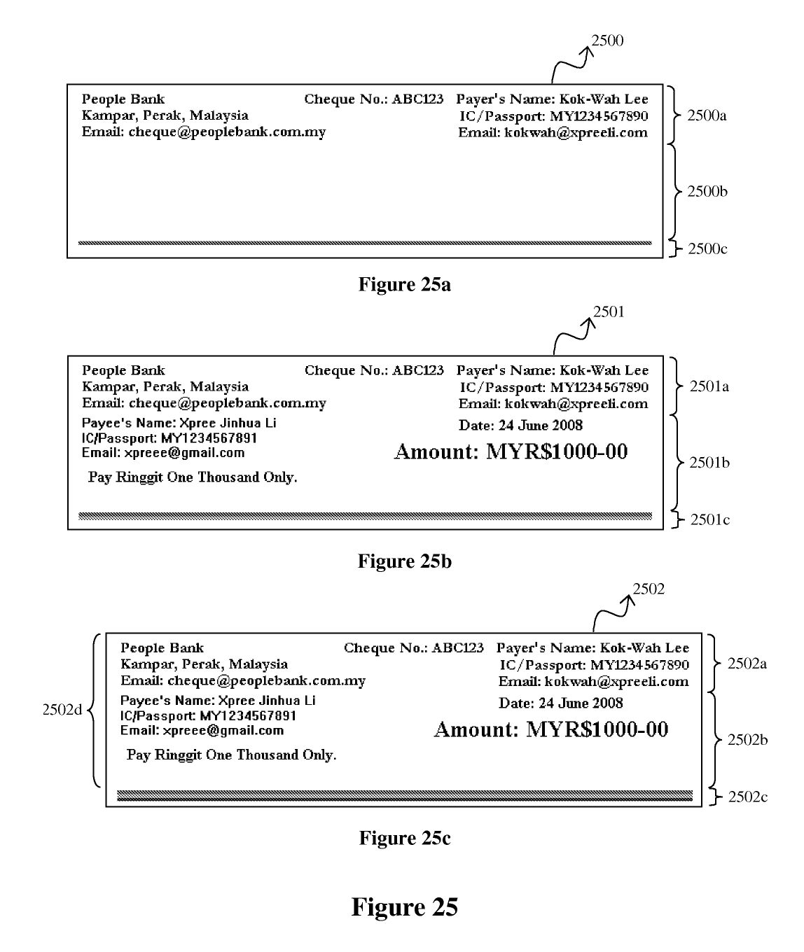

FIG. 25 depicts the samples of digital cheque in triple-watermark digital cheque scheme, wherein FIG. 25A (or 2500 consisting of 2500a, 2500b, and 2500c) shows a blank cheque issued by bank to payer; FIG. 25B (or 2501 consisting of 2501a, 2501b, and 2501c) shows a written cheque signed by payee; and FIG. 25C (or 2502 consisting of 2502a, 2502b, 2502c, and 2502d) shows a processed payee's cheque by bank. The blank cheque shall carry the basic information about payer's bank, payer, and cheque number, which is signed and endorsed by the payer's bank to create a watermark in the red band. The written cheque shall carry the information about payee and cheque amount, where this information together with the information of payer's bank, payer, and cheque number, shall be signed and endorsed by payer to create a watermark in the green band. The processed cheque shall be signed and endorsed by payer's bank to create a watermark in the blue band to acknowledge the current cheque validity status.

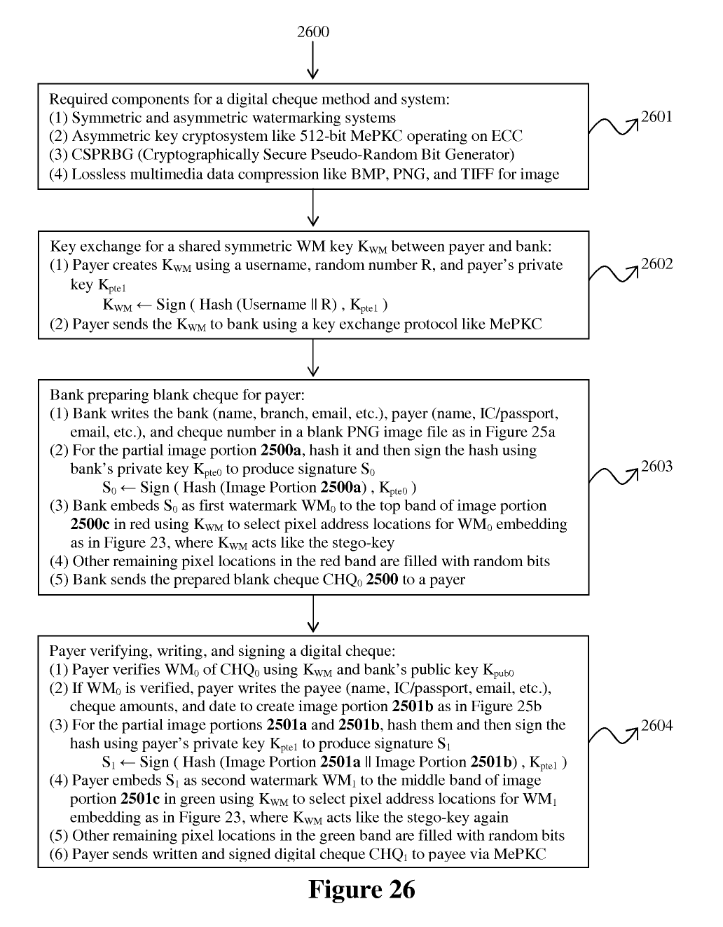

FIG. 26 depicts the creation of blank cheque by a bank and written cheque by a payer in the triple-watermark digital cheque method and system. Starting from Entry 2600, Box 2601 shows the required components for a digital cheque method and system. These components are symmetric and asymmetric watermarking systems, asymmetric key cryptosystem like 512-bit MePKC operating on ECC, CSPRBG (Cryptographically Secure Pseudo-Random Bit Generator), and lossless multimedia data compression like BMP, PNG, and TIFF for image. Box 2602 shows the key exchange for a shared symmetric watermarking key K_{WM} between payer and bank. Payer creates K_{WM} using a username, random number R, and payer's private key Kₚₜₑ₁, where K_{WM}←Sign (Hash (Username∥R), Kₚₜₑ₁), and sends the K_{WM} to bank using a key exchange protocol like MePKC. Box 2603 shows bank preparing a blank cheque for payer. Firstly, bank writes the bank (name, branch, email, etc.), payer (name, IC/passport, email, etc.), and cheque number in a blank PNG image file as in FIG. 25A. For the partial image portion 2500a, hash it and then sign the hash using bank's private key Kₚₜₑ₀ to produce signature S₀, where S₀←Sign (Hash (Image Portion 2500a), Kₚₜₑ₀). Then, bank embeds S₀ as first watermark WM₀ to the top band of image portion 2500c in red band using K_{WM} to select pixel address locations for WM₀ embedding as in FIG. 23, where K_{WM} acts like the stego-key. Other remaining pixel locations in the red band are filled with random bits. Bank sends the prepared blank cheque CHQ₀ 2500 to a payer. Box 2604 shows payer verifying, writing, and signing a digital cheque. Firstly, payer verifies WM₀ of CHQ₀ using K_{WM} and bank's public key K_{pub0}. If WM₀ is verified, payer writes the payee (name, IC/passport, email, etc.), cheque amounts, and date to create image portion 2501b as in FIG. 25B. For the partial image portions 2501a and 2501b, hash them and then sign the hash using payer's private key Kₚₜₑ₁ to produce signature S₁, where S₁←Sign (Hash (Image Portion 2501a∥Image Portion 2501b), Kₚₜₑ₁). Later, payer embeds S₁ as second watermark WM₁ to the middle band of image portion 2501c in green band using K_{WM} to select pixel address locations for WM₁ embedding as in FIG. 23, where K_{WM} acts like the stego-key again. Other remaining pixel locations in the green band are filled with random bits Finally, payer sends written and signed digital cheque CHQ₁ to payee via MePKC.

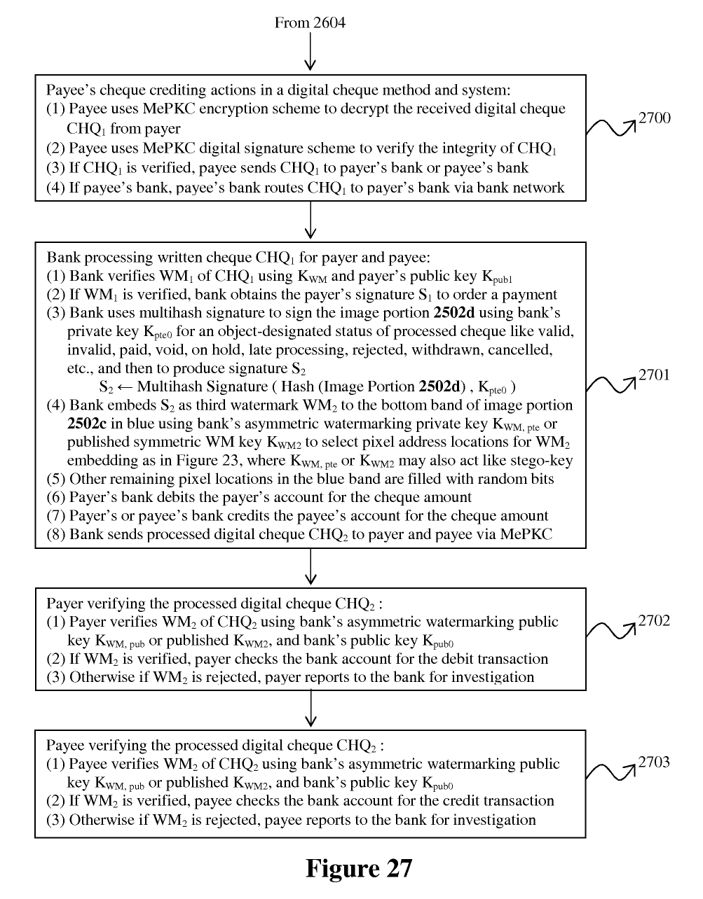

FIG. 27 depicts the cheque crediting process by a payee in the triple-watermark digital cheque method and system. After Box 2604, Box 2700 shows payee's cheque crediting actions in a digital cheque method and system. Firstly, payee uses MePKC encryption scheme to decrypt the received digital cheque CHQ₁ from payer. Then, payee uses MePKC digital signature scheme to verify the integrity of CHQ₁. If CHQ₁ is verified, payee sends CHQ₁ to payer's bank or payee's bank. If it is payee's bank, payee's bank routes CHQ₁ to payer's bank via bank network. Box 2701 shows bank processing written cheque CHQ₁ for payer and payee. Firstly, bank verifies WM₁ of CHQ₁ using K_{WM} and payer's public key K_{pub1}. If WM₁ is verified, bank obtains the payer's signature S₁ to order a payment. Bank uses multihash signature to sign the image portion 2502d using bank's private key Kₚₜₑ₀ for an object-designated status of processed cheque like valid, invalid, paid, void, on hold, late processing, rejected, withdrawn, cancelled, etc., and then to produce signature S₂, where S₂←Multihash Signature (Hash (Image Portion 2502d), Kₚₜₑ₀). Bank embeds S₂ as third watermark WM₂ to the bottom band of image portion 2502c in blue using bank's asymmetric watermarking private key K_{WM, pte} or published symmetric watermarking key K_{WM2} to select pixel address locations for WM₂ embedding as in FIG. 23, where K_{WM, pte} or K_{WM2} may also act like stego-key. Other remaining pixel locations in the blue band are filled with random bits. Payer's bank debits the payer's account for the cheque amount. Payer's or payee's bank credits the payee's account for the cheque amount. Bank sends processed digital cheque CHQ₂ to payer and payee via MePKC. Box 2702 shows payer verifying the processed digital cheque CHQ₂. Firstly, payer verifies WM₂ of CHQ₂ using bank's asymmetric watermarking public key K_{WM, pub} or published K_{WM2}, and bank's public key K_{pub0}. If WM₂ is verified, payer checks the bank account for the debit transaction. Otherwise if WM₂ is rejected, payer reports to the bank for investigation. Box 2703 shows payee verifying the processed digital cheque CHQ₂. Firstly, payee verifies WM₂ of CHQ₂ using bank's asymmetric watermarking public key K_{WM, pub} or published K_{WM2}, and bank's public key K_{pub0}. If WM₂ is verified, payee checks the bank account for the credit transaction. Otherwise if WM₂ is rejected, payee reports to the bank for investigation.

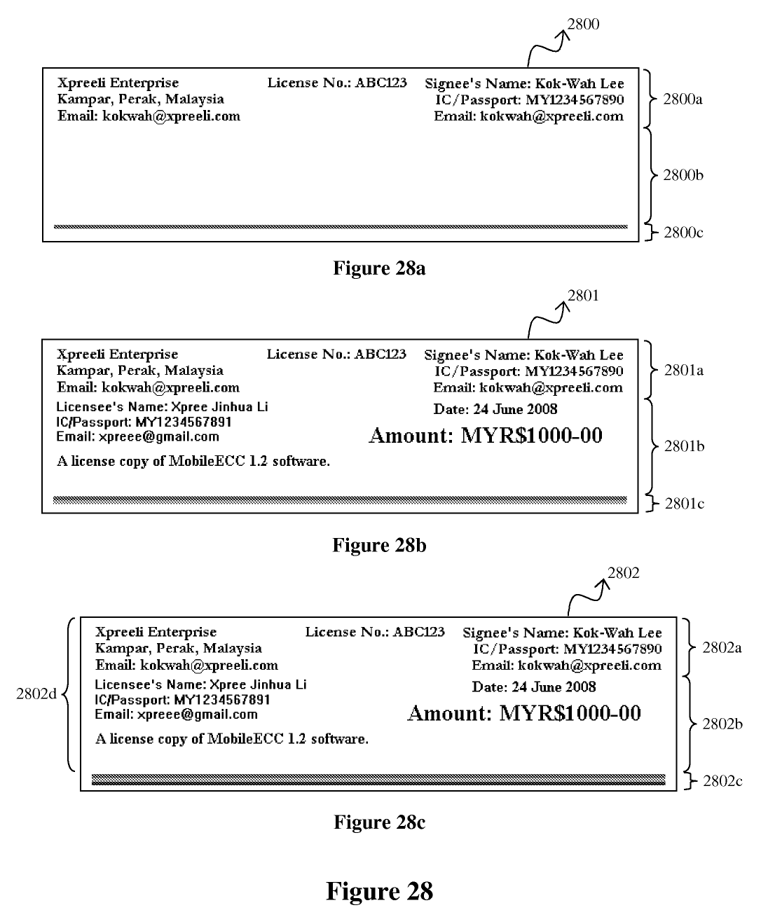

FIG. 28 depicts the samples of digital software license in triple-watermark digital software license scheme, wherein FIG. 28A (or 2800 consisting of 2800a, 2800b, and 2800c) shows a blank software license issued by software vendor to reseller (or sales agent); FIG. 28B (or 2801 consisting of 2801a, 2801b, and 2801c) shows a written software license signed by reseller; and FIG. 28C (or 2802 consisting of 2802a, 2802b, 2802c, and 2802d) shows a processed software license by vendor. The blank software license shall carry the basic information about software vendor, reseller, and license number, which is signed and endorsed by the software vendor to create a watermark in the red band. The written software license shall carry the information about licensee (aka buyer), license details, and license price, where this information together with the information of software vendor, reseller, and license number, shall be signed and endorsed by reseller to create a watermark in the green band. The processed software license shall be signed and endorsed by software vendor to create a watermark in the blue band to acknowledge the current license validity status.

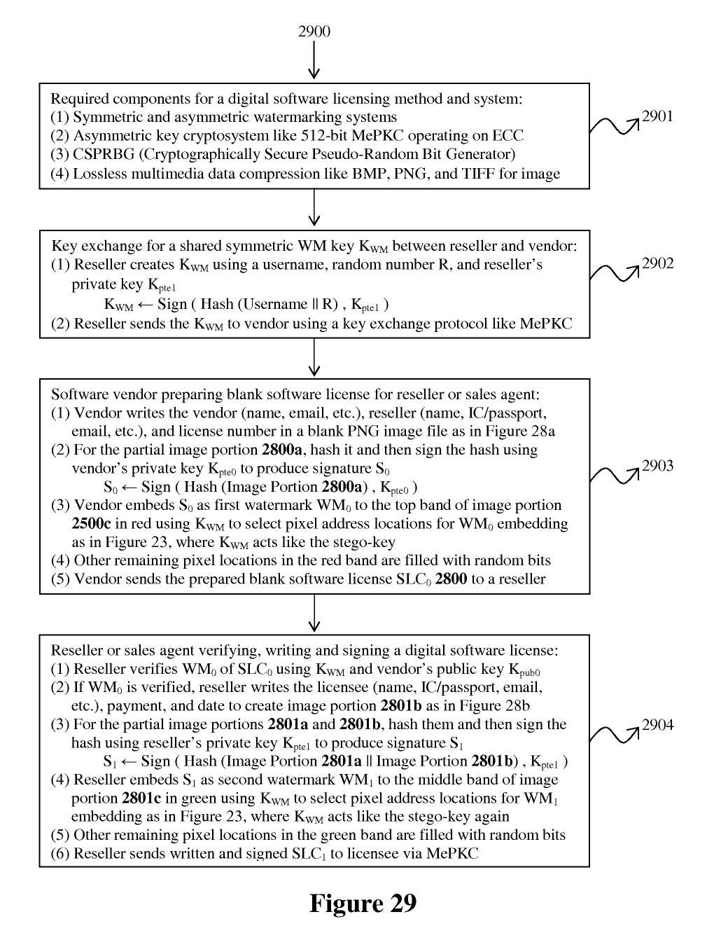

FIG. 29 depicts the creation of blank software license by a vendor and written software license by a reseller in the triple-watermark digital software license method and system. Starting from Entry 2900, Box 2901 shows the required components for a digital software licensing method and system. These components are symmetric and asymmetric watermarking systems, asymmetric key cryptosystem like 512-bit MePKC operating on ECC, CSPRBG (Cryptographically Secure Pseudo-Random Bit Generator), and lossless multimedia data compression like BMP, PNG, and TIFF for image. Box 2902 shows key exchange for a shared symmetric watermarking key K_{WM} between reseller and vendor. Firstly, reseller creates K_{WM} using a username, random number R, and reseller's private key Kₚₜₑ₁, where K_{WM}←Sign (Hash (Username∥R), Kₚₜₑ₁). Reseller sends the K_{WM} to vendor using a key exchange protocol like MePKC. Box 2903 shows software vendor preparing blank software license for reseller or sales agent. Firstly, vendor writes the vendor (name, email, etc.), reseller (name, IC/passport, email, etc.), and license number in a blank PNG image file as in FIG. 28A. For the partial image portion 2800a, hash it and then sign the hash using vendor's private key Kₚₜₑ₀ to produce signature S₀, S₀←Sign (Hash (Image Portion 2800a), Kₚₜₑ₀). Vendor embeds S₀ as first watermark WM₀ to the top band of image portion 2800c in red band using K_{WM} to select pixel address locations for WM₀ embedding as in FIG. 23, where K_{WM} acts like the stego-key. Other remaining pixel locations in the red band are filled with random bits. Vendor sends the prepared blank software license SLC₀ 2800 to a reseller. Box 2904 shows reseller or sales agent verifying, writing and signing a digital software license. Firstly, Reseller verifies WM₀ of SLC₀ using K_{WM} and vendor's public key K_{pub0}. If WM₀ is verified, reseller writes the licensee (name, IC/passport, email, etc.), payment, and date to create image portion 2801b as in FIG. 28B. For the partial image portions 2801a and 2801b, hash them and then sign the hash using reseller's private key Kₚₜₑ₁ to produce signature S₁, where S₁←Sign (Hash (Image Portion 2801a∥Image Portion 2801b), Kₚₜₑ₁). Reseller embeds S₁ as second watermark WM₁ to the middle band of image portion 2801c in green band using K_{WM} to select pixel address locations for WM₁ embedding as in FIG. 23, where K_{WM} acts like the stego-key again. Other remaining pixel locations in the green band are filled with random bits. Reseller sends written and signed SLC₁ to licensee via MePKC.

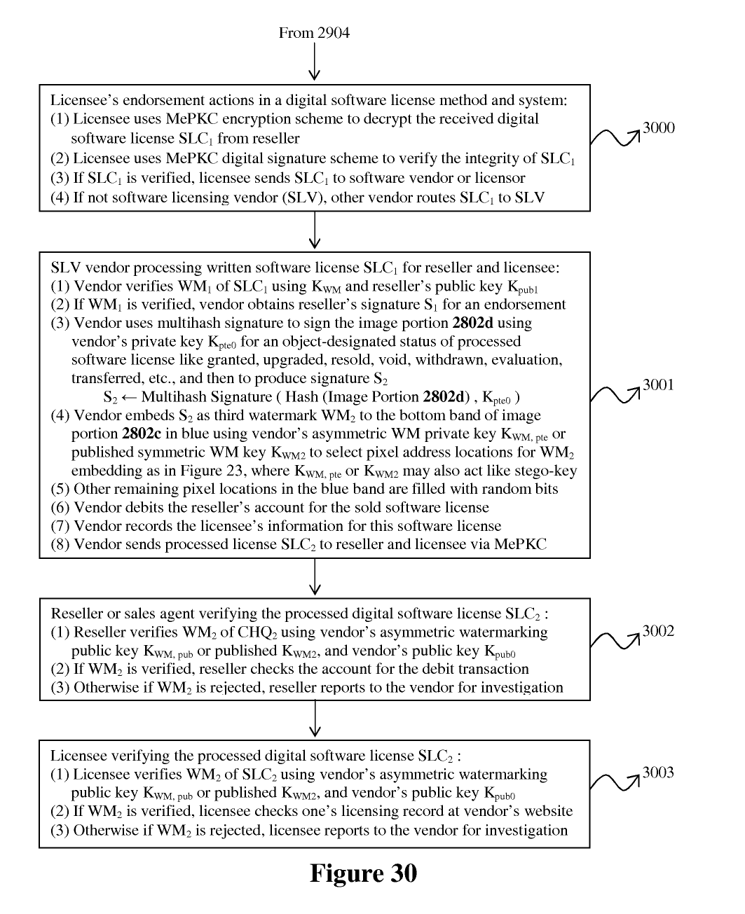

FIG. 30 depicts the endorsement process of a software license by a licensee in the triple-watermark digital software license method and system. After Box 2904, Box 3000 shows licensee's endorsement actions in a digital software license method and system. Firstly, licensee uses MePKC encryption scheme to decrypt the received digital software license SLC₁ from reseller. Licensee uses MePKC digital signature scheme to verify the integrity of SLC₁. If SLC₁ is verified, licensee sends SLC₁ to software vendor or licensor. If it is not software licensing vendor (SLV), other vendor routes SLC₁ to SLV. Box 3001 shows SLV vendor processing written software license SLC₁ for reseller and licensee. Firstly, Vendor verifies WM₁ of SLC₁ using K_{WM} and reseller's public key K_{pub1}. If WM₁ is verified, vendor obtains reseller's signature S₁ for an endorsement. Vendor uses multihash signature to sign the image portion 2802d using vendor's private key Kₚₜₑ₀ for an object-designated status of processed software license like granted, upgraded, resold, void, withdrawn, evaluation, transferred, etc., and then to produce signature S₂, where S₂←Multihash Signature (Hash (Image Portion 2802d), Kₚₜₑ₀). Vendor embeds S₂ as third watermark WM₂ to the bottom band of image portion 2802c in blue using vendor's asymmetric watermarking private key K_{WM, pte} or published symmetric watermarking key K_{WM2} to select pixel address locations for WM₂ embedding as in FIG. 23, where K_{WM, pte} or K_{WM2} may also act like stego-key. Other remaining pixel locations in the blue band are filled with random bits. Vendor debits the reseller's account for the sold software license. Vendor records the licensee's information for this software license. Vendor sends processed license SLC₂ to reseller and licensee via MePKC. Box 3002 shows reseller or sales agent verifying the processed digital software license SLC₂. Reseller verifies WM₂ of CHQ₂ using vendor's asymmetric watermarking public key K_{WM, pub} or published K_{WM2}, and vendor's public key K_{pub0}. If WM₂ is verified, reseller checks the account for the debit transaction. Otherwise if WM₂ is rejected, reseller reports to the vendor for investigation. Box 3003 shows licensee verifying the processed digital software license SLC₂. Licensee verifies WM₂ of SLC₂ using vendor's asymmetric watermarking public key K_{WM, pub} or published K_{WM2}, and vendor's public key K_{pub0}. If WM₂ is verified, licensee checks one's licensing record at vendor's website. Otherwise if WM₂ is rejected, licensee reports to the vendor for investigation.

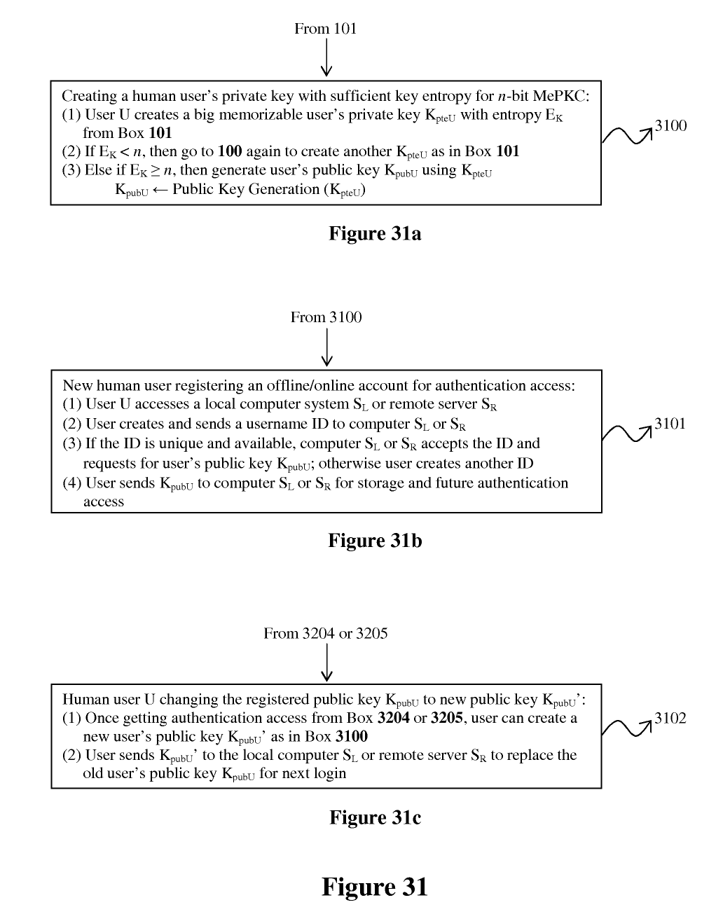

FIG. 31 depicts the various not-so-frequent operations of the basic model of MePKC authentication schemes with feature of non-plaintext equivalence. FIG. 31A shows operations to create a sufficiently big and yet memorizable user's private key. FIG. 31B shows account registration of a new user. FIG. 31C shows how to replace a user's public key by a user. At Box 3100, user U creates a big memorizable user's private key K_{pteU} with entropy E_{K} from Box 101. If E_{K}<n, then go to 100 again to create another K_{pteU} as in Box 101. Else if E_{K}≧n, then generate user's public key K_{pubU} using K_{pteU}. After Box 3100 and at Box 3101 for new human user registering an offline/online account for authentication access, user U accesses a local computer system S_{L} or remote server S_{R}. User creates and sends a username ID to computer S_{L} or S_{R}. If the ID is unique and available, computer S_{L} or S_{R} accepts the ID and requests for user's public key K_{pubU}; otherwise user creates another ID. User sends K_{pubU} to computer S_{L} or S_{R} for storage and future authentication access. From Box 3204 or 3205 reaching at Box 3102, human user U changes the registered public key K_{pubU} to a new public key K_{pubU}′. Once getting authentication access from Box 3204 or 3205, user can create a new user's public key K_{pubU}′ as in Box 3100. User sends K_{pubU}′ to the local computer S_{L} or remote server S_{R} to replace the old user's public key K_{pubU} for next login.

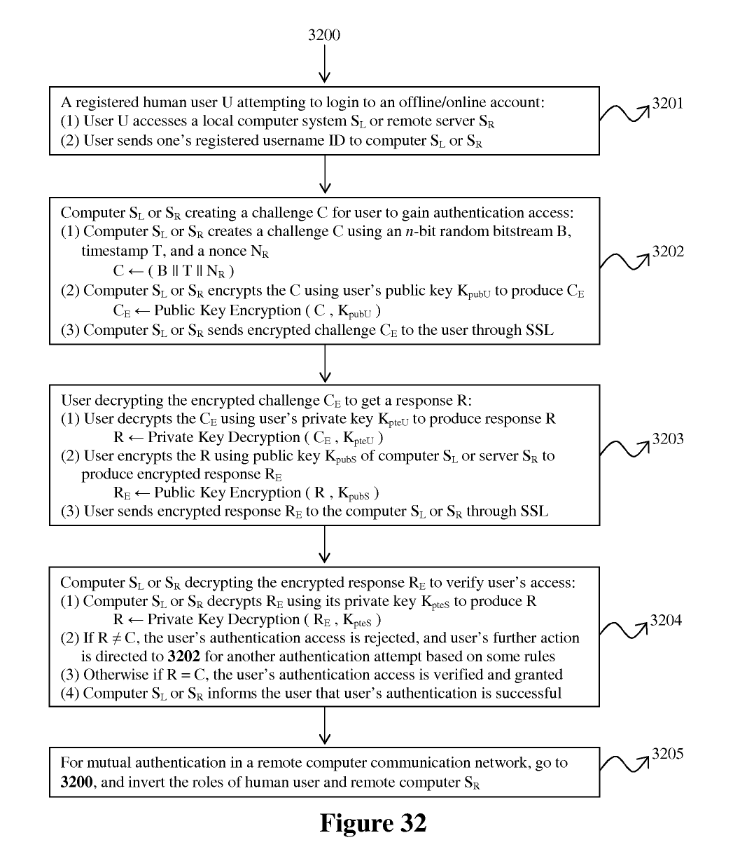

FIG. 32 depicts the basic model of MePKC authentication scheme between a human user and a computer with features of non-plaintext equivalence and optional mutual authentication. Starting from Entry 3200, Box 3201 shows a registered human user U attempting to login to an offline/online account. User U accesses a local computer system S_{L} or remote server S_{R}. User sends one's registered username ID to computer S_{L} or S_{R}. Box 3202 shows computer S_{L} or S_{R} creating a challenge C for user to gain authentication access. Firstly, Computer S_{L} or S_{R} creates a challenge C using an n-bit random bitstream B, timestamp T, and a nonce N_{R}, where C←(B∥T∥N_{R}). Computer S_{L} or S_{R} encrypts the C using user's public key K_{pubU} to produce C_{E}, and sends encrypted challenge C_{E} to the user through SSL. Box 3203 shows user decrypting the encrypted challenge C_{E} to get a response R. Firstly, user decrypts the C_{E} using user's private key K_{pteU} to produce response R. User encrypts the R using public key K_{pubS} of computer S_{L} or server S_{R} to produce encrypted response R_{E}. User sends encrypted response R_{E} to the computer S_{L} or S_{R} through SSL. Box 3204 shows computer S_{L} or S_{R} decrypting the encrypted response R_{E} to verify user's access. Computer S_{L} or S_{R} decrypts R_{E} using its private key K_{pteS} to produce R. If R≠C, the user's authentication access is rejected, and user's further action is directed to 3202 for another authentication attempt based on some rules. Otherwise if R=C, the user's authentication access is verified and granted. Computer S_{L} or S_{R} informs the user that user's authentication is successful. At Box 3205 for mutual authentication in a remote computer communication network, go to 3200, and invert the roles of human user and remote computer S_{R}.

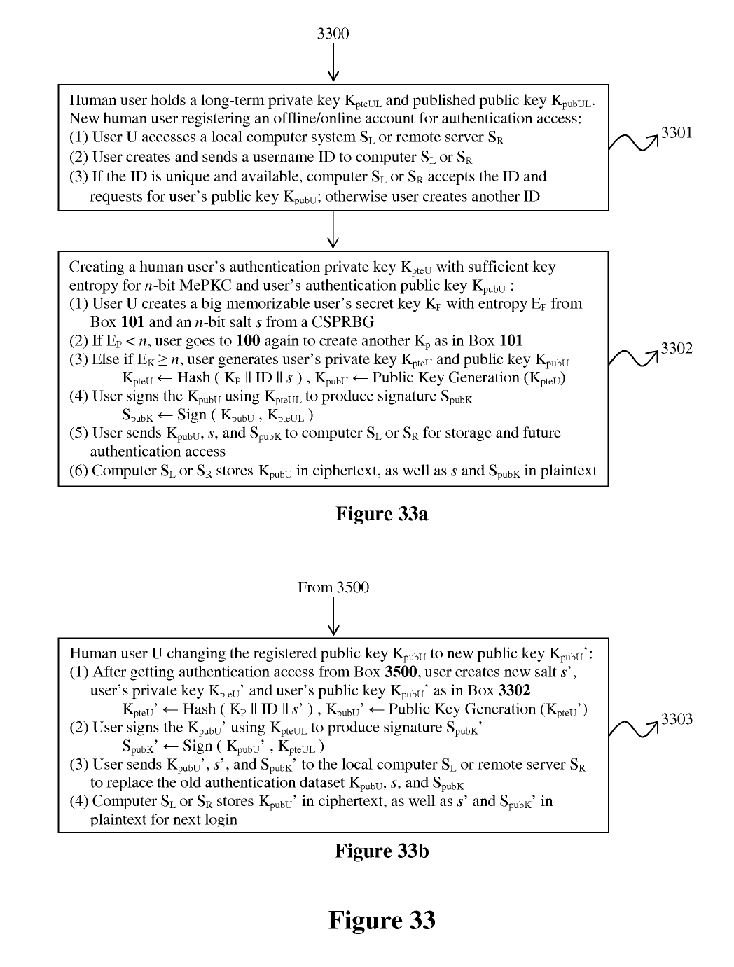

FIG. 33 depicts the various not-so-frequent operations of the second model of MePKC authentication schemes with features of non-plaintext equivalence and perfect forward secrecy. FIG. 33A shows account registration of a new user by creating a sufficiently big and yet memorizable user's private key. FIG. 33B shows operations to replace a user's authentication dataset like user's public key and salt by a user. Starting from Entry 3300, at Box 3301, human user holds a long-term private key K_{pteUL} and published public key K_{pubUL}. Here, new human user registers an offline/online account for authentication access. Firstly, user U accesses a local computer system S_{L} or remote server S_{R}. User creates and sends a username ID to computer S_{L} or S_{R}. If the ID is unique and available, computer S_{L} or S_{R} accepts the ID and requests for user's public key K_{pubU}; otherwise user creates another ID. Box 3302 shows operations to create a human user's authentication private key K_{pteU} with sufficient key entropy for n-bit MePKC and user's authentication public key K_{pubU}. Firstly, user U creates a big memorizable user's secret key K_{P} with entropy E_{P} from Box 101 and an n-bit salt s from a CSPRBG. If E_{P}<n, user goes to 100 again to create another K_{P} as in Box 101; else if E_{K}≧n, user generates user's private key K_{pteU} and public key K_{pubU}, where K_{pteU}←Hash (K_{P}∥ID∥s). User signs the K_{pubU} using K_{pteUL} to produce signature S_{pubK}. User sends K_{pubU}, s, and S_{pubK} to computer S_{L} or S_{R} for storage and future authentication access. Computer S_{L} or S_{R} stores K_{pubU} in ciphertext, as well as s and S_{pubK} in plaintext. After Box 3500 at Box 3303, human user U changes the registered public key K_{pubU} to new public key K_{pubU}′. After getting authentication access from Box 3500, user creates new salt s′, user's private key K_{pteU}′ and user's public key K_{pubU}′ as in Box 3302, where K_{pteU}′←Hash (K_{P}∥ID∥s′). User signs the K_{pubU}′ using K_{pteUL} to produce signature S_{pubK}′. User sends K_{pubU}′, s′, and S_{pubK}′ to the local computer S_{L} or remote server S_{R} to replace the old authentication dataset K_{pubU}, s, and S_{pubK}. Computer S_{L} or S_{R} stores K_{pubU}′ in ciphertext, as well as s′ and S_{pubK}′ in plaintext for next login.

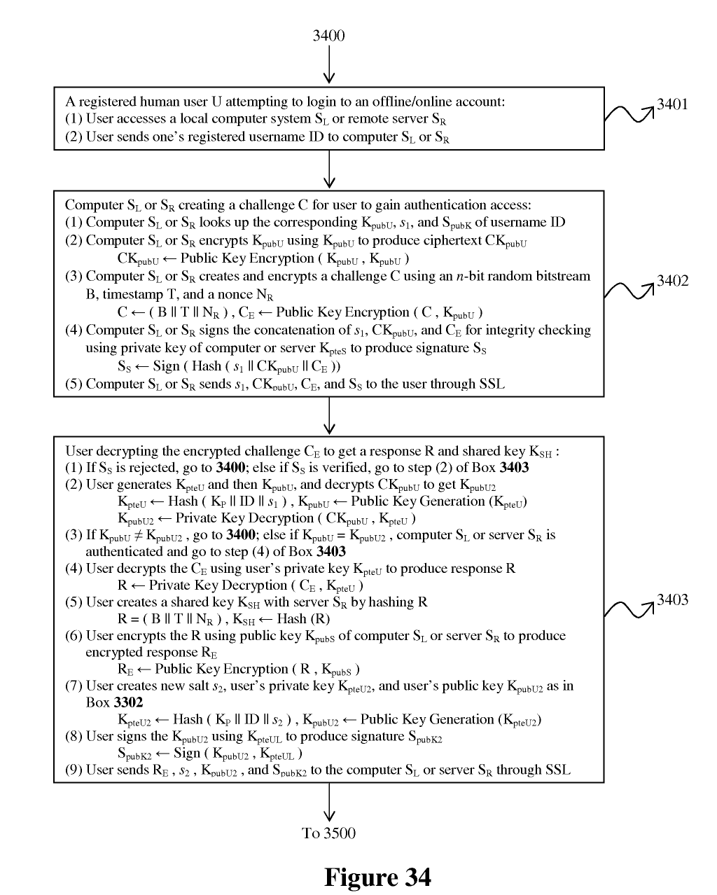

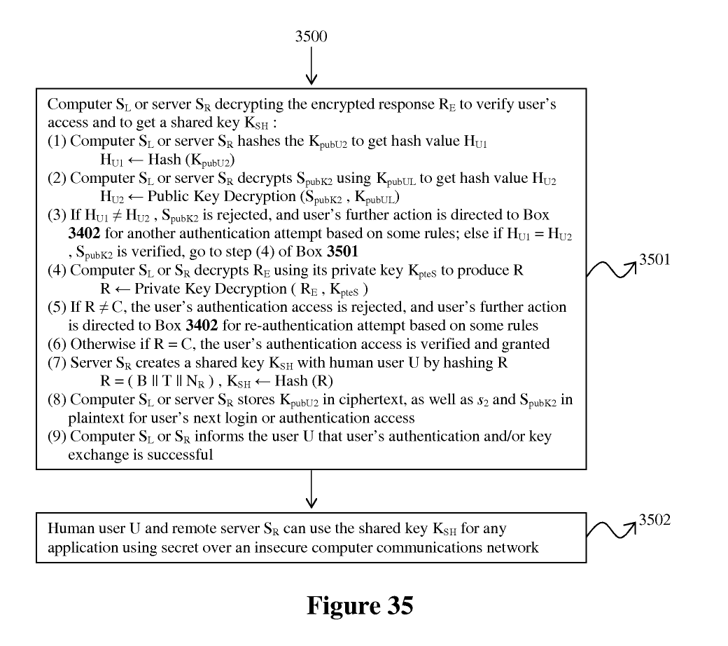

FIGS. 34-35 depict the second model of MePKC authentication scheme between a human user and a computer with features of non-plaintext equivalence, perfect forward secrecy, and optional key exchange scheme. Starting from Entry 3400, Box 3401 shows a registered human user U attempting to login to an offline/online account. User accesses a local computer system S_{L} or remote server S_{R}. User sends one's registered username ID to computer S_{L} or S_{R}. Box 3402 shows computer S_{L} or S_{R} creating a challenge C for user to gain authentication access. Firstly, computer S_{L} or S_{R} looks up the corresponding K_{pubU}, s₁, and S_{pubK} of username ID. Then, computer S_{L} or S_{R} encrypts K_{pubU} using K_{pubU} to produce ciphertext CK_{pubU}. Computer S_{L} or S_{R} creates and encrypts a challenge C using an n-bit random bitstream B, timestamp T, and a nonce N_{R}, where C←(B∥T∥N_{R}). Later, computer S_{L} or S_{R} signs the concatenation of s₁, CK_{pubU}, and C_{E} for integrity checking using private key of computer or server K_{pteS} to produce signature S_{S}, where S_{S}←Sign (Hash (s₁∥CK_{pubU}∥C_{E})) Finally, computer S_{L} or S_{R} sends s₁, CK_{pubU}, C_{E}, and S_{S} to the user through SSL. Box 3403 shows user decrypting the encrypted challenge C_{E} to get a response R and shared key K_{SH}. If S_{S} is rejected, go to 3400; else if S_{S} is verified, go to step (2) of Box 3403. User generates K_{pteU} and then K_{pubU}, and decrypts CK_{pubU} to get K_{pubU2}, where K_{pteU}←Hash (K_{P}∥ID∥s₁). If K_{pubU}≠K_{pubU2}, go to 3400; else if K_{pubU}=K_{pubU2}, computer S_{L} or server S_{R} is authenticated and go to step (4) of Box 3403. User decrypts the C_{E} using user's private key K_{pteU} to produce response R. User creates a shared key K_{SH} with server S_{R} by hashing R, where R=(B∥T∥N_{R}), K_{SH}←Hash (R). User encrypts the R using public key K_{pubs} of computer S_{L} or server S_{R} to produce encrypted response R_{E}. User creates new salt s₂, user's private key K_{pteU2}, and user's public key K_{pubU2} as in Box 3302, where K_{pteU2}←Hash (K_{P∥ID∥s}₂). User signs the K_{pubU2} using K_{pteUL} to produce signature S_{pubK2}. Finally, user sends R_{E}, s₂, K_{pubU2}, and S_{pubK2} to the computer S_{L} or server S_{R} through SSL. After Box 3403, go to Box 3500. From Box 3500, Box 3501 shows computer S_{L} or server S_{R} decrypting the encrypted response R_{E} to verify user's access and to get a shared key K_{SH}. Computer S_{L} or server S_{R} hashes the K_{pubU2} to get hash value H_{U1}, where H_{U1}←Hash (K_{pubU2}). Computer S_{L} or server S_{R} decrypts the S_{pubK2} using K_{pubUL} to get hash value H_{U2}, where H_{U2}←Public Key Decryption (S_{pubK2}, K_{pubUL}). If H_{U1}≠H_{U2}, S_{pubK2} is rejected, and user's further action is directed to Box 3402 for another authentication attempt based on some rules; else if H_{U1}=H_{U2}, S_{pubK2} is verified, go to step (4) of Box 3501. Computer S_{L} or S_{R} decrypts R_{E} using its private key K_{pteS} to produce R. If R≠C, the user's authentication access is rejected, and user's further action is directed to Box 3402 for re-authentication attempt based on some rules. Otherwise if R=C, the user's authentication access is verified and granted. Server S_{R} creates a shared key K_{SH} with human user U by hashing R, where R=(B∥T∥N_{R}), K_{SH}←Hash (R). Computer S_{L} or server S_{R} stores K_{pubU2} in ciphertext, as well as s₂ and S_{pubK2} in plaintext for user's next login or authentication access. Computer S_{L} or S_{R} informs the user U that user's authentication and/or key exchange is successful. At Box 3502, human user U and remote server S_{R} can use the shared key K_{SH} for any application using secret over an insecure computer communications network.

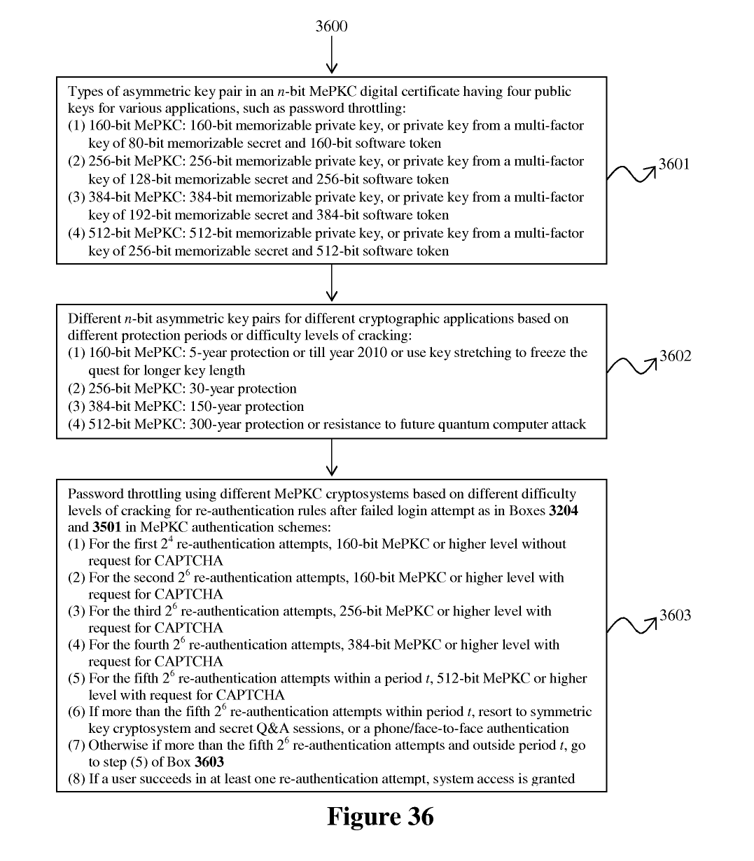

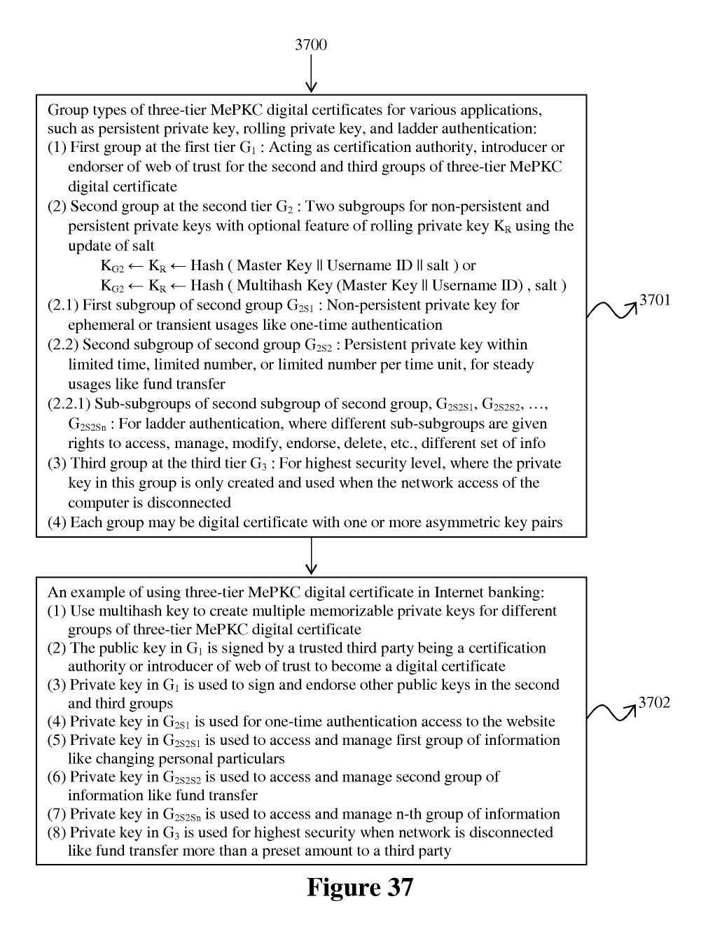

FIG. 36 depicts the MePKC digital certificate with four public keys for various applications, such as password throttling. Starting from Entry 3600, Box 3601 shows types of asymmetric key pair in an n-bit MePKC digital certificate having four public keys for various applications, such as password throttling. For 160-bit MePKC, it may use 160-bit memorizable private key, or private key from a multi-factor key of 80-bit memorizable secret and 160-bit software token. For 256-bit MePKC, it may use 256-bit memorizable private key, or private key from a multi-factor key of 128-bit memorizable secret and 256-bit software token. For 384-bit MePKC, 384-bit memorizable private key, or private key from a multi-factor key of 192-bit memorizable secret and 384-bit software token. For 512-bit MePKC, 512-bit memorizable private key, or private key from a multi-factor key of 256-bit memorizable secret and 512-bit software token. Box 3602 shows different n-bit asymmetric key pairs for different cryptographic applications based on different protection periods or difficulty levels of cracking. For 160-bit MePKC, it has 5-year protection or till year 2010, or use key stretching to freeze the quest for longer key length. For 256-bit MePKC, it has 30-year protection. For 384-bit MePKC, it has 150-year protection. For 512-bit MePKC, it has 300-year protection or resistance to future quantum computer attack. Box 3603 shows password throttling using different MePKC cryptosystems based on different difficulty levels of cracking for re-authentication rules after failed login attempt as in Boxes 3204 and 3501 in MePKC authentication schemes. For the first 2⁴ re-authentication attempts, use 160-bit MePKC or higher level without request for CAPTCHA. For the second 2⁶ re-authentication attempts, use 160-bit MePKC or higher level with request for CAPTCHA. For the third 2⁶ re-authentication attempts, use 256-bit MePKC or higher level with request for CAPTCHA. For the fourth 2⁶ re-authentication attempts, use 384-bit MePKC or higher level with request for CAPTCHA. For the fifth 2⁶ re-authentication attempts within a period t, use 512-bit MePKC or higher level with request for CAPTCHA. If more than the fifth 2⁶ re-authentication attempts within period t, resort to symmetric key cryptosystem and secret Q&A sessions, or a phone/face-to-face authentication. Otherwise if more than the fifth 2⁶ re-authentication attempts and outside period t, go to step (5) of Box 3603. If a user succeeds in at least one re-authentication attempt, system access is granted. FIG. 37 depicts the three-tier MePKC digital certificates for various applications, such as persistent private key, rolling private key, and ladder authentication. Starting from Entry 3700, Box 3701 shows the group types of three-tier MePKC digital certificates for various applications, such as persistent private key, rolling private key, and ladder authentication. First group at the first tier G₁ acts as certification authority, introducer or endorser of web of trust for the second and third groups of three-tier MePKC digital certificate. Second group at the second tier G₂ consists of two subgroups for non-persistent and persistent private keys with optional feature of rolling private key K_{R} using the update of salt, where K_{G2}←K_{R}←Hash (Master Key∥Username ID∥salt) or K_{G2}←K_{R}←Hash (Multihash Key (Master Key∥Username ID), salt). First subgroup of second group G_{2S1} consists of non-persistent private key for ephemeral or transient usages like one-time authentication. Second subgroup of second group G_{2S2} consists of persistent private key within limited time, limited number, or limited number per time unit, for steady usages like fund transfer. Sub-subgroups of second subgroup of second group, G_{2S2S1}, G_{2S2S2}, . . . , G_{2S2Sn}, are for ladder authentication, where different sub-subgroups are given rights to access, manage, modify, endorse, delete, etc., different set of information. Third group at the third tier G₃ is for highest security level, where the private key in this group is only created and used when the network access of the computer is disconnected. Each group may be digital certificate with one or more asymmetric key pairs. Box 3702 shows an example of using three-tier MePKC digital certificate in Internet banking. Firstly, use multihash key to create multiple memorizable private keys for different groups of three-tier MePKC digital certificate. The public key in G₁ is signed by a trusted third party being a certification authority or introducer of web of trust to become a digital certificate. Private key in G₁ is used to sign and endorse other public keys in the second and third groups. Private key in G_{2S1} is used for one-time authentication access to the website. Private key in G_{2S2S1} is used to access and manage first group of information like changing personal particulars. Private key in G_{2S2S2} is used to access and manage second group of information like fund transfer. Private key in G_{2S2Sn} is used to access and manage n-th group of information. Private key in G₃ is used for highest security when network is disconnected like fund transfer more than a preset amount to a third party.

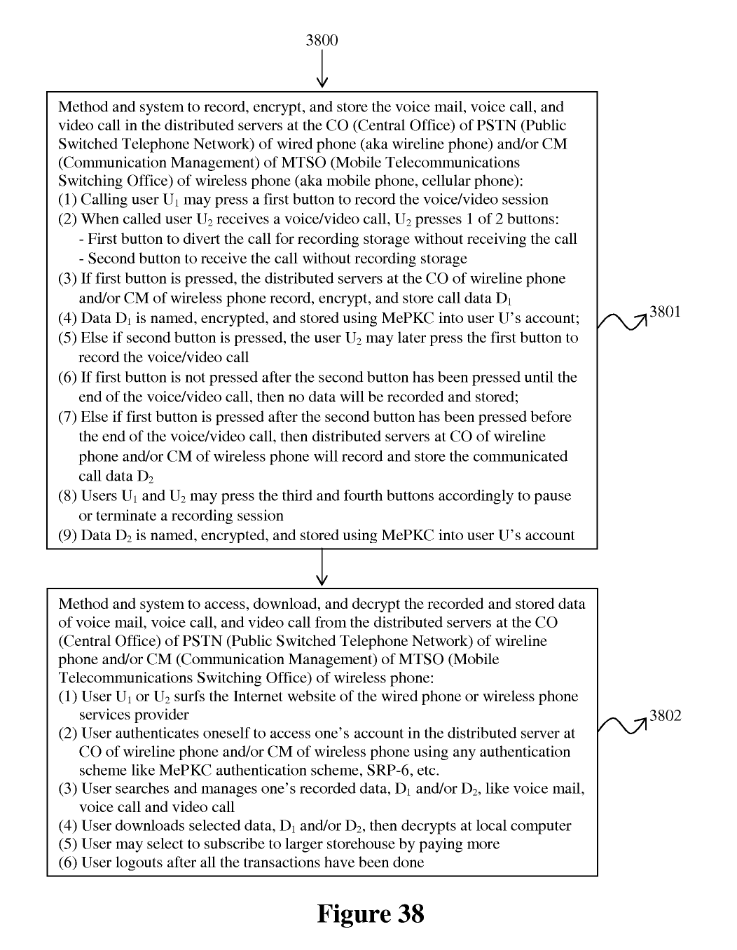

FIG. 38 depicts the operations to record, encrypt, store, access, manage, download, and decrypt the voice mail, voice call, and video call in the distributed servers at the CO (Central Office) of PSTN (Public Switched Telephone Network) of wireline phone and/or CM (Communication Management) of MTSO (Mobile Telecommunications Switching Office) of wireless phone. Starting from Entry 3800, Box 3801 shows method and system to record, encrypt, and store the voice mail, voice call, and video call in the distributed servers at the CO (Central Office) of PSTN (Public Switched Telephone Network) of wired phone (aka wireline phone) and/or CM (Communication Management) of MTSO (Mobile Telecommunications Switching Office) of wireless phone (aka mobile phone, cellular phone). Firstly, calling user U₁ may press a first button to record the voice/video session. When called user U₂ receives a voice/video call, U₂ presses 1 of 2 buttons, where first button is to divert the call for recording storage without receiving the call, and second button is to receive the call without recording storage. If first button is pressed, the distributed servers at the CO of wireline phone and/or CM of wireless phone record, encrypt, and store call data D₁. Data D₁ is named, encrypted, and stored using MePKC into user U's account. Otherwise if second button is pressed, the user U₂ may later press the first button to record the voice/video call. If first button is not pressed after the second button has been pressed until the end of the voice/video call, then no data will be recorded and stored; else if first button is pressed after the second button has been pressed before the end of the voice/video call, then distributed servers at CO of wireline phone and/or CM of wireless phone will record and store the communicated call data D₂. Users U₁ and U₂ may press the third and fourth buttons accordingly to pause or terminate a recording session. Data D₂ is named, encrypted, and stored using MePKC into user U's account. Box 3802 shows method and system to access, download, and decrypt the recorded and stored data of voice mail, voice call, and video call from the distributed servers at the CO (Central Office) of PSTN (Public Switched Telephone Network) of wireline phone and/or CM (Communication Management) of MTSO (Mobile Telecommunications Switching Office) of wireless phone. Firstly, user U₁ or U₂ surfs the Internet website of the wired phone or wireless phone services provider. User authenticates oneself to access one's account in the distributed server at CO of wireline phone and/or CM of wireless phone using any authentication scheme like MePKC authentication scheme, SRP-6, etc. User searches and manages one's recorded data, D₁ and/or D₂, like voice mail, voice call and video call. User downloads selected data, D₁ and/or D₂, then decrypts at local computer. Ladder authentication may be optionally required to download a recorded data. User may select to subscribe to larger storehouse by paying more. User logouts after all the transactions have been done.

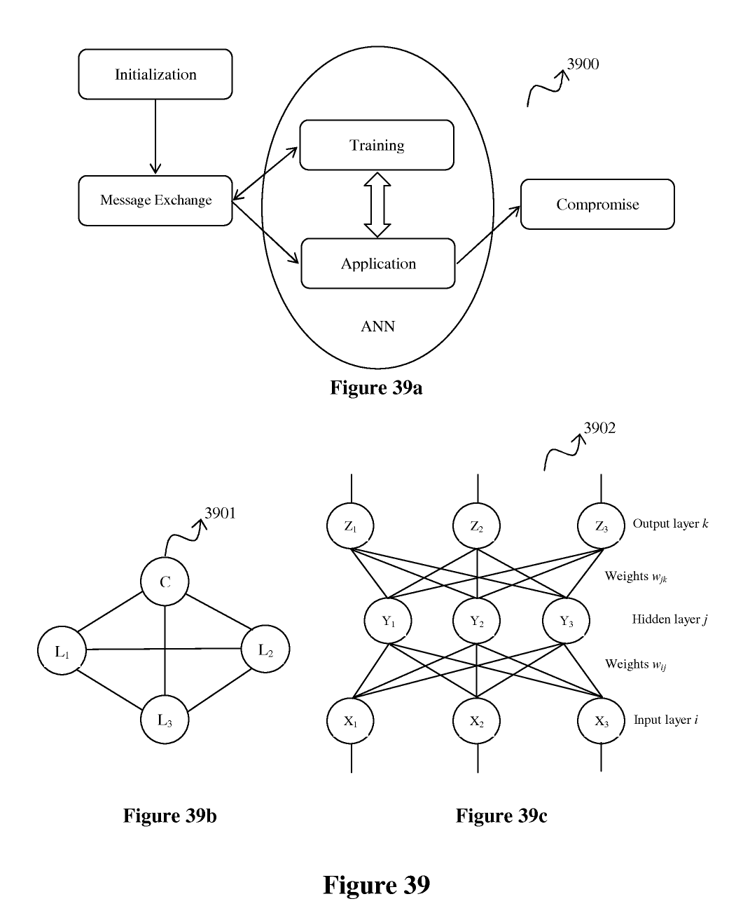

FIG. 39 depicts the ANN based BAP and its smallest model of 4-node distributed network. FIG. 39A (or 3900) shows a block diagram of ANN based BAP. FIG. 39B (or 3901) shows an FCN model of 4-node distributed network. FIG. 39C (or 3902) shows an ANN model of 4-node distributed network. For 3900, the ANN based BAP is also called BAP-ANN (BAP with ANN). It has five stages: Initialization, message exchange, ANN training, ANN application, and compromise. For more details about ANN based BAP and its faulty node detection, please refer to a master's thesis entitled “Artificial Neural Network Based Byzantine Agreement Protocol” by Kok-Wah Lee, October 2002, Multimedia University, Bukit Beruang, Melaka, Malaysia. For 3901, it shows a 4-node FCN (Fully Connected Network), which is the smallest network for BAP to function to tolerate a maximum of one faulty node. There are one commander node and at least three lieutenant nodes. For 3902, it shows the neural architecture of FCN-4, where there are two layers of hidden nodes. The number of input neurons equals to the number of lieutenant nodes and the number of output neurons is fixed at three for three types of consensus, i.e. agree, reject, and DEFAULT value to agree or reject for unexpected cases. For the number of hidden neurons, it is any value best suited for the best performance time of BAP-ANN.

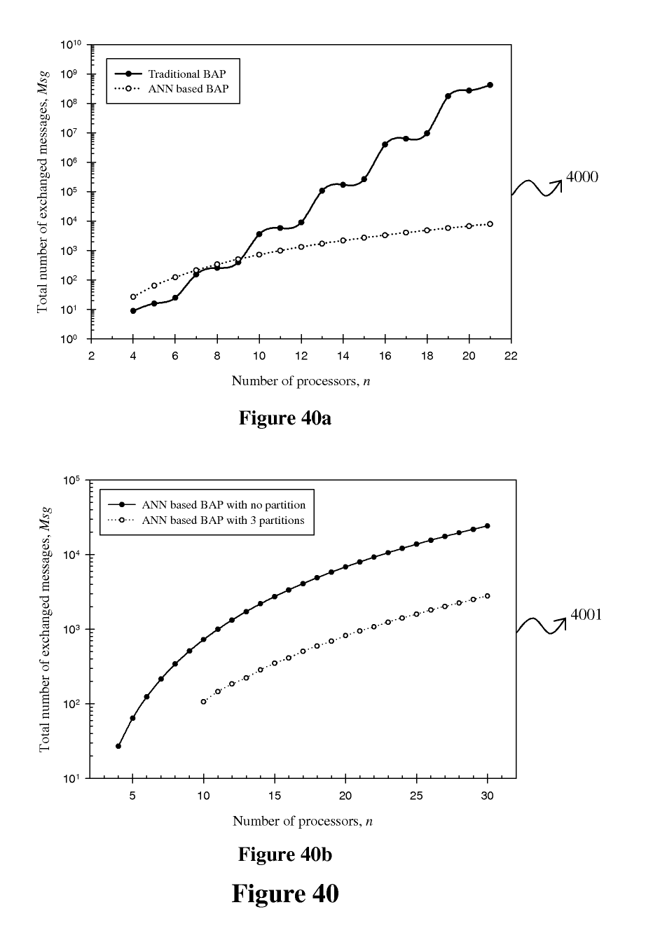

FIG. 40 depicts the total number of exchanged messages for different types of BAP. FIG. 40A (or 4000) compares traditional BAP by Leslie Lamport in 1982 with basic ANN based BAP by using number of exchanged messages. FIG. 40B (or 4001) compares basic ANN based BAP with tripartite ANN based BAP by using number of exchanged messages as well. The number of exchanged message determines the speed of BAP-ANN because it involves the slow operations of MePKC encryption and signature schemes. The applications of MePKC using memorizable secret are expected to increase the popularity of e-commerce using BAP-ANN. From 4000, basic ANN based BAP outperforms the traditional BAP when the network size is larger than nine. From 4001, tripartite BAP-ANN clearly outperforms the basic BAP-ANN. However, tripartite BAP-ANN only works when the network size is at least ten.

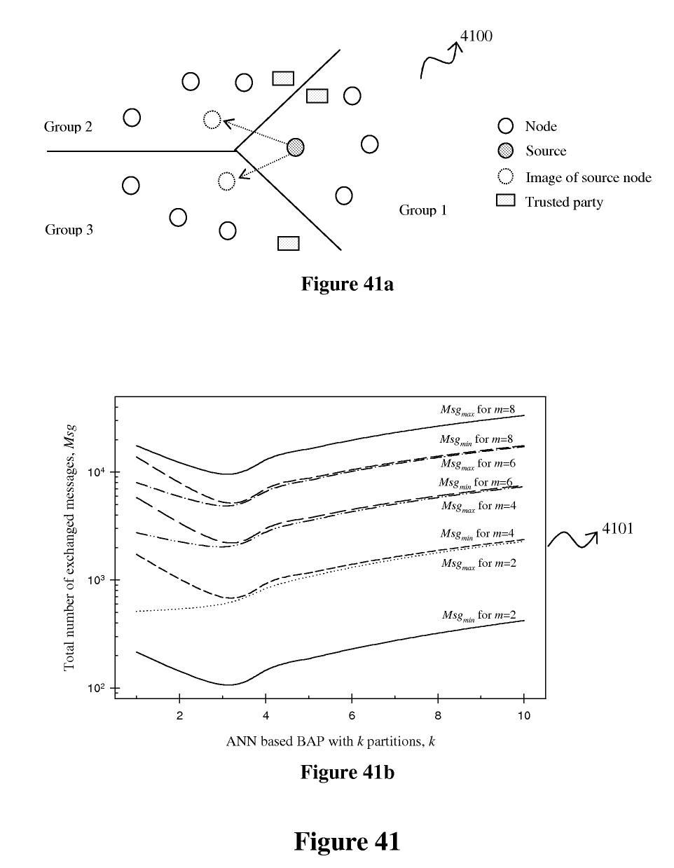

FIG. 41 depicts the partitioning of a distributed network and its optimal partitioning selection. FIG. 41A (or 4100) shows the partitioning of a 10-node distributed network into three groups. FIG. 41B (or 4101) shows the optimal selection of network partitioning for tripartite ANN based BAP. From 4100, it shows how a 10-node network is partitioned into three groups. The source node in group 1 appears in the other two groups as well. Each group optionally requires a trusted party. If trusted parties have to be excluded or not enough trust, then the number of exchanged messages can be increased to tolerate for more trust and independence. Here, after completing the compromise stage for its group, each node in a group just needs to send its individual group BA (Byzantine Agreement) to all the nodes in the other two groups. Afterwards, every node carries out a majority function to know the group BA that shall be sent by the trust party in that group. From 4101, for a fixed number of tolerated faulty nodes, the tripartite partition is the optimal choice among all the k-partite BAP-ANN because it has the least number of exchanged messages, which means indirectly fastest operating time.

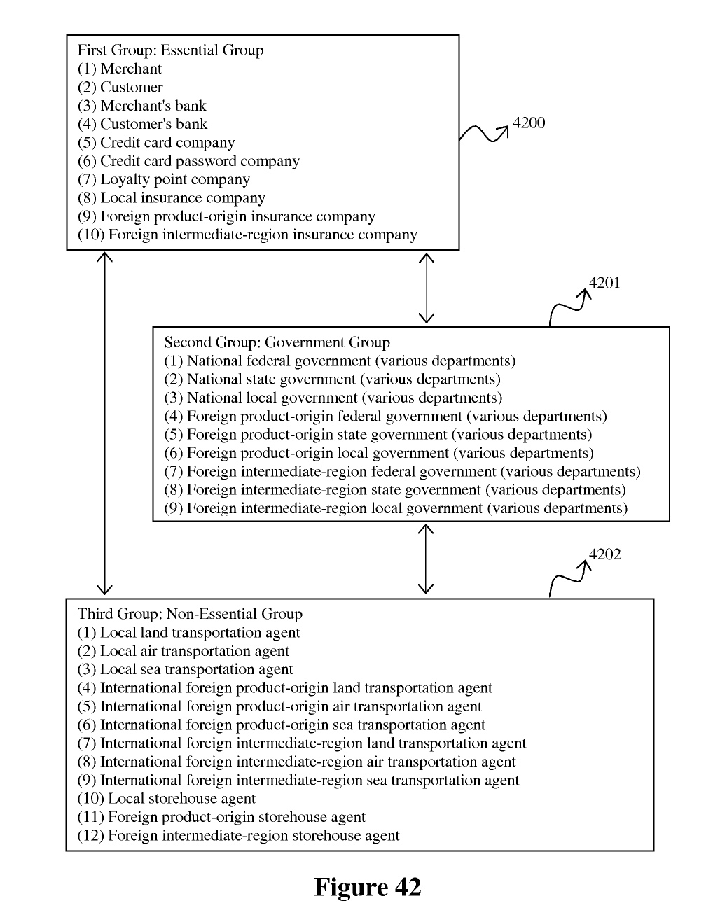

FIG. 42 depicts the partitioning of the entities involved in the electronic commerce transactions into three groups: Essential group, government group, and non-essential group. These three groups are the three partitions of tripartite BAP-ANN applied for multipartite e-commerce. Box 4200 shows the first essential group consisting of merchant, customer, merchant's bank, customer's bank, credit card company (like VISA and MasterCard), credit card password company (like PayPal, Verified by VISA, and MasterCard SecureCode), loyalty point company, local insurance company, foreign product-origin insurance company, and foreign intermediate-region insurance company. Here, only the merchant and customer in the essential group are critical and irreplaceable. Box 4201 shows the second government group consisting of national federal government (various departments), national state government (various departments), national local government (various departments), foreign product-origin federal government (various departments), foreign product-origin state government (various departments), foreign product-origin local government (various departments), foreign intermediate-region federal government (various departments), foreign intermediate-region state government (various departments), and foreign intermediate-region local government (various departments). Here, all the entities in the government group are critical and irreplaceable. Box 4202 shows the third non-essential group consisting of local land transportation agent, local air transportation agent, local sea transportation agent, international foreign product-origin land transportation agent, international foreign product-origin air transportation agent, international foreign product-origin sea transportation agent, international foreign intermediate-region land transportation agent, international foreign intermediate-region air transportation agent, international foreign intermediate-region sea transportation agent, local storehouse agent, foreign product-origin storehouse agent, and foreign intermediate-region storehouse agent. All the entities in the non-essential group are not critical and replaceable.

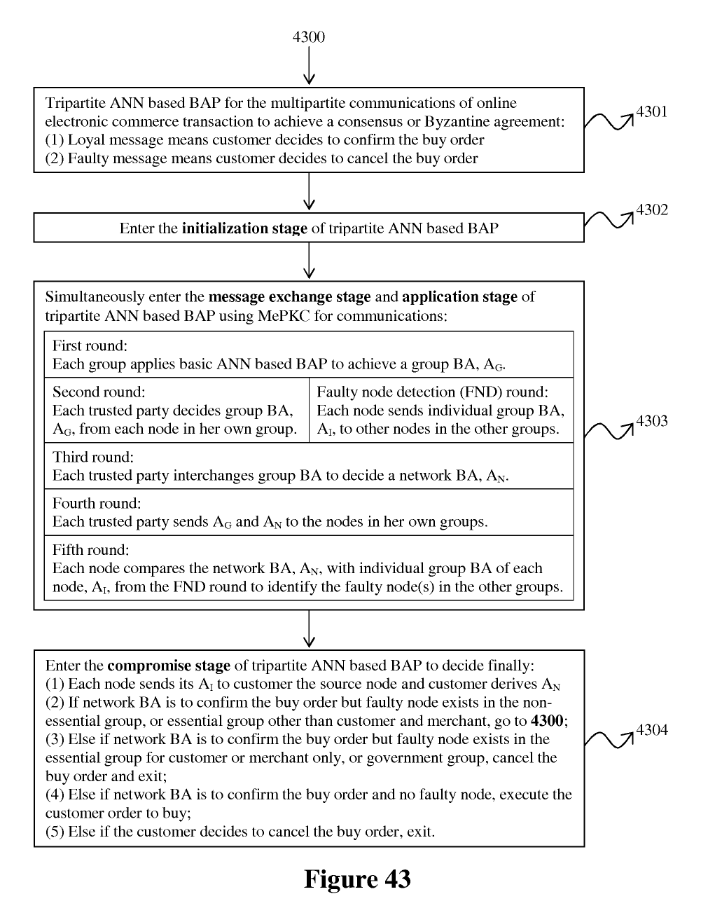

FIG. 43 depicts the tripartite ANN based BAP with trusted party and faulty node detection for multipartite electronic commerce transaction using MePKC cryptographic schemes for communications. Starting from Entry 4300, Box 4301 shows the tripartite ANN based BAP for the multipartite communications of online electronic commerce transaction to achieve a consensus or Byzantine agreement. Loyal message means customer decides to confirm the buy order. Faulty message means customer decides to cancel the buy order. At Box 4302, it enters the initialization stage of tripartite ANN based BAP. At Box 4303, it simultaneously enters the message exchange stage and application stage of tripartite ANN based BAP using MePKC for communications. For the first round, each group applies basic ANN based BAP to achieve a group BA, A_{G}, and detect the faulty node(s) inside the group. For loyal nodes but not faulty nodes, individual group BA, A_{I}, of each node equals to group BA, A_{G}. For the second round, each trusted party decides group BA, A_{G}, from each node in her own group. In parallel with the second round, there is faulty node detection (FND) round. In the FND round, each node sends individual group BA, A_{I}, to other nodes in the other groups. For the third round, each trusted party interchanges group BA to decide a network BA, A_{N}. For the fourth round, each trusted party sends A_{G} and A_{N} to the nodes in her own groups. For the fifth round, each node compares the network BA, A_{N}, with individual group BA of each node, A_{I}, from the FND round to identify the faulty node(s) in the other groups. Here, the FND round can also be used to replace the trusted party, where the group BA of the other nodes in the other two groups is determined from the majority function over the individual group BA sent from each node in the other groups as happened in the FND round. At Box 4304, it enters the compromise stage of tripartite ANN based BAP to decide finally. Each node sends its A_{I} to customer the source node and customer derives the A_{N}. If network BA is to confirm the buy order but faulty node exists in the non-essential group, or essential group other than customer and merchant, go to 4300; else if network BA is to confirm the buy order but faulty node exists in the essential group for customer or merchant only, or government group, cancel the buy order and exit; else if network BA is to confirm the buy order and no faulty node, execute the customer order to buy; else if the customer decides to cancel the buy order, exit. In this way, the multipartite e-commerce transaction can be operated by tripartite BAP-ANN or any other BAP with trusted party. For these BAP, anyone of them needs the MePKC using fully memorizable secret to boost up the popularity of PKC applications.

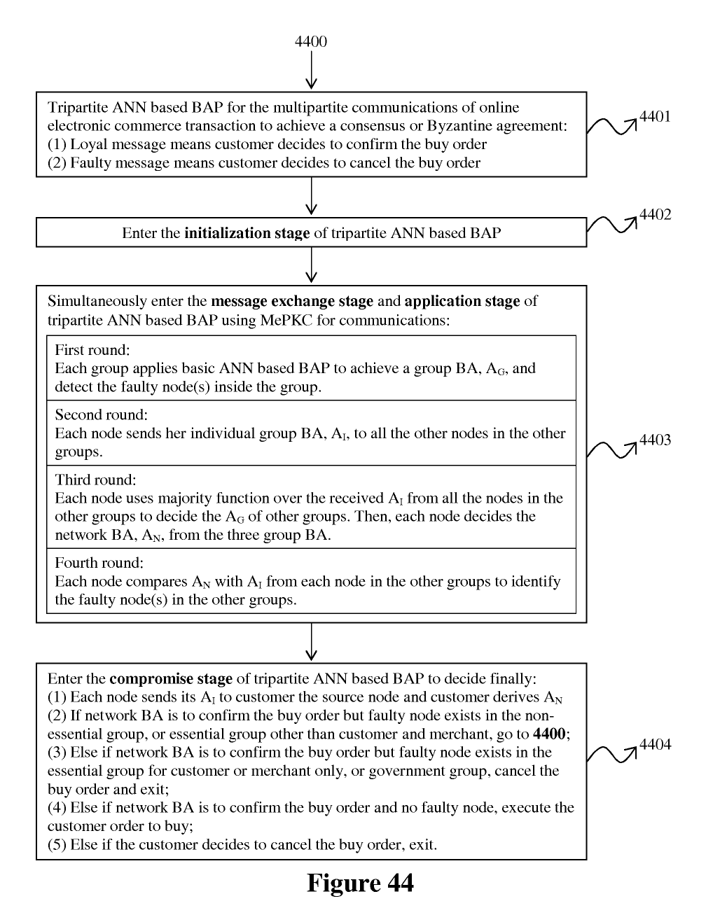

FIG. 44 illustrates the tripartite ANN based BAP without trusted party but still with faulty node detection for multipartite electronic commerce transaction using MePKC cryptographic schemes for communications. Starting from Entry 4400, Box 4401 shows the tripartite ANN based BAP for the multipartite communications of online electronic commerce transaction to achieve a consensus or Byzantine agreement. Loyal message means customer decides to confirm the buy order. Faulty message means customer decides to cancel the buy order. At Box 4402, it enters the initialization stage of tripartite ANN based BAP. At Box 4403, it simultaneously enters the message exchange stage and application stage of tripartite ANN based BAP using MePKC for communications. For the first round, each group applies basic ANN based BAP to achieve a group BA, A_{G}, and detect the faulty node(s) inside the group. For the second round, each node sends her individual group BA, A_{I}, to all the other nodes in the other groups. For the third round, each node uses majority function over the received A_{I} from all the nodes in the other groups to decide the A_{G} of other groups. Then, each node decides the network BA, A_{N}, from the three group BA. For the fourth round, each node compares A_{N} with A_{I} from each node in the other groups to identify the faulty node(s) in the other groups. At Box 4404, it enters the compromise stage of tripartite ANN based BAP to decide finally. Each node sends its A_{I} to customer the source node and customer derives the A_{N}. If network BA is to confirm the buy order but faulty node exists in the non-essential group, or essential group other than customer and merchant, go to 4400; else if network BA is to confirm the buy order but faulty node exists in the essential group for customer or merchant only, or government group, cancel the buy order and exit; else if network BA is to confirm the buy order and no faulty node, execute the customer order to buy; else if the customer decides to cancel the buy order, exit. In this way, the multipartite e-commerce transaction can be operated by tripartite BAP-ANN or any other BAP without trusted party. For these BAP, anyone of them needs the MePKC using fully memorizable secret as well to boost up the popularity of PKC applications.

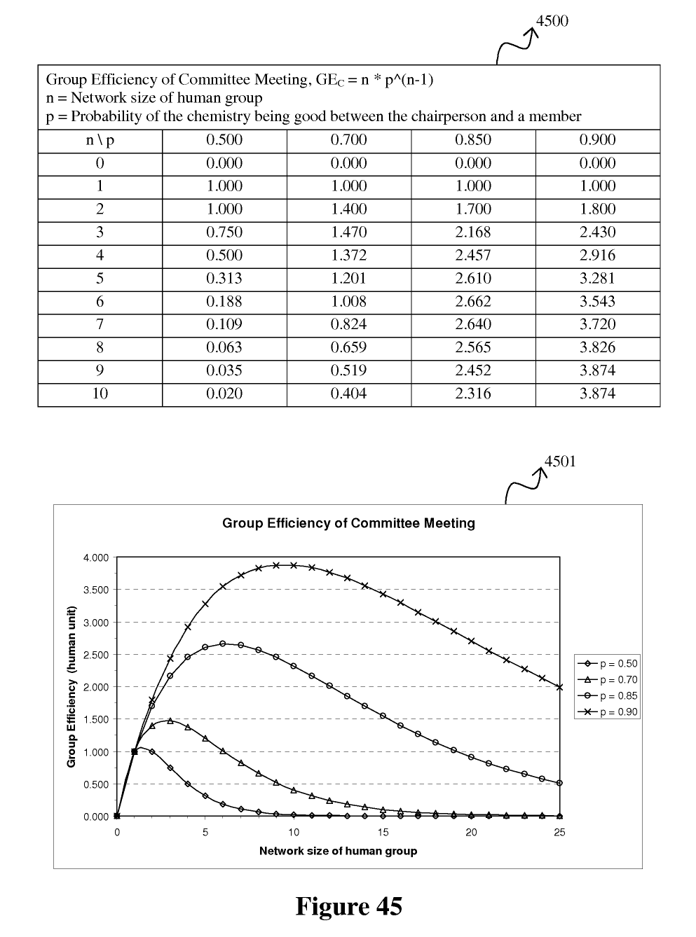

FIG. 45 (consisting of 4500 and 4501) illustrates the group efficiency (GE_{C}) of a committee meeting according to the Kurokawa's human interaction model. GE=n*p̂(n−1), where n=network size of human group and p=probability of the chemistry being good between the chairperson and a member. For an appropriate p=0.85, the n=20 or more is the critical limit to begin the era of coefficients of inefficiency. An organized crime group to fake digital certificate similar to the committee meeting starts to become inefficient when n≧20.

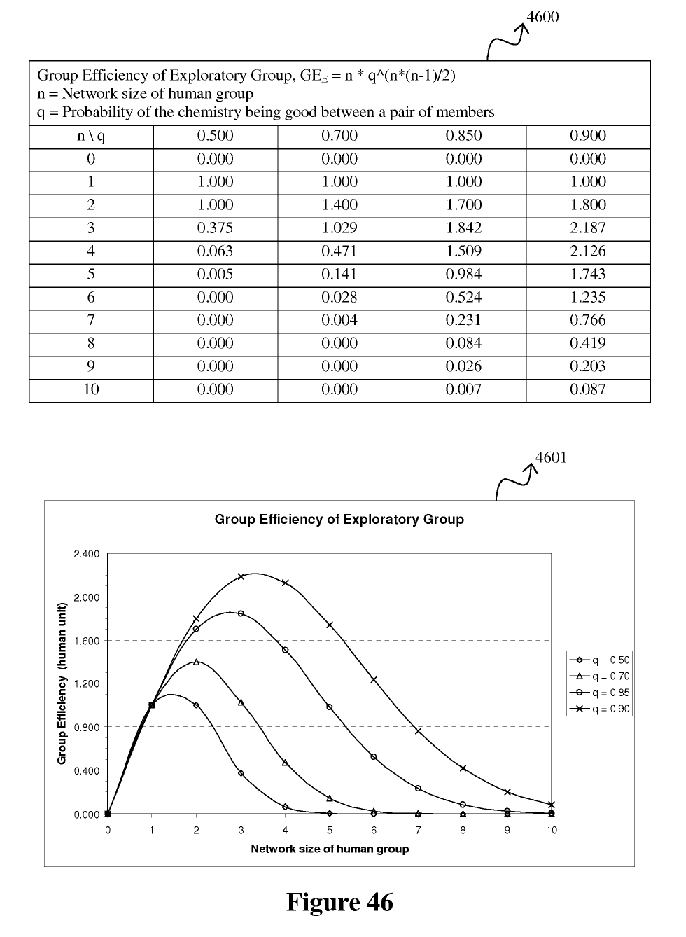

FIG. 46 (consisting of 4600 and 4601) illustrates the group efficiency (GE_{E}) of an exploratory group according to the Kurokawa's human interaction model. GE_{E}=n*q̂(n*(n−1)/2), where n=network size of human group and q=probability of the chemistry being good between a pair of members. For an appropriate p=0.85, the n=5 or more is the critical limit to begin the era of coefficients of inefficiency. An organized crime group to fake digital certificate similar to the exploratory group starts to become inefficient when n≧5.

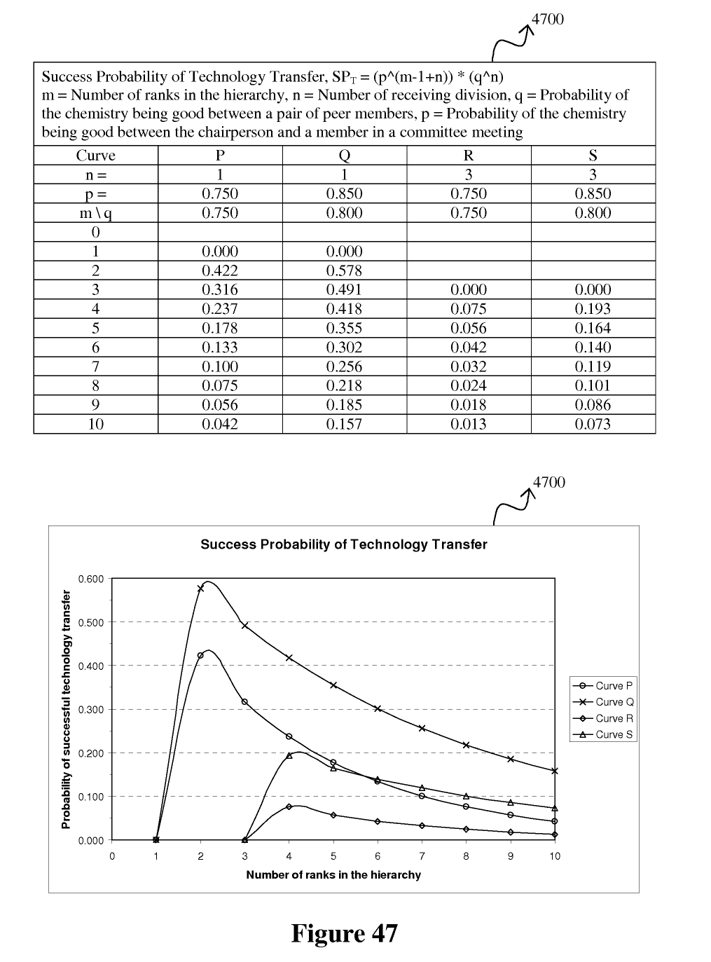

FIG. 47 (consisting of 4700 and 4701) illustrates the success probability (SP_{T}) of technology transfer according to the Kurokawa's human interaction model. SP_{T}=(p̂(m−1+n))*(q̂n), where m=number of ranks in the hierarchy, n=number of receiving division, q=probability of the chemistry being good between a pair of peer members, and p=probability of the chemistry being good between the chairperson and a member in a committee meeting. It can be observed that the success probability is only high when the m and n are small. It means an organized crime group to fake digital signature is only efficient when the group is small. To make the organized crime group to fake digital certificate to be inefficient, the PKI (Public Key Infrastructure) of MePKC digital certificate has to somehow increase the number of digital signature certifying a user identity.

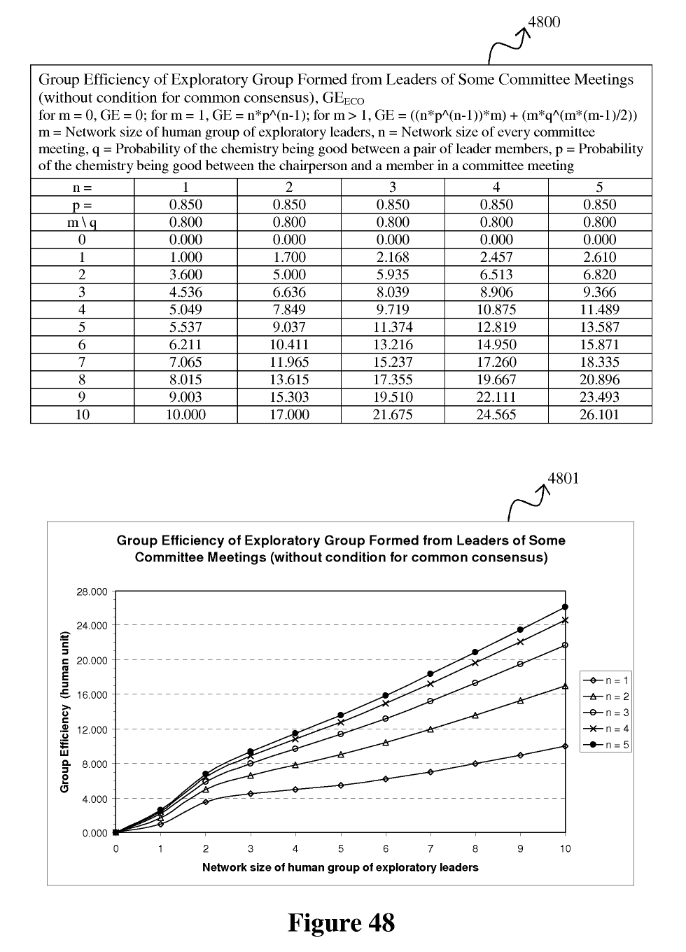

FIG. 48 (consisting of 4800 and 4801) illustrates the group efficiency (GE_{ECO}) of an exploratory group formed from leaders of some committee meetings (without condition for common consensus) as modified and enhanced from the Kurokawa's human interaction models. For m=0, GE_{ECO}=0; for m=1, GE_{ECO}=n*p̂(n−1); and for m>1, GE_{ECO}=((n*p̂(n−1))*m)+(m*q̂(m*(m−1)/2)), where m=network size of human group of exploratory leaders, n=network size of every committee meeting, q=probability of the chemistry being good between a pair of leader members, and p=probability of the chemistry being good between the chairperson and a member in a committee meeting. The group efficiency increases as the m and n increase. However, this is only true for the condition that common consensus among all the members is not needed. This condition can be applied to make the organized crime group to be inefficient.

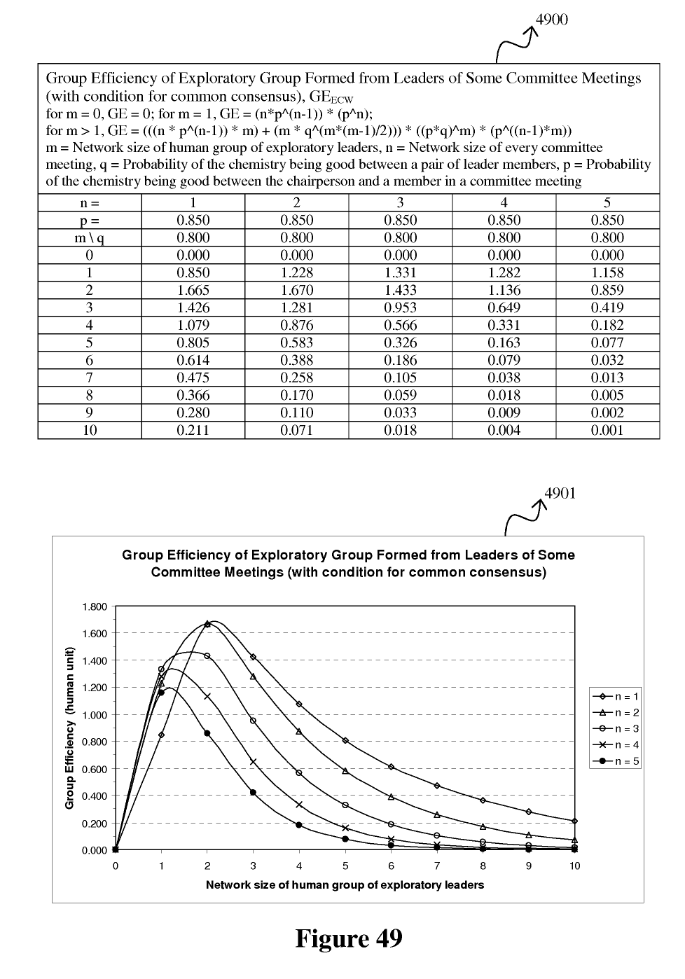

FIG. 49 (consisting of 4900 and 4901) illustrates the group efficiency (GE_{ECW}) of an exploratory group formed from leaders of some committee meetings (with condition for common consensus) as modified and enhanced from the Kurokawa's human interaction models. For m=0, GE_{ECW}=0; for m=1, GE_{ECW}=(n*p̂(n−1))*(p̂n); and for m>1, GE_{ECW}=(((n*p̂(n−1))*m)+(m*q̂(m*(m−1)/2)))*((p*q) ̂m)*(p̂((n−1)*m)), where m=network size of human group of exploratory leaders, n=network size of every committee meeting, q=probability of the chemistry being good between a pair of leader members, and p=probability of the chemistry being good between the chairperson and a member in a committee meeting. The condition of needing a common consensus among all the members is used here to make the organized crime group to be inefficient. For an appropriate p=0.85 and q=0.80, the more n and m, then the more inefficient is the group. Hence, there shall be more than one personnel in the CA (Certification Authority) to be authorized to sign, certify, and issue digital certificate. The CA personnel here are in analogy with n. Also, there shall be more than one CA or introducer of web of trust used to sign, certify, and issue digital certificate. The number of CA and/or introducer here is in analogy with m. Therefore, by having large values of m and n, the organized crime group to fake digital certificate can be made highly inefficient. In other words, the trust level of MePKC digital certificate can be increased when n and m are increased.

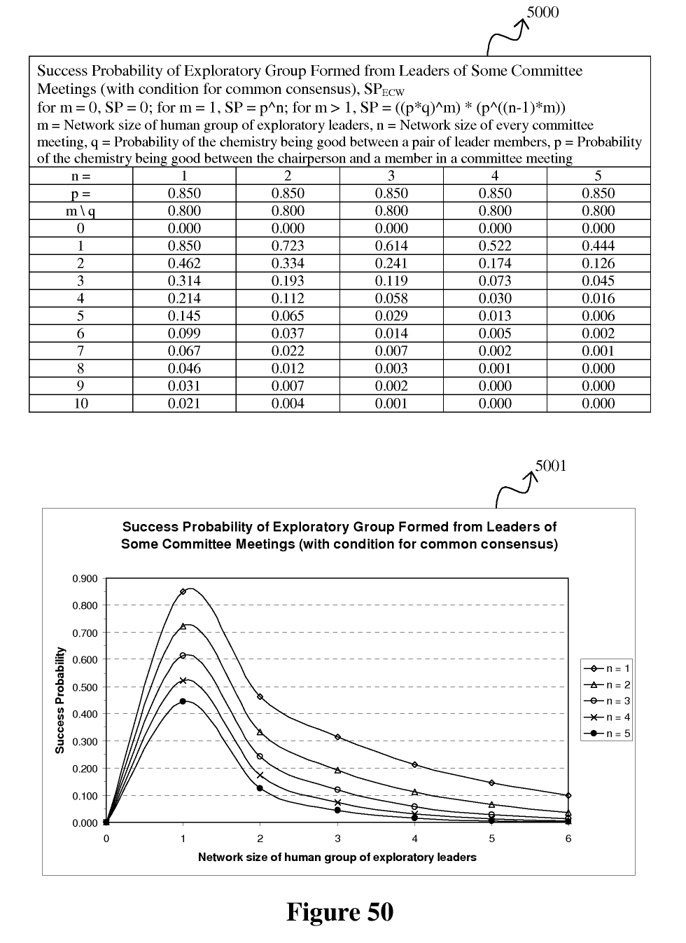

FIG. 50 (consisting of 5000 and 5001) illustrates the success probability (SP_{ECW}) of an exploratory group formed from leaders of some committee meetings (with condition for common consensus)) as modified and enhanced from the Kurokawa's human interaction models. For m=0, SP_{ECW}=0; for m=1, SP_{ECW}=p̂n; and for m>1, SP_{ECW}=((p*q) ̂m)*(p̂((n−1)*m)), where m=network size of human group of exploratory leaders, n=network size of every committee meeting, q=probability of the chemistry being good between a pair of leader members, and p=probability of the chemistry being good between the chairperson and a member in a committee meeting. The condition of needing a common consensus among all the members is used here to make the organized crime group to be inefficient. For an appropriate p=0.85 and q=0.80, the more n and m, then the more inefficient is the group. When the Kurokawa's human interaction model is simulated for the organized crime to create fake MePKC digital certificate, one of the optimal implementation is to have four (m=4) or more groups of digital signatures for binding file certification from the CA and/or introducers of trust of web, where each CA contributes three (n=3) or more digital signatures from its different personnel. In this case, the success probability of the organized crime group is less than 6%.

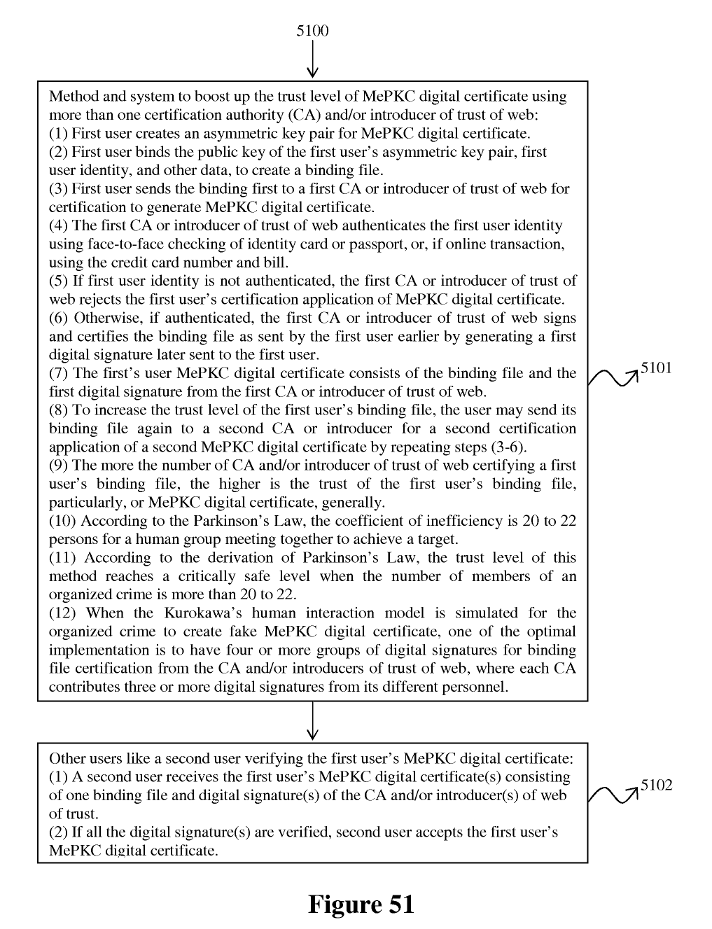

FIG. 51 illustrates the method and system to boost up the trust level of MePKC digital certificate by using more than one certification authority (CA) and/or introducer of trust of web. Starting from Entry 5100, at Box 5101, first user creates an asymmetric key pair for MePKC digital certificate. Then, first user binds the public key of the first user's asymmetric key pair, first user identity, and other data, to create a binding file. First user sends the binding first to a first CA or introducer of trust of web for certification to generate MePKC digital certificate. The first CA or introducer of trust of web authenticates the first user identity using face-to-face checking of identity card or passport, or, if online transaction, using the credit card number and bill. If first user identity is not authenticated, the first CA or introducer of trust of web rejects the first user's certification application of MePKC digital certificate. Otherwise, if authenticated, the first CA or introducer of trust of web signs and certifies the binding file as sent by the first user earlier by generating a first digital signature later sent to the first user. The first's user MePKC digital certificate consists of the binding file and the first digital signature from the first CA or introducer of trust of web. To increase the trust level of the first user's binding file, the user may send its binding file again to a second CA or introducer for a second certification application of a second MePKC digital certificate by repeating some previous steps. The more the number of CA and/or introducer of trust of web certifying a first user's binding file, the higher is the trust of the first user's binding file, particularly, or MePKC digital certificate, generally. According to the Parkinson's Law, the coefficient of inefficiency is 20 to 22 persons for a human group meeting together to achieve a target. According to the derivation of Parkinson's Law, the trust level of this method reaches a critically safe level when the number of members of an organized crime is more than 20 to 22. When the Kurokawa's human interaction model is simulated for the organized crime to create fake MePKC digital certificate, one of the optimal implementation is to have four or more groups of digital signatures for binding file certification from the CA and/or introducers of trust of web, where each CA contributes three or more digital signatures from its different personnel. At Box 5102, for other users like a second user to verify the first user's MePKC digital certificate, a second user receives the first user's MePKC digital certificate(s) consisting of one binding file and digital signature(s) of the CA and/or introducer(s) of web of trust. If all the digital signature(s) are verified, second user accepts the first user's MePKC digital certificate.

### —Mind Mapping of These Designs, Inventions, and Innovations in Individual Point Form at the First Level—

P1. Methods to create big and yet memorizable secret as password and passphrase beyond 128 bits for various applications in information engineering, especially MePKC (Memorizable Public-Key Cryptography) using fully memorizable private key, as follows and further explained in Points P2-P6:
1.1 Self-created signature-like Han character of CLPW (Chinese Language Password) and CLPP (Chinese Language Passphrase);
1.2 Two-dimensional key (2D key);
1.3 Multilingual key;
1.4 Multi-tier geo-image key;
1.5 Multi-factor key using software token; and
1.6 Their hybrid combinations.

P2. As in Point P1, methods to create big and yet memorizable secret using self-created signature-like Han character of CLPW (Chinese Language Password) and CLPP (Chinese Language Passphrase), wherein:
2.1 A normal Han character is selected from the Unicode encoding and then modified to become a self-created signature-like Han character;
2.2 Phonetic pronunciation system like Hanyu Pinyin and character structure system like Sijiao Haoma (aka Four Corner Method) are used in Romanization to represent a Han character, which is used in CJKV languages that can be Hanzi in Chinese language, Kanji in Japanese language, Hanja in Korean language, and Hán T [symbol] in Vietnamese language;
2.3 Other Romanization code of the Han character encoding, such like pronunciation systems of jyutping and rōmaji, can be used;
2.4 The Chinese character can also be transformed into signature-like graphic symbol to be a newly created Chinese character that is currently not in the repertoire of Han characters and hence higher randomness;
2.5 Semantic textual noises like character stuffing, capitalization, permutation, punctuation marks, misspelling, mnemonic substitution, and/or ASCII mutual substitution table can be used to increase the randomness;
2.6 One unit of CLPW is about 13 ASCII characters carrying nominal entropy of 85.41 bits or other size;
2.7 Two units of CLPW can realize the private key of 160-bit MePKC, and three units of CLPW for 256-bit MePKC are even better, or more units of CLPW for higher levels of MePKC; and
2.8 Creation method of CLPW and CLPP can have optional anti-keylogging application software to have higher security.
   P3. As in Point P1, methods to create big and yet memorizable secret using two-dimensional key (2D key), wherein:
3.1 An input method of cryptographic key with optional anti-keylogging has a 2-dimensional (2D) field like matrix using fixed-width font, where a user pre-selects the row size and column size of the 2D field before entering a key/password with various high-entropy and human-memorizable forms/styles suitable for Latin language users particularly;
3.2 The styles/forms of 2D key can be a single style or a hybrid style with a mixture of two or more single styles, where these styles are multiline passphrase, crossword, ASCII art/graphics, and Unicode art/graphics, which can be coded using present programming languages without special encoding;
3.3 The styles/forms of 2D key can be a single style or a hybrid style with a mixture of two or more single styles, where these styles can additionally be colorful text and sensitive input sequence, which need special encoding for present programming languages to support them.
3.4 The entropies per character for ASCII-based and Unicode-based 2D key are 6.57 and 16.59 bits, respectively;
3.5 The styles of multiline passphrase and crossword can have padding character and background character, respectively;
3.6 The elements of 2D matrix can be either partially, fully, or extraordinary filled, where to fill extraordinarily means adding some extra trailing characters as noise after the last element of the 2D matrix;
3.7 The key entropy of 2D key input method is 6.57 bits for ASCII-based 2D key and 16.59 bits for Unicode-based 2D key using 98884 graphic symbols in Unicode 5.0, which can be updated from time to time according to the release of the newest version of Unicode to increase the key entropy;
3.8 The input method is normally a keyboard, where it can also be other input devices like mouse, touch screen, stylus, sound recognition, eye-tracking technology, Microsoft Surface, etc.;
3.9 2D key can be either implemented as a stand-alone application or integrated with current applications;
3.10 2D key has a toggle function to see or hide the entered password/key;
3.11 2D key can have optional anti-keylogging application software to have higher security;
3.12 2D key can be specialized to include only numeric digits or other sets of limited encoded characters for devices with limited space like the display and key pad of a bank ATM machine and computerized safety box; and
3.13 The display of 2D key can be an LCD display or other display technologies integrated with a computer keyboard having a first partial 2D key optionally visible and a second partial 1D key in hidden mode only to better resist the shoulder-surfing attacks.
   P4. As in Point P1, methods to create big and yet memorizable secret using multilingual key, wherein:
4.1 An input method of cryptographic key has a huge set of black-and-white or colorful Unicode graphic symbols for a key space in tabular pages with optional grid partitioning and shoulder-surfing resistance techniques, where a user selects sequence of image areas as secret graphical key/password using recognition-based cognometrics and locimetrics, in which this method is suitable for logographic, bilingual and multilingual users;
4.2 Black-and-white multilingual key is a basic model with entropy of 16.59 bits per click;
4.3 Optional invisible and/or visible 3*3 grid partitioning adds another 3 bits;
4.4 Colorful multilingual key adds another 2 to 8 bits for (2+1)-color to (16+1)-color models, respectively;
4.5 Other methods to increase the entropy per click of multilingual key are special effects (like directional shadow, 3D styles, and lighting), enclosed character using shapes like circle, square, triangular, or diamond, typeface variation (like font type, font size, as well as font format of single strike through, double strike through, and underscore/underline), mirror images (left, right, up/down), (45°, 90°, 135°) clockwise and anti-clockwise rotated images, solid/hollow images, and background watermark;
4.6 The Unicode graphic symbols can be any other character encoding formats consisting of textual symbols, especially ideographs like Han characters;
4.7 The grid partitioning is set at 3*3 partitioning at normal case for each Unicode graphic symbol, where it can also be other settings like 1*1, 2*2, 4*4, etc, to have higher entropy per selected image area;
4.8 The shoulder-surfing resistance technique relies on the limit of human memorizability and false selection of image areas by toggling a key on the keyboard, or single-double or left-middle-right click of mouse;
4.9 The shoulder-surfing resistance technique has another technique where a user is allowed to enter a textual password/key into the key field at any interim session during the input of a graphical password/key, which in other words, a hybrid method combining the textual and graphical password/key;
4.10 The tabular pages have a few pages listing the frequently used Unicode symbols, especially Latin and Han characters, or Latin and other languages, to speed up the input of secret key;
4.11 The Unicode symbols in the tabular pages are from the Unicode planes of BMP (Basic Multilingual Plane) and SIP (Supplementary Ideographic Plane), where other Unicode planes can also be added;
4.12 The input method is normally a mouse, where it can also be other input devices like touch screen, tablet, stylus, keyboard, sound recognition, eye-tracking technology, Microsoft Surface, etc.;
4.13 The input method can be either implemented as stand-alone application or integrated with current applications;
4.14 The input method has a toggle function to see or hide the entered password/key in its encoding format;
4.15 The pictorial black-and-white and colorful Unicode graphic symbols are stored in the image file format of PNG (Portable Network Graphics), which is good for image compression of line art, for efficient size of image database; or better file compression algorithm like DJVU;
4.16 The pictorial colorful Unicode graphic symbols can be stored in a new image file format with smaller size using the font rasterization technique and multi-layer imaging, or generated under real-time mode using font rasterization directly;
4.17 The key entropy of multilingual key input method is at a minimum of 16 bits using black-and-white multilingual key without grid partitioning, which can be increased by 4 bits if 3*3 grid partitioning is used, and further increased by another 8 bits if (16+1)-color colorful multilingual key is used, or other entropy per selected image area if other sizes of color combinations are used;
4.18 The key space and key entropy are based on the 98884 graphic symbols in Unicode 5.0, which can be updated from time to time according to the release of the newest version of Unicode to increase the key space and key entropy;
4.19 The key space is increased using pictorial colorful Unicode graphic symbols with 17 background colors and 16 foreground colors, which can also be increased using special effects like directional shadow, 3D styles, lighting, enclosed character using shapes like circle, square, triangular, or diamond, as well as typeface variation like font type, font size, and font format;
4.20 The (16+1) colors of colorful multilingual key are black, brown, red, orange, yellow, green, blue, violet, gray, white, silver, tan, salmon, gold, khaki, and cyan for 16 foreground colors, and black, brown, red, orange, yellow, green, blue, violet, gray, white, silver, tan, salmon, gold, khaki, cyan, and pink for 17 background colors;
4.21 The first 10 colors of the (16+1)-color scheme has good memorizability based on the color code of resistor. The next 6 colors are lighter colors than the corresponding colors modulus 10. The last color pink is used as the front-slash-wise diagonal background color;
4.22 Other color combinations may also be possible; and
4.23 Multilingual key can have optional anti-keylogging application software to have higher security.
P5. As in Point P1, methods to create big and yet memorizable secret using multi-tier geo-image key, wherein:
5.1 A hybrid input method of cryptographic key using graphical password/key of geo-images and textual password/key of normal text hinted by the geo-images;
5.2 Under the GPS resolution at 15 m for civilian usages, after the consideration of memorizable geo-images at 2⁻⁷ of Earth surface, and grouping 20*20 pixels as a click area of geo-image key, entropy of geo-image key for one venue is about 25.40 bits, where there are additional 39.42 bits from the hinted textual password/key if it is a 6-letter ASCII character, making one unit of geo-image key to have entropy 64.82 bits;
5.3 Three and four units of geo-image key can realize 160-bit and 256-bit MePKC, respectively;
5.4 The multi-tier geo-image key includes the continents of Earth, seafloor of oceans and constellations of star sky, etc.
5.5 The space map can optionally have invisible and/or visible grid lines for easy references;
5.6 The input method is normally a mouse, where it can also be other input devices like touch screen, stylus, keyboard, sound recognition, eye-tracking technology, Microsoft Surface, etc.;
5.7 To further increase the key space of this method, the preceding tiers of geo-image key before the last tier can be included, and early secret selection of larger geographical area is allowed;
5.8 Yet another method to increase the key space is to invest more resources to recruit the architects to draw the geographical map of populated areas using the architectural normal scaling of 1:500 (or 1 cm:500 cm, or 1 cm:5 m), which is a resolution better than the civilian GPS resolution 15 m/pixel; and
5.9 Multi-tier geo-image key can have optional anti-keylogging application software to have higher security.
   P6. As in Point P1, methods to create big and yet memorizable secret using multi-factor key using software token, wherein:
6.1 For 160-bit MePKC, an 80-bit symmetric key can use AES-128 to encrypt a 160-bit hash of various compressed digital multimedia data like bitstream, text, image, audio, animation, or video, where this key input method is a bi-factor method based on password secret and software token;
6.2 For 512-bit MePKC, an 256-bit symmetric key can use AES-256 to encrypt a 512-bit hash of various digital multimedia data like random or non-random bitstream, text, image, audio, animation, or video, where this key input method is a bi-factor method based on password secret and software token as well;
6.3 For 2n-bit MePKC, an n-bit symmetric key can use n-bit symmetric cipher to encrypt a 2n-bit hash of various digital multimedia data like random or non-random bitstream, text, image, audio, animation, or video, where this key input method is a bi-factor method based on password secret and software token;
6.4 The password/key to access the software token can be replaced by biometrics (like fingerprint, iris and face), or strengthened by biometrics to become a multi-factor method; and
6.5 Multi-factor key using software token can have optional anti-keylogging application software to have higher security.
   P7. Methods to apply the created big and yet memorizable secrets using the methods as in Points P1-P6 for various applications using secret(s), wherein they include the following objects further explained in Points P8-P21 and are not limited thereto:
7.1 Methods and systems to realize memorizable symmetric key the secret till resistance to quantum computer attack;
7.2 Methods and systems to realize memorizable public-key cryptography (MePKC);
7.3 Methods and systems to improve security strength of other cryptographic, information-hiding, and non-cryptographic applications of secret in information engineering beyond 128 bits;
7.4 Method and system to harden the identification of embedded data in steganography although stego-data has been detected;
7.5 Method and system to transfer fund electronically over a remote network using MePKC;
7.6 Method and system to license software electronically over a remote network using MePKC;
7.7 Methods and systems to authenticate human-computer and human-human communications at a local station or over a remote network using MePKC;
7.8 Method and system to use digital certificate with more than one asymmetric key pair for different protection periods and password throttling;
7.9 Method and system to use three-tier MePKC digital certificates for ladder authentication;
7.10 Method and system to store, manage, and download voice and video calls of mobile phone and wired phone at online distributed servers;
7.11 Method and system of multipartite electronic commerce transactions; and
7.12 Method and system to boost up the trust level of MePKC digital certificate by using more than one certification authority (CA) and/or introducer of trust of web.
   P8. As in Point P1, the first novel and innovated application of created big memorizable secret using the methods and systems as in Points P1-P6 is method to realize memorizable symmetric key till resistance to quantum computer attack, wherein:
8.1 Novel realization of memorizable 192-bit symmetric key like 192-bit AES for 150-year protection; and
8.2 Novel realization of memorizable 256-bit symmetric key like 256-bit AES for protection against quantum computer attack.
8.3 Novel realization of memorizable symmetric key size beyond 128 bits for stronger security levels and longer protection periods.
   P9. As in Point P1, the second novel and innovated application of created big memorizable secret using the methods and systems as in Points P1-P6 is methods and systems to realize memorizable public-key cryptography (MePKC), wherein:
9.1 A public-key cryptosystem with high mobility by introducing human-memorizable private key using one or more of various proposed key input methods, that fulfills the minimum requirement of practical private key size at 160 bits and optionally embeds the key strengthening techniques to make a key stronger and freeze the computer technology advancement that requests for longer key length;
9.2 As in Points P2-P6, 160-bit to 256-bit MePKC using FFC (Finite Field Cryptography) or ECC (Elliptic Curve Cryptography), or any other public-key cryptography that uses practical private key sizes with enough security strength;
9.3 As in Point P6, 256-bit and beyond till 512-bit MePKC is practical, or according to Points P2-P5 for exceptional users with exceptional memory;
9.4 Secret-based MePKC can resist some side-channel attacks vulnerable to token-based PKC, such as those attacks over the fully or partially encrypted private key;
9.5 Applicable to major cryptographic schemes like encryption and signature schemes;
9.6 Applicable to minor cryptographic schemes like key exchange, authentication, blind signature, multisignature, group-oriented signature, undeniable signature, threshold signature, fail-stop signature, group signature, proxy signature, signcryption, forward-secure signature, designated-verifier signature, public-key certificate (digital certificate), digital timestamping, copy protection, software licensing, digital check (aka electronic cheque), electronic cash, electronic voting, BAP (Byzantine Agreement Protocol), electronic commerce, MAC (Message Authentication Code), key escrow, online verification of credit card, multihash signature, etc.;
9.7 The blind signature scheme includes its further applications for electronic cash (also called e-cash, electronic money, e-money, electronic currency, e-currency, digital cash, digital money, digital currency, or scrip) and electronic voting (also called e-voting, electronic election, e-election, electronic poll, e-poll, digital voting, digital election, or digital poll);
9.8 The key strengthening technique, which is also called key stretching, includes the techniques using password supplement and many rounds of hash iteration, together with hash truncation and a hash function with longer hash value like 1024 bits or more, can be used to freeze the longer key size request due to the advancement of computing technologies;
9.9 MePKC is extended to novel invention of multihash signature scheme, and novel innovations of some cryptographic schemes like digital cheque, software licensing, human-computer and human-human authentication via a computer communications network, as well as MePKC digital certificate with multiple public keys; and
9.10 Shorter and yet secure private key size at equivalent security strength of symmetric key can be obtained using hyperelliptic curve cryptography (HECC) and possibly other cryptosystems like torus-based cryptography (TBC) on the condition that sufficient experimental implementation for security testing has been done.
   P10. As in Point P1, the third novel and innovated application of created big memorizable secret using the methods and systems as in Points P1-P6 is methods and systems to improve security strength of other cryptographic, information-hiding, and non-cryptographic applications of secret in information engineering beyond 128 bits, wherein:
10.1 As a seed in pseudo-random number generator (PRNG), cryptographically secure pseudo-random bit generation (CSPRBG);
10.2 As a secret in password-authenticated key exchange (PAKE) like Secure Remote Password Protocol 6 (SRP-6);
10.3 As a stego-key in steganography of information hiding;
10.4 As a secret key in symmetric watermarking of information hiding; and
10.5 As a private key in asymmetric watermarking of information hiding.
   P11. Methods and systems to generate multiple slave keys from a single master key called multihash key to further boost up the number of created big memorizable secrets as in Points P1-P6, and to be applied in the novel and innovated applications of secret as in Point P7, wherein:
11.1 A basic multihash key using hash iteration, hash truncation, and CSPRBG supporting infinite online account and finite offline accounts like 20, 32, etc., which is slightly adjustable for more offline account if a better computer is used;
11.2 An innovated basic multihash key to become an improved multihash key using filename, random number, or two-tier structure to support more offline accounts, where method using random number supports almost infinite offline account but requires ciphertext storage of random number, and method using two-tier or more does not need ciphertext storage of random number but supports up to finite offline accounts like 400 or more;
11.3 To increase the randomness of the slave key, it is seeded in a CSPRBG to generate two random n-bit bitstreams, RND_{—}1 and RND_{—}2, in serial, where RND_{—}1 and RND_{—}2 are then XORed (exclusive ORed) to create a final slave key;
11.4 A first variant where the two-tier multihash key can be extended to multi-tier like eight-tier;
11.5 Using a combination of eight-tier multihash key and remembering the selection of intermediate slave keys, if two slave keys are selected to be hashed and then seeded in a CSPRBG to create a final slave key, then about 68.1 bits of entropy can be added to the entropy of the master key, where to get 256-bit slave key for 256-bit MePKC, a master key with minimum 188 bits is enough, and to get 160-bit slave key for 160-bit MePKC, a master key with minimum 92 bits is sufficient;
11.6 Besides remembering the selected intermediate slave keys for combination to generate the final slave key, a second variant can use permutation of some slave keys in the mono-tier multihash key;
11.7 For mono-tier multihash key with 20 slave keys, if every slave key is only used once, there are (20!*e) permutations to give additional entropy of 62.5 bits to the master key, where this permutation is hashed, and then seeded in the CSPRBG to generate the final slave key, further in which to get 256-bit slave key for 256-bit MePKC, a master key with minimum 194 bits is enough, and to get 160-bit slave key for 160-bit MePKC, a master key with minimum 98 bits is sufficient;
11.8 A third variant of multihash key is a hybrid combination of multi-tier and permutation of some slave keys at the same tier;
11.9 If the slave key can be used more than once in the first, second, and third variants of multihash key, then the key space of the key space can be enlarged and more additional entropy is added;
11.10 A fourth variant where the one-time SMS token of mobile phone used in Internet banking can be replaced by a software token by following the steps as follows:
   11.10.1 User and bank server share a master key;
   11.10.2 Bank server sends a first message with random value, timestamp and downcount/upcount number to a remote user;
   11.10.3 The user uses the downcount/upcount number as the hash iteration number of a master key in the multihash key to generate a slave key;
   11.10.4 The user uses the slave key to encrypt the first message to create a second message;
   11.10.5 The user sends the second message to the bank server for authentication;
   11.10.6 If the verification of second message by bank server is valid, then authentication is successful and the downcount/upcount number is decreased/increased by one; otherwise the authentication is rejected and downcount number remains the same; and
11.11 A fifth variant applied for supervisor-wise non-critical secret, where key management of master keys and slave keys as follows of an organization from multihash key can act as a simple key escrow method and system:
   11.11.1 Supervisor or anyone from a higher management level holds a grandmaster key;
   11.11.2 Generate staff slave key K₁=Multihash Key (Grandmaster Key∥Staff ID∥Event ID∥Year), where K₁ is multiple keys used by a staff;
   11.11.3 Generate client slave key K₂=Multihash Key (K₁∥Client ID∥Event ID∥Year), where K₂ is multiple keys shared by a staff and his clients.
      P12. Method and system to generate object-designated signature message with specific meaning, function, or recipient called multihash signature to be used independently, or to be applied in the novel and innovated applications of secret as in Point P7, wherein:
12.1 Multihash signature carries defined representation like designated receiver, functions like referral, and meanings like cheque validity status;
12.2 It allows anonymous identity, and representation of object, action, feature, function, meaning, etc., as a representation;
12.3 It avoids name clashing and rename problem for stronger collision resistance strength;
12.4 For recipient non-repudiation, the recipient as a second signer signs the received signature using one's private key to create an acknowledgment message sent to the originator of object-designated signature message as the first signor;
12.5 Multihash signature is used here in some novel innovated inventions of triple-watermark digital cheque and triple-watermark software licensing schemes together with MePKC, steganography and watermarking; and
12.6 For stronger security, the hash value of a message may be concatenated with the MAC and IP address of a networked computer, which can be used in multihash signature and other cryptographic schemes as follows:

Signature=Multihash Signature(Hash(Message)∥MAC Address∥IP Address)

P13. As in Point P1, the fourth novel and innovated application of created big memorizable secret using the methods and systems as in Points P1-P6 is method and system to harden the identification of embedded data in steganography although stego-data has been detected, wherein:
13.1 It uses big memorizable secret creation methods to resist the stego-key searching;
13.2 Asymmetric and symmetric key cryptography are used to boost up the security of steganography;
13.3 To embed secret into a cover data, firstly, generate an n-bit random number as a symmetric key K_{SY}, where for example n=256;
13.4 Secondly, encrypt the embedded data M using symmetric key K_{SY} under the AES-256 to produce ciphertext C_{M};
13.5 Thirdly, encrypt the symmetric key using recipient's public key K_{pub} to produce N_{L}-bit ciphertext C_{K}, where for example N_{L}=512;
13.6 Fourthly, seed an N_{ST}-bit stego-key K_{ST} into a CSPRBG to produce sequential units of N_{R}-bit bitstream B, where for example N_{ST}=256 and N_{R}=32;
13.7 Assume the cover data is an image with dimensions (x*y) and bit depth per channel at B_{P} bits for channels RGBA in the PNG (Portable Network Graphics) file format, where for example m=1024, n=1024, B_{P}=8, N_{P}=number of bits per pixel=32, then S_{size}=maximum supported size of embedded data in a cover data=x*y*B_{P}=1024*1024*8≧total size of C_{M} and C_{K};
13.8 Every pixel of the image is indexed by an address location starting from the top leftmost pixel, moving to the rightmost pixel, then continuing with the leftmost pixel of the second line, and so on, until the rightmost pixel in the last bottom line;
13.9 For every sequential unit of N_{R}-bit bitstream B, calculate L_{P}=(B mod (x*y)) to get the selected pixel location in the cover image, where for example L_{P}=B mod 2²⁰, and first, second, third, . . . , and so on of the B_{S} are labeled as B₀, B₁, B₂, . . . , B_{N};
13.10 For every B_{N}, record it into an index table, and if a B_{N} has occurred previously, mark and use the subsequent (B_{N}+1) as the selected pixel location;
13.11 Chunk the C_{K} and C_{M} into B_{P}-bit block, and store the chunks of C_{K} first, followed by chunks of C_{M}, one by one, into the B_{P}-bit alpha channels addressed by the N_{R}-bit bitstream B to produce a partially completed stego-data;
13.12 Seed another CSPRBG with the present clock time to produce sequential garbage units of B_{P}-bit bitstream G to harden the identification of embedded data;
13.13 Store the sequential garbage units of B_{P}-bit bitstream G addressed by the additional N_{R}-bit bitstream B into the remaining alpha channels of remaining pixel locations until the index table has all the pixel locations marked;
13.14 To extract the embedded data from stego-data, use the N_{ST}-bit stego-key K_{ST} to generate sequential units of N_{R}-bit bitstream B, calculate L_{P}=(B mod (x*y)))) and its subsequent value if there is a clash to get the series of selected pixel locations in the stego-image, and then extract the ciphertext C_{K}, followed by C_{M};
13.15 Decrypt the ciphertext C_{K} using the recipient's private key Kₚₜₑ to get symmetric key K_{SY};
13.16 Decrypt the ciphertext C_{M} using the K_{SY} to retrieve the embedded message M;
13.17 The addition of garbage bitstream G is optional;
13.18 To paralyze the detection of stego-data, a sender can frequently broadcast dummy stego-data with noises as the embedded data;
13.19 The PNG file format can be other file format using lossless image compression algorithm like BMP (Bitmap file format) and TIFF (Tagged Image File Format);
13.20 Besides the alpha channels of image, it can be other types of image steganography like LSB insertion; and
13.21 Besides image data type, it can be other types of multimedia data like bitstream, text, audio, animation, video, or their hybrid combinations.
   P14. As in Point P1, the fifth novel and innovated application of created big memorizable secret using the methods and systems as in Points P1-P6 is method and system to transfer fund electronically over a remote network using MePKC, wherein:
14.1 MePKC triple-watermark digital check scheme is used to transfer fund electronically using MePKC, CSPRBG, lossless data compression, as well as information hiding technique like steganography and fragile watermarking;
14.2 The first watermark is a digital signature signed by the payer bank to verify the first image portion of payer bank name, payer name, payer email and cheque number;
14.3 The second image portion shows the payee name, payee email, payee IC/passport number, cheque amount, date and optional embedded pictorial signature;
14.4 The second watermark is a digital signature of the first and second image portions signed by the payer, which is then hidden in the cheque using information hiding technique, where the stego-key or watermarking key is a shared secret between the payer and payer bank;
14.5 The third watermark is a multihash signature signed by payer's bank to designate the meanings of check validity status like paid, void, withdrawn, etc.;
14.6 Some random bitstreams are added to confuse the detection of the three watermarks; and
14.7 The fragile watermarking scheme here can be alternated with a steganographic scheme.
   P15. As in Point P1, the sixth novel and innovated application of created big memorizable secret using the methods and systems as in Points P1-P6 is method and system to license software electronically over a remote network using MePKC, wherein:
15.1 MePKC triple-watermark software licensing scheme is used to license software electronically using MePKC, CSPRBG, lossless data compression, as well as information hiding technique like steganography and fragile watermarking;
15.2 The first watermark is a digital signature signed by the software vendor to verify the first image portion of software vendor name, reseller name, reseller email and software product ID (or license number);
15.3 The second image portion shows the buyer name (i.e. licensee name), buyer email, buyer IC/passport number, type of software product, date and optional embedded pictorial signature;
15.4 The second watermark is a digital signature of the first and second image portions signed by the sales agent, which is then hidden in the license using information hiding technique, where the stego-key or watermarking key is between the sales agent and software vendor;
15.5 The third watermark is a multihash signature signed by software vendor to designate the meanings of software license validity status like granted, upgraded, resold, void, withdrawn, evaluation, etc.;
15.6 Some random bitstreams are added to confuse the detection of the three watermarks; and
15.7 The fragile watermarking scheme here can be alternated with a steganographic scheme.
   P16. As in Point P1, the seventh novel and innovated application of created big memorizable secret using the methods and systems as in Points P1-P6 is methods and systems to authenticate human-computer and human-human communications at a local station or over a remote network using MePKC, wherein:
16.1 This is a computer authentication method, that exists between human-computer and human-human using public-key cryptography without shared secret in the forms of plaintext password/key, encrypted password/key, hashed password/key, or verifier, among the two or more parties, and has the properties of perfect forward secrecy, non-plaintext equivalence, resistance to dictionary attacks, and precomputation attacks;
16.2 The public-key cryptography is realized using the MePKC based on memorizable and mobile private key;
16.3 Challenge-and-response authentication protocol is used together with timestamp and nonce to realize this method;
16.4 The computer authentication method can be further enhanced to become a mutual authentication method by inversing the involved two parties in using the challenge-and-response authentication protocol;
16.5 To increase the difficulty to crack an online account, measures like limited time, limited usage amount of a factor, and limited number of login attempt per 1 time unit, can be used for some quantum number of unsuccessful login attempts;
16.6 If the same asymmetric key pair is used together with multihash key to create different slave keys for different online accounts, this allows pseudo-one-set password entry to multiple websites without having password domino cracking effect as in symmetric key cryptosystems;
16.7 The online authentication using MePKC asymmetric key cryptosystem may resort to symmetric key cryptosystem using password, token or biometrics, for access of minimal information like secret question if the asymmetric key cryptosystem has failed or digital certificate revoked; and
16.8 CAPTCHA (Completely Automated Public Turing test to tell Computers and Humans Apart) can be used to resist online machinery attack.
   P17. As in Point P1, the eighth novel and innovated application of created big memorizable secret using the methods and systems as in Points P1-P6 is method and system to use digital certificate with more than one asymmetric key pair for different protection periods and password throttling, wherein:
17.1 A design of digital certificate carrying four public keys or other number more than one for different applications, i.e. 160-bit, 256-bit, 384-bit, and 512-bit MePKC;
17.2 Multihash key can improve the memorizability of this MePKC digital certificate with more than one asymmetric key pair significantly;
17.3 A person skilled in the art can further optimize the application of multihash key for MePKC digital certificate with more than one asymmetric key pair;
17.4 To detect the cracking event of MePKC digital certificate, at least a bait asymmetric key pair is needed to see if there is any hacker trying to crack a digital certificate;
17.5 In addition to the current prior art of time and bit length for the password throttling of access authentication, these multiple asymmetric key pairs in one MePKC digital certificate can be used for password throttling as well, where the account cracking becomes harder from one asymmetric key pair to the other and so on;
17.6 The online authentication using multiple asymmetric key pairs in one digital certificate of MePKC asymmetric key cryptosystem may resort to symmetric key cryptosystem using password, token or biometrics, for access of minimum information like secret questions and answers if the asymmetric key cryptosystem has failed or digital certificate revoked;
17.7 The number of public keys in a MePKC digital certificate may be any number more than one; and
17.8 For different bits of security on the scale of symmetric key, the combination settings of MePKC key sizes can be flexibly modified and adjusted.
   P18. As in Point P1, the ninth novel and innovated application of created big memorizable secret using the methods and systems as in Points P1-P6 is method and system to use three-tier MePKC digital certificates for ladder authentication, wherein:
18.1 This method has three groups of MePKC digital certificates at three tiers, subgroups in the second group, and sub-subgroups in the second subgroup of second group for different application purposes;
18.2 The first group of MePKC digital certificate at the first tier acts as certification authority, introducer and endorser for second and third groups of MePKC digital certificate at the second and third tiers, respectively, where the private keys of the first, second, and third groups are slave keys from a multihash key of a master key;
18.3 The second group of MePKC digital certificate at the second tier may have private key to be persistent and non-persistent in computer memory like RAM and is used directly for various applications like encryption, signature, authentication, key exchange, etc.;
18.4 The third group of MePKC digital certificate at the third tier has non-persistent private key in computer memory like RAM and is used directly for various applications like encryption, signature, authentication, key exchange, etc.;
18.5 For the user information in the second and third groups of MePKC digital certificate, it can be friendly modified by the user from time to time, and later signed and endorsed again using the same user's first group of MePKC digital certificate;
18.6 For the second group of MePKC digital certificate used for authentication purposes, there can be another two subgroups, where the first subgroup of asymmetric key pair is non-persistent in computer memory for ephemeral or transient usages like one-time authentication, and the second subgroup of asymmetric key pair is persistent in computer memory within limited amount per time unit for steady usages like fund transfer and bill payment;
18.7 For authentication application, the first and second subgroups of the second group may be rolling keys, in which their private key and public key may change after a pre-set number of usages according to equation as follows to provide changing private key and hence prefect forward secrecy;
Rolling private key=Hash (Master Key∥Username ID∥salt) or
Rolling private key=Hash (Multihash Key (Master Key∥Username ID), salt)
18.8 The second subgroup of second group can be further divided into some sub-subgroups for ladder authentication to resist MITM (Man-In-The-Middle) attacks, where first sub-subgroup may access, manage, modify, endorse, delete, etc., first group of information, and second sub-subgroup for second group of information, and so on;
18.9 For highest security, the private key of the third group is only used when the networked computer is offline or disconnected from the computer communications network like Internet and LAN;
18.10 An exemplary application of this method and system is its function as the second and more authentication factors in the Internet banking;
18.11 When anonymity feature is needed, then at least an additional set of MePKC digital certificate from the first, second, and/or third group is needed; and
18.12 The three-tier design may be modified to become other numbers of tier.
   P19. As in Point P1, the tenth novel and innovated application of created big memorizable secret using the methods and systems as in Points P1-P6 is method and system to store, manage, and download voice and video calls of mobile phone and wired phone at online distributed servers, wherein:
19.1 The wireline and wireless devices have some buttons to activate, pause and terminate data recording;
19.2 For telecommunications using wireline and wireless devices with buttons to divert call to voice/video box without receiving the call, as well as to activate, pause and terminate data recording, the distributed servers at the CO (Central Office) (aka Telephone Exchange) of PSTN (Public Switched Telephone Network) and/or communication management (CM) of MTSO (Mobile Telecommunications Switching Office) (aka Mobile Telephone Switching Office) are used, respectively, to record, encrypt using MePKC, and store online the voice and video calls into user account;
19.3 For telecommunications between computer and wireline or wireless devices with buttons to divert call to voice/video box without receiving the call, as well as to activate, pause and terminate the data recording by calling and called parties, the users using the computer can access the distributed servers of wireline and wireless phone services provider, and download, store, as well as decrypt using MePKC, the voice and/or video calls locally in the computer or remotely at the distributed servers of the Internet services providers;
19.4 MePKC authentication scheme is used to verify the user identity to access, manage, download, modify, delete, etc., the voice and video calls stored in the distributed servers at the telephone exchange of PSTN, communication management (CM) of MTSO, and Internet services providers;
19.5 Alternatively, conventional cryptosystems using symmetric password, non-memorizable private key, token, and biometrics, can be used to verify the user identity to access, manage, download, modify, delete, etc., the voice and video calls stored in the distributed servers at the telephone exchange of PSTN, communication management (CM) of MTSO, and Internet services providers; and
19.6 Likewise, this method can be extended to other online electronic data storage using MePKC or the conventional cryptosystems using symmetric password, non-memorizable private key, token, and biometrics.
   P20. As in Point P1, the eleventh novel and innovated application of created big memorizable secret using the methods and systems as in Points P1-P6 is method and system of multipartite electronic commerce transactions, wherein:
20.1 MePKC cryptographic schemes like encryption, signature and authentication schemes are used in the Byzantine communications of the BAP for online electronic commerce transactions;
20.2 The multipartite communications of online electronic commerce transaction can be completed using any Byzantine Agreement Protocol to achieve a common agreement called Byzantine Agreement (BA) with or without artificial neural network to perform the majority function;
20.3 For more efficient multipartite communications of electronic commerce transaction, tripartite BAP-ANN (Byzantine Agreement Protocol with Artificial Neural Network) can be used together with its faulty node detection function;
20.4 The involved entities in the electronic commerce are divided into three groups: Essential, government and non-essential groups;
20.5 The first group, which is essential group, may consist of merchant, customer, merchant's bank, customer's bank, credit card company (like VISA and MasterCard), credit card password company (like PayPal, MasterCard SecureCode, and Verified by VISA), loyalty point company, local insurance company, foreign product-origin insurance company, as well as foreign intermediate-region insurance company;
20.6 The second group, which is government group, may consist of various departments of national federal government, national state government, national local government, foreign product-origin federal government, foreign product-origin state government, foreign product-origin local government, foreign intermediate-region federal government, foreign intermediate-region state government, and foreign intermediate-region local government;
20.7 The third group, which is non-essential group, may consist of local land transportation agent, local air transportation agent, local sea transportation agent, international foreign product-origin land transportation agent, international foreign product-origin air transportation agent, international foreign product-origin sea transportation agent, international foreign intermediate-region land transportation agent, international foreign intermediate-region air transportation agent, international foreign intermediate-region sea transportation agent, local storehouse agent, foreign product-origin storehouse agent, and foreign intermediate-region storehouse agent;
20.8 During the Byzantine communications, the loyal message is approved transaction and the faulty message is rejected transaction;
20.9 For the first group, the entities of merchant and customer are critical and cannot be replaced; whereas other entities are non-critical and can be replaced;
20.10 For the second group, all the entities are critical and cannot be replaced;
20.11 For the third group, all the entities are non-critical and can be replaced
20.12 In the first possible implementation, the entity of customer is the only source node;
20.13 For the group BA in the first group, there shall be no faulty node detected, and if there is detected faulty node other than merchant and customer, then this detected entity having a faulty message shall be replaced until there is no faulty node detected in the first group;
20.14 For the group BA in the second group, there shall be no faulty node detected for approved transaction, and if at least a faulty node is detected, then it is irreplaceable and the electronic commerce transaction shall be rejected;
20.15 For the group BA in the third group, there shall be no faulty node detected for approved transaction, and if at least a faulty node is detected, then it is replaceable until no faulty node detected for an approved transaction;
20.16 When the group BA's of all the three groups agree, then an electronic commerce transaction is approved;
20.17 Otherwise, if at least one of the group BAs rejects, then the electronic commerce transaction is rejected;
20.18 In the second possible implementation, there are two rounds of Byzantine communications, where the customer is the first source node to agree and send message about paying monetary tokens to the merchant, and then the merchant acts as second source node to agree and send message about delivering the product and/or service to the customer;
20.19 Both rounds of Byzantine communications in the second possible implementation are the same as the Byzantine communication in the first possible implementation, where all the group BAs have to be agreed for approved transaction, or else transaction rejected; and
20.20 The trusted parties can be excluded if the individual group BA of each node is broadcasted as in the faulty node detection round to the nodes of other groups to derive the network BA.
   P21. As in Point P1, the twelfth novel and innovated application of created big memorizable secret using the methods and systems as in Points P1-P6 is method and system to boost up the trust level of MePKC digital certificate by using more than one certification authority (CA) and/or introducer of trust of web, wherein:
21.1 Asymmetric key pair of MePKC digital certificate is created by the first user;
21.2 The number of public keys of the first user's asymmetric key pairs in a MePKC digital certificate can be one or more than one;
21.3 The public key of the first user's asymmetric key pair, first user identity, and other data are bound as a file and sent by a user to a first CA or introducer of trust of web for certification to generate MePKC digital certificate;
21.4 The first CA or introducer of trust of web may be a government authority, and people working in the fields of religion, law, police, security, politics, army, finance, diplomacy, etc., who have a high trust level in the society like judge, Commissioner for Oaths, lawyer, etc.;
21.5 The first CA or introducer of trust of web authenticates the first user identity using face-to-face checking of identity card or passport, or, if online transaction, using the credit card number and bill;
21.6 If first user identity is not authenticated, the first CA or introducer of trust of web rejects the first user's certification application of MePKC digital certificate;
21.7 Otherwise, if authenticated, the first CA or introducer of trust of web signs and certifies the binding file of the public key of the first user's asymmetric key pair, first user identity, and other data as sent by the first user earlier by generating a first digital signature;
21.8 The first's user MePKC digital certificate consists of the binding file of the public key of the first user's asymmetric key pair, first user identity, and other data, as well as the first digital signature from the first CA or introducer of trust of web;
21.9 The first digital signature is used by other users to verify the authenticity of the first user's MePKC digital certificate, generally, or the first user's binding file of the public key of the first user's asymmetric key pair, first user identity, and other data, particularly;
21.10 To increase the trust level of the first user's binding file, the user may send its binding file again to a second CA or introducer of trust of web for a second certification application of a second MePKC digital certificate;
21.11 The number of CA or introducer of trust of web certifying a first user's binding file can be one or more than one to achieve higher trust level;
21.12 A first user's binding file can have one or more than one digital signature of one or more CA and/or introducer of trust of web;
21.13 The more the number of CA and/or introducer of trust of web certifying a first user's binding file, the higher is the trust of the first user's binding file, particularly, or MePKC digital certificate, generally;
21.14 Yet for higher trust level, the CA may have one or more personnel issuing one digital signature per person to certify a first user's binding file;
21.15 According to the Parkinson's Law, the coefficient of inefficiency is 20 to 22 persons for a human group meeting together to achieve a target;
21.16 According to the derivation of Parkinson's Law, the trust level of this method reaches a critically safe level when the number of members of an organized crime is more than 20 to 22; and
21.17 When the Kurokawa's human interaction model is simulated for the organized crime to create fake MePKC digital certificate, one of the optimal implementation is to have four or more groups of digital signatures for binding file certification from the CA and/or introducers of trust of web, where each CA contributes three or more digital signatures from its different personnel.
   P22. Methods as pointed from Points (P1) to (P21) can be applied into any system and networked system of computing devices, wherein:
22.1 The computing devices may be a mobile phone, PDA (Personal Digital Assistant), embedded system, wearable computer, desktop computer, notebook computer, workstation, server, proxy server, mainframe, supercomputer, etc.;
22.2 The computing devices have three main components consisting of CPU (Central Processing Unit), main memory, and I/O (Input/Output) devices connected by some system interconnection bus;
22.3 The CPU of the computing devices have three main components consisting of control unit, ALU (Arithmetic and Logic Unit), and registers connected by some internal CPU interconnection;
22.4 The control unit of CPU of computing devices have yet another three main components consisting of control unit registers and decoders, sequencing logic, and control memory;
22.5 The I/O devices of the computing devices may involve one or many wired and/or wireless modem, network card, network adapter, LAN card, NIC (Network Interface Card), etc., to set up a computer communications network with the other computing devices to form a networked system; and
22.6 The networked system may be a PAN (Personal Area Network), LAN (Local Area Network) (of home, company, school, etc.), CAN (Campus Area Network), MAN (Metropolitan Area Network), WAN (Wide Area Network), Internet, or any other types of computer communications network.

### —Mind Mapping of These Designs, Inventions, and Innovations in Point Group Form at the Second Level—

G1. Methods and systems to create big and yet memorizable secret as password and passphrase beyond 128 bits for various applications in information engineering, especially MePKC (Memorizable Public-Key Cryptography) using fully memorizable private key, as follows by using one or a hybrid combination, in which:
(a) using self-created signature-like Han character of CLPW (Chinese Language Password) and CLPP (Chinese Language Passphrase) as further described in Point P2 of Section Detailed Description of the Inventions;
(b) using two-dimensional key (2D key) with the possible key styles of multiline passphrase, crossword, ASCII art/graphics, Unicode art/graphics, colorful text, sensitive input sequence, as well as partially, fully, and extraordinary filled in matrix-like 2D field, as further described in Point P3;
(c) using multilingual key with black-and-white or colorful Unicode graphic symbols for a key space in tabular pages with optional grid partitioning, as further described in Point P4;
(d) using multi-tier geo-image key from a graphical password/key of geo-images and textual password/key of normal text hinted by the geo-images, as further described in Point P5;
(e) using multi-factor key using software token, where for 2n-bit MePKC, an n-bit symmetric key can use n-bit symmetric cipher to encrypt a 2n-bit hash of various digital multimedia data like random or non-random bitstream, text, image, audio, animation, or video, as further described in Point P6; and
(f) using the hybrid combinations of the above-mentioned methods and systems in this Point Group G1.
   G2. Methods and systems to generate multiple slave keys from a single master key called multihash key to further boost up the number of created big memorizable secrets as in Point Group G1 or work independently, as further described in Point P11 in which they can be in some variant forms of:
(a) a basic multihash key using hash iteration, hash truncation, and CSPRBG supporting infinite online account and finite offline accounts like 20, 32, etc.;
(b) an innovated basic multihash key to become an improved multihash key using filename, random number, or two-tier structure to support more offline accounts;
(c) a combination of t-tier multihash key for the combination selection of intermediate slave keys to generate the final slave key;
(d) a permutation of some slave keys in the mono-tier multihash key keys to generate the final slave key;
(e) a hybrid combination of multi-tier and permutation of some slave keys at the same tier to generate the final slave key;
(f) a dynamic slave key with its generation controlled by a downcount/upcount number as the hash iteration number of a master key in the multihash key to act as a software token for one-time SMS token of mobile phone used in Internet banking; and
(g) a simple key escrow method and system by using the specific key management of master keys and slave keys from multihash key for an organization.
   G3. Method and system to generate object-designated signature message with specific meaning, function, or recipient called multihash signature to be used independently or together with the methods and system in Point Group G1 for various applications in information engineering, as further described in Point P12, wherein the features are:
(a) defined representation like designated receiver, functions like referral, and meanings like cheque validity status;
(b) possible anonymous identity, and representation of object, action, feature, function, meaning, etc., as a representation;
(c) avoidance of name clashing and rename problem for stronger collision resistance strength; and
(d) recipient non-repudiation, where the recipient as a second signer signs the received signature using one's private key to create an acknowledgment message sent to the originator of object-designated signature message as the first signor.
   G4. As in Point Group G1, invention improvements thereof as simple applications of Point Group G1 involve simple and yet direct usages of big memorizable secret, wherein they can be:
(a) methods and systems to realize memorizable symmetric key the secret till resistance to quantum computer attack, as further described in Point P8;
(b) methods and systems to realize memorizable public-key cryptography (MePKC) using fully memorizable private key, which has strongest expected impact in this invention disclosure, as further described in Point P9; and
(c) methods and systems to improve security strength of other cryptographic, information-hiding, and non-cryptographic applications of secret in information engineering beyond 128 bits, as further described in Point P10.
   G5. As in Point Groups G1, G3, and G4, there are applications of big secret from Point Group G1, object-designated signature function of multihash signature from Point Group G3, as well as cryptographic functions from Point Group G4, for invention improvements thereof as applications needing hidden authenticated data in some files, wherein they are:
(a) method and system to harden the identification of embedded data in steganography although stego-data has been detected, as further described in Point P13;
(b) method and system to transfer fund electronically over a remote network using MePKC, as further described in Point P14; and
(c) method and system to license software electronically over a remote network using MePKC, as further described in Point P15.
   G6. As in Point Groups G1, G2, and G4, there are applications of big secret from Point Group G1, multihash key from Point Group G2, as well as cryptographic functions from Point Group G4, for invention improvements thereof as applications needing stronger public-key certificate with one or more asymmetric key pairs per user, wherein they are:
(a) method and system to use digital certificate with more than one asymmetric key pair for different protection periods and password throttling, as further described in Point P17;
(b) method and system to use three-tier MePKC digital certificates for ladder authentication, as further described in Point P18; and
(c) method and system to boost up the trust level of MePKC digital certificate by using more than one certification authority (CA) and/or introducer of trust of web, as further described in Point P21.
   G7. As in Point Groups G1, G2, G4, and G6, there are applications of big secret from Point Group G1, multihash key from Point Group G2, cryptographic functions from Point Group G4, and MePKC public-key certificate from Point Group G6, for invention improvements thereof as applications needing better mutual authentication for human-computer and human-human communications over a malicious computer communications network, wherein they are:
(a) methods and systems to authenticate human-computer and human-human communications at a local station or over a remote network using MePKC, as further described in Point P16;
(b) method and system to store, manage, and download voice and video calls of mobile phone and wired phone at online distributed servers, as further described in Point P19; and
(c) method and system of multipartite electronic commerce transactions using Byzantine Agreement Protocol (BAP), generally, or tripartite BAP-ANN (Byzantine Agreement Protocol with Artificial Neural Network), particularly, as further described in Point P20.
   G8. As in Point Groups G1 to G7, the methods and systems include the networked systems of computing devices, as further described in Point P22, wherein:
(a) the computing devices may be anything with CPU (Central Processing Unit), main memory, and I/O (Input/Output) devices connected by some system interconnection bus; and
(b) the networked system may be a PAN (Personal Area Network), LAN (Local Area Network) (of home, company, school, etc.), CAN (Campus Area Network), MAN (Metropolitan Area Network), WAN (Wide Area Network), Internet, or any other types of computer communications network.

### OBJECTIVES OF THE PRESENT INVENTION

It is an object of the present invention to provide information security systems which overcome the deficiencies of existing information security systems. Additional objects, advantages, novel features of the present invention will become apparent to those skilled in the art from this disclosure, including the previous and following detailed descriptions, as well as by practice of the invention. While the invention is described in this article with reference to preferred embodiment(s), it should be understood that the invention is not limited thereto. It will also be appreciated that the preferred embodiment is illustrative only and that various changes may be made by those skilled in the art without departing from the spirit and scope of the invention.

Yet it will also be recognized by those skilled in the art that, while the invention has been described above in terms of one or more preferred embodiments, it is not limited thereto. Various features and aspects of the above described invention may be used individually or jointly. Further, although the invention has been described in the context of its implementation in a particular environment and for particular purposes, e.g. in providing security for local and networked Internet communications, those skilled in the art will recognize that its usefulness is not limited thereto and that the present invention can be beneficially utilized in any number of environments and implementations.

Those of ordinary skill in the art having access to the teachings herein will recognize additional implementations, modifications, and embodiments, as well as other fields of use, in which are within the full breath, spirit, and scope of the invention as disclosed and claimed herein and with respect to which the invention could be of significant utility.

### APPENDIX A

### Chinese-English Translation for Drawings Section

U.S. patent application Ser. No. 12/921,155 (Filed on 5 Sep. 2010)

FIG. 2A: [symbol] (simplified script: han)—1. An ancient dynasty in China from 206 B.C. to 220 A.D.

FIG. 2B: This is a self-created signature-like Chinese character modified from [symbol] (han). It is a non-existent symbol in the standard Chinese dictionary.

FIG. 5: This is a range of Unicode graphic symbols for a page chart of Unihan characters as in Unicode 4.1.0 <http://www.unicode.org/versions/Unicode4.1.0>, from code 4E00₁₆ to 4EFF₁₆. Each of the Unicode symbols can be entered using keyboard button series by inputting its Unicode decimal value when holding down the “Alt” button at the same time, and then release the “Alt” button. For example, [symbol] (ding) (headcount) has decimal value 19969₁₀ (=4E01₁₆). This Unicode page chart in 256 Chinese characters is just used to illustrate the example of multilingual key realization. There can and may involve all the Unicode graphic symbols or other encodings in various world languages to support the multilingual password. Sets of combo-boxes containing subsets of Unicode graphic symbols form the full collection of key space of multilingual key. There is no need to understand the original meaning of a Unicode symbol in this figure, but the rule is to recognize it as a graphical symbol or picture. Thus, there is no need for translation. For a closer reference, please see page 2 of <http://www.unicode.org/charts/PDF/Unicode-4.1/U41-4E00.pdf>.

FIG. 6: [symbol] (qin)—1. An ancient dynasty in China from 221 B.C. to 206 B.C.

FIG. 7: [symbol] (traditional script: han)—1. An ancient dynasty in China from 206 B.C. to 220 A.D.

FIG. 8: [symbol] (xing)—1. star. 2. tiny substance.

What I claim as my invention is:

1. A method to create big and yet memorizable (or mnemonic) secret as password and passphrase beyond 128 bits for various applications in information engineering, especially MePKC (Memorizable Public-Key Cryptography) using fully memorizable private key, by selecting and using one or a hybrid combination of the listed options here, wherein they are consisting of:
(a) using self-created signature-like Han character of CLPW (Chinese Language Password) and CLPP (Chinese Language Passphrase) characterized by phonetic encoding of hanyu pinyin, structural encoding of sijiao haoma (aka four-corner method), textual semantic noises, uniquely self-created signature-like symbol, and higher randomness;
(b) using two-dimensional key (2D key) characterized by possible key styles of multiline passphrase, crossword, ASCII art/graphics, Unicode art/graphics, colorful text, sensitive input sequence, as well as partially, fully, and extraordinary filled in user-selected matrix-like 2D field;
(c) using multilingual key characterized by black-and-white or colorful Unicode graphic symbols for a key space in tabular pages with optional grid partitioning;
(d) using multi-tier geo-image key characterized by a generated graphical password/key from series of geographical images called geo-images, and textual password/key of normal text hinted by the geo-images; and
(e) using multi-factor key using software token characterized by the feature, where for 2n-bit MePKC, an n-bit symmetric key can use n-bit symmetric cipher to encrypt a 2n-bit hash of various digital multimedia data like random or non-random bitstream, text, image, audio, animation, or video.

2. The method of Markush-type claim 1 can be applied and used for big memorizable secret creation beyond 128 bits till 256 bits and even larger for a number of cryptographic, information-hiding, and non-cryptographic applications, wherein they are:
(a) creating an asymmetric public key using an asymmetric private key;
(b) encrypting using a symmetric key, stego-key, or asymmetric public key;
(c) decrypting using a symmetric key, stego-key, or asymmetric private key;
(d) signing using an asymmetric private key;
(e) embedding using a symmetric watermarking key, or asymmetric WM private key;
(f) verifying using a symmetric watermarking key;
(g) creating an HMAC (Keyed-Hash Message Authentication Code) using a secret key;
(h) seeding PRNG (Pseudo-Random Number Generator), or CSPRBG (Cryptographically Secure Pseudo-Random Bit Generator); and
(i) enabling fully memorizable asymmetric private key for MePKC (Memorizable Public Key Cryptography), which has strongest expected contribution impact in this invention disclosure.

3. A method to generate multiple storage-free slave keys from a single memorizable master key called multihash key to further boost up the number of created big memorizable secrets or work independently, wherein there are:
(a) optional unique feature called binding identity having partial master key to be concatenated with domain name and/or ID (aka identity) to tie up the master key with unique user identity;
(b) unique feature called hash truncation, creating a first discarded half portion of hash value, that is hard to be retrieved by password cracker, and a second ephemeral half portion of hash value as a slave key, that is preferably a hard problem for brute force attack of password guessing;
(c) a first basic model of multihash key is characterized by using hash iteration, hash truncation, and CSPRBG (Cryptographically Secure Pseudo-Random Bit Generator) supporting infinite online account and finite offline accounts like 20, 32, etc.;
(d) a second improved model of multihash key characterized by using filename, random number, or two-tier structure to support more offline accounts;
(e) a third improved model of mutlihash key as the first variant characterized by using a combination of multi-tier multihash key for the combination selection of intermediate slave keys to generate the final slave key;
(f) a fourth improved model of multihash key as the second variant characterized by using a permutation of some slave keys in the mono-tier multihash key keys to generate the final slave key; and
(g) a fifth improved model of multihash key as the third variant characterized by using a hybrid combination of multi-tier and permutation of some slave keys at the same tier to generate the final slave key.

4. A method to generate object-designated signature message with specific meaning, function, or recipient called multihash signature to be used independently or together with the methods to create big and yet memorizable secret for various applications in information engineering, wherein the features are characterized by:
(a) using a single asymmetric key pair signing over a single message source to generate multiple unique digital signatures based on different round of hash iteration over the single message;
(b) defined representation like designated receiver, functions like referral, and meanings like cheque validity status;
(c) possible anonymous identity, and representation of object, action, feature, function, meaning, etc., as a representation;
(d) avoidance of name clashing and rename problem for stronger collision resistance strength; and
(e) recipient non-repudiation, where the recipient as a second signer signs the received signature using one's private key to create an acknowledgment message sent to the originator of object-designated signature message as the first signor.

5. A method, called here as random space steganography, to harden the identification of embedded data in steganography although stego-data has been detected, wherein characterized by:
(a) using the big and yet memorizable secret generation methods to resist stego-key searching;
(b) using both asymmetric and symmetric key cryptography to boost up the security strength of steganography;
(c) embedding the encrypted data and symmetric key into the space of cover data, together with random noise insertion into the vacant space of cover data, to form stego-data, like stego-image, randomly, by using an asymmetric key pair and stego-key;
(d) retrieving the embedded data by using the stego-key, asymmetric key pair, and symmetric key from stego-data;
(e) frequently broadcasting the dummy stego-data with noises as the embedded data to paralyze the detection of actual stego-data; and
(f) using the sources of cover data from the possible multimedia file formats like bitstream, text, audio, animation, video, or their hybrid combinations.

6. A method to enable stronger public key certificate with one or more asymmetric key pairs per user, wherein there are features characterized by:
(a) using digital certificate with more than one asymmetric key pair for different protection periods and password throttling;
(b) using three-tier MePKC digital certificates for ladder authentication; and
(c) boosting up the trust level of MePKC digital certificate by using more than one certification authority (CA) and/or introducer of trust of web.

7. A system comprising a single computing device like computer, or multiple computers forming a computer communications network, or networked system, for implementing the generation methods of big memorizable secret, multihash key, multihash signature, or random space steganography, wherein:
(a) the computing devices are characterized by any possible things having CPU (Central Processing Unit), main memory, and I/O (Input/Output) devices connected by some system interconnection bus; and
(b) the networked system is characterized by any possible computing networks like PAN (Personal Area Network), LAN (Local Area Network) (of home, company, school, etc.), CAN (Campus Area Network), MAN (Metropolitan Area Network), WAN (Wide Area Network), Internet, or any other types of computer communications network.
